(19) United States
(12) Patent Application Publication
(10) Pub. No.: US 2017/0000133 A1
(43) Pub. Date: Jan. 5, 2017

(54) BENZOXABOROLE FUNGICIDES

(71) Applicant: SYNGENTA PARTICIPATIONS AG, Basel (CH)

(72) Inventors: Ramya RAJAN, Goa (IN); Peter RENOLD, Stein (CH); Atul MAHAJAN, Goa (IN); Daniel STIERLI, Stein (CH); Renaud BEAUDEGNIES, Stein (CH)

(73) Assignee: Syngenta Participations AG, Basel (SE)

(21) Appl. No.: 15/107,038

(22) PCT Filed: Dec. 23, 2014
(86) PCT No.: PCT/EP2014/079289

§ 371 Date: Jun. 21, 2016

(30) Foreign Application Priority Data
Dec. 23, 2013 (IN) 3739/DEL/2013

(51) Int. Cl. A01N 55/08; A23L 3/3544; A23B 7/154; C07F 5/02

(52) U.S. Cl. CPC A01N 55/08; C07F 5/025; A23L 3/3544; A23B 7/154; A23V 2002/00

(57) ABSTRACT

Compounds of formula (I) are as defined in the claims, and their use in compositions and methods for the control and/or prevention of microbial infection, particularly fungal infection, in plants and to processes for the preparation of these compounds.

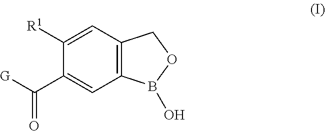

The present invention relates to novel microbiocidally active, in particular fungicidally active, oxoboroles moiety containing compounds their use in compositions and methods for the control and/or prevention of microbial infection, particularly fungal infection, in plants or plant propagation material, harvested food crops by phytopathogenic microorganisms, preferably fungi and to processes for the preparation of these compounds. Preferably these compounds are used in agriculture or horticulture for controlling or preventing infestation of plants by phytopathogenic microorganisms, preferably fungi.

The incidence of serious microbial infections, particularly fungal infections, either systemic or topical, continues to increase for plants.

Fungicides are compounds, of natural or synthetic origin, which act to protect plants against damage caused by fungi. Current methods of agriculture rely heavily on the use of fungicides. In fact, some crops cannot be grown usefully without the use of fungicides. Using fungicides allows a grower to increase the yield of the crop and consequently, increase the value of the crop. Numerous fungicidal agents have been developed. However, the treatment of fungal infestations continues to be a major problem. Furthermore, fungicide resistance has become a serious problem, rendering these agents ineffective for some agricultural uses. As such, a need exists for the development of new fungicidal compounds with improved antifungal properties. It has been found that novel oxoborazoles with a specific substitution pattern are novel and have improved microbiocidal activity.

According to the present invention there is provided a method for controlling or preventing infestation of plants or plant propagation material and/or harvested food crops susceptible to microbial attack by treating plants or plant propagation material and/or harvested food crops with an effective amount of an oxaborole of general formula (I)

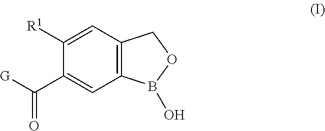

wherein
R¹ is H, fluorine, chlorine, bromine, cyano, nitro, unsubstituted or substituted C₁-C₄alkyl or unsubstituted or substituted C₁-C₄haloalkyl, unsubstituted or substituted C₁-C₄alkoxy, haloalkoxy;
G=OR², NR³R⁴
R², R³ and R⁴ independently are H, unsubstituted or substituted C₁-C₆alkyl, haloalkyl, six to 10 membered aryl, 1,3-benzodioxole-(C₀-C₂)—, five to ten membered heteroaryl which may be mono or bicyclic containing 1 to 3 hetero atoms selected from the group consisting of nitrogen, oxygen and sulfur, it not being possible for the ring system to contain more than 2 oxygen atoms and more than 2 sulfur atoms, C₃-C₆cycloalkyl, unsubstituted or substituted heterocycloalkyl containing 3 to 10 ring members containing 1 to 3 hetero atoms selected from the group consisting of nitrogen, oxygen and sulfur, it not being possible for the ring system to contain more than 2 oxygen atoms and more than 2 sulfur atoms, unsubstituted or substituted C₁-C₆alkoxy, unsubstituted or substituted C₁-C₆haloalkoxy, unsubstituted or substituted C₂-C₆alkenyl, unsubstituted or substituted C₂-C₆alkynyl, or R³ and R⁴ form together with the nitrogen to which they are attached a 3 to 9 ring containing 1 to 3 hetero atoms selected from the group consisting of nitrogen, oxygen and sulfur, it not being possible for the ring system to contain more than 2 oxygen atoms and more than 2 sulfur atoms,
and wherein the substituents for the substituted aryl, heteroaryl, cycloalkyl, heterocycloalkyl and alkyl can be independently mono- or polysubstituted by substituents selected from oxo, —OH, CN, NO₂, F, Cl, —SH, —S—C₁₋₄ alkyl, —S(O)₂—N-heteroaryl, —S(O)₂—N-aryl, —C₁₋₄ alkyl C₁₋₄alkoxy, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁₋₄alkylamino, unsubstituted or substituted five- to ten-membered aryl, unsubstituted or substituted five- to six-membered heteroaryl, unsubstituted or substituted C₃-C₇ cycloalkyl, and unsubstituted or substituted C₃-C₇ heterocycloalkyl, C₁-C₆alkyl, C₁-C₆haloalkyl, C₁-C₆alkenyl, C₁-C₆haloalkenyl, C₁-C₆alkinyl, C₁-C₆haloalkinyl, C₁-C₆alkoxy, C₁-C₆haloalkoxy, C₁-C₆alkenyloxy, C₁-C₆haloalkenyloxy, C₁-C₆alkinyloxy, C₁-C₆haloalkinyl, C₁-C₆alkoxy-C₁-C₆alkyl, C₁-C₆haloalkoxy, C₁-C₆alkoximino, C₁-C₆alkylendioxy, —C(O)(C₁₋₄ alkyl), —(C₁₋₄ alkyl)-C(O)(C₁₋₄ alkyl), —C(O)OH, —(C₁₋₄ alkyl)-C(O)OH, —S—S(O)₂—OH, —S(O)₂—OH, indolin, unsubstituted or substituted six- to ten-membered-aryl(alkylene)₍₀₋₃₎ and unsubstituted or substituted six- to ten-membered-aryl(alkylene)₍₀₋₃₎oxy;
wherein the heterocycloalkyl and heteroaryl containing 3 to 10 ring members containing 1 to 3 hetero atoms selected from the group consisting of nitrogen, oxygen and sulfur, it not being possible for the ring system to contain more than 2 oxygen atoms and more than 2 sulfur atoms
and wherein the heterocycloalkyl and the heteroaryl contain 1 to 3 hetero atoms selected from the group consisting of nitrogen, oxygen and sulfur, it not being possible for the ring system to contain more than 2 oxygen atoms and more than 2 sulfur atoms;
and agronomically acceptable salts, stereoisomers, diastereoisomers, enantiomers, tautomers, atriopisomers and N-oxides of those compounds.

The present invention accordingly further relates to the use of benzoxaborole derivatives according to formula (I) and salts thereof for controlling or preventing infestation of plants or plant propagation material, the application of benzoxaborole derivatives according to formula (I) to useful plants, the application of benzoxaborole derivatives according to formula (I) to the locus of useful plants or the application of benzoxaborole derivatives according to formula (I) to plant propagation material of useful plants a compound of formula (I).

The present invention accordingly further relates to the use of benzoxaborole derivatives according to formula (I) and salts thereof for controlling or preventing infestation of plants or plant propagation material by treating plants or plant propagation material with an effective amount of an benzoxaborole of general formula (I).

The present invention accordingly further relates to the method of controlling phytopathogenic diseases on useful plants or plant propagation material thereof, which comprises applying to said plant or plant propagation material a fungicidally effective amount of a compound of formula (I). Preferably the method method of controlling phytopathogenic diseases on useful plants or plant propagation material thereof, which comprises applying to said plant or plant propagation material a fungicidally effective amount of a compound of formula (I), wherein plant propagation material of useful plants are seeds of useful plants.

The present invention accordingly further relates to the method for controlling or preventing infestation of plants or plant propagation material by treating plants or plant propagation material with an effective amount of an oxaborole of general formula (I).

The present invention accordingly further relates to the method of controlling phytopathogenic diseases on useful plants or plant propagation material thereof, which comprises applying to said plant propagation material a fungicidally effective amount of a compound of formula (I).

Accordingly the present invention also relates to a method of protecting plant propagation material and organs that grow at a later point in time against damage phytopathogenic diseases, which method comprises applying to said propagation material a fungicidally effective amount of a compound of formula I.

In a further aspect of the invention, the invention provides a plant propagation material protecting composition comprising a compound of formula I, together with a suitable carrier therefore.

In a further aspect of the invention, the invention provides a method of controlling phytopathogenic diseases on useful plants or plant propagation material thereof, which comprises applying to said plant propagation material a fungicidally effective amount of a plant propagation material protecting composition comprising a compound of formula (I) as defined in claim 1, together with a suitable carrier therefore.

A preferred embodiment of this aspect of the invention is a plant propagation material protecting composition comprising a compound of formula I, together with a suitable carrier therefor, wherein said plant propagation material protecting composition comprises additionally a colouring agent.

In yet a further aspect of the invention, the invention provides plant propagation material treated with a plant propagation material protecting composition comprising a compound of formula I, together with a suitable carrier therefor.

A preferred embodiment of this aspect of the invention is plant propagation material treated with a plant propagation material protecting composition comprising a compound of formula I, together with a suitable carrier therefor, wherein said plant propagation material protecting composition comprises additionally a colouring agent.

A method of controlling or preventing pest damage in a growing plant said method comprising applying onto the plant propagation material, before planting or sowing thereof a compound of formula (I).

A method of controlling or preventing damage by phytopathogenic diseases in a growing plant or growing plant tissue said method comprising: applying onto the plant propagation material, before planting or sowing thereof a fungicidial effective amount of a compound of formula (I).

A method of controlling or preventing fungal diseases in a growing plant or growing plant tissue said method comprising: applying onto the plant propagation material before planting or sowing thereof a fungicidial effective amount of a compound of formula (I).

In a preferred embodiment the plant propagation material is a seed or a tuber. In a further preferred embodiment the plant propagation material is a seed. In a further preferred embodiment the plant propagation material is a tuber. Preferably the seeds and tubers (stem tubers and root tubers) according to this application are alive. Preferably the seeds and tubers according to this application are able to germinate.

In a further aspect of the invention, the invention provides a method of controlling or preventing damage by phytopathogenic diseases in a growing plant said method comprising applying onto the seed, before planting or sowing thereof a compound of formula (I).

In a further aspect of the invention, the invention provides a method of controlling or preventing damage by phytopathogenic diseases in a growing plant or growing plant tissue said method comprising: applying onto the seed, before planting or sowing thereof a fungicidial effective amount of a compound of formula (I).

In a further aspect of the invention, the invention provides a method of controlling or preventing fungal diseases in a growing plant or growing plant tissue said method comprising: applying onto the seed before planting or sowing thereof a fungicidial effective amount of a compound of formula (I).

In a further aspect of the invention, the invention provides a method of protecting plant propagation material and organs that grow at a later point in time against damage by phytopathogenic diseases, which method comprises applying to said propagation material a fungicidally effective amount of a compound of formula (I).

In a further aspect of the invention, the invention provides a plant propagation material comprising compound a compound of formula (I). Preferably the plant propargation material comprising a fungicidial effective amount of a compound of formula (I).

In a further aspect of the invention, the invention provides a plant propagation material comprising compound a compound of formula (I) and comprises additionally a colouring agent.

In a further aspect of the invention, the invention provides a coated plant propagation material coated with a compound of formula (I).

In a further aspect of the invention, the invention provides a combination of a plant propagation material and a compound of formula (I).

In a further aspect of the invention, the invention provides a coated plant propagation material coated with coating comprising a compound of formula (I) as defined in claim 1.

In a further aspect of the invention, the invention provides a plant propagation material comprising an outer coating characterized that the outer coating comprises a compound according to formula (I), preferably a seed comprising an outer coating characterized that the outer coating comprises a compound according to formula (I).

In a further aspect of the invention, the invention provides a composition comprising a plant propagation material and a compound of formula (I).

In a further aspect of the invention, the invention provides a composition comprising a plant propagation material and a compound of formula and further comprising a a seed grow medium.

In a further aspect of the invention, the invention provides a plant which results from the germination of a a coated seed wherein the coating comprises a compound of formula (I).

In a further aspect of the invention, the invention provides a coated plant propagation material wherein the coating comprises a compound of formula (I).

In a further aspect of the invention, the invention provides a coated plant propagation material according to the preceding paragraph, wherein the said material is a seed.

In a further aspect of the invention, the invention provides the combination of a plant propagation material and a composition comprising a compound of formula (I).

In a further aspect of the invention, the invention provides the combination according to the preceding paragraph wherein the said material is a seed.

In a further aspect of the invention, the invention provides the combination according to one of the two preceding paragraphs, further comprising a plant growth and/or seed germination medium.

In a further aspect of the invention, the invention provides a plant which results from the germination and/or growth of the coated plant propagation material wherein the coating comprises a compound of formula (I).

In a further aspect of the invention, the invention provides a plant which results from the germination and/or growth of the coated plant propagation material wherein the coating comprises a compound of formula (I) and wherein the coated plant propagation material is a seed. Preferably the coated plant propagation material is a seed.

In a further aspect of the invention, the invention relates to the use of a compound of formula (I) according to claim 1, in the preparation of a composition for coating a plant propagation material for the prevention or control of plant pathogenic fungi.

In a further aspect of the invention, the invention relates to a method of controlling or preventing infestation of plants or plant propagation material and/or harvested food crops susceptible to microbial attack by treating plants or plant propagation material and/or harvested food crops with an effective amount of an oxaborole of general formula (I)

In a further aspect of the invention, the invention relates to a method of controlling or preventing infestation of plants or plant propagation material and/or harvested food crops susceptible to microbial attack by providing in a first step a agrochemical compositions according to the present invention comprising from 0.1 to 99% by weight of the compound of formula (I) and 99.9 to 1% by weight, of a solid or liquid adjuvant and/or an surfactant and in a second step applying said composition to the plants or the locus thereof.

The compounds of formula I are applied by treating plant propagation material with a fungicidally effective amount of a compound of formula I. Preferably, compounds of formula I are applied by adhering compounds of formula I to plant propagation material in a fungicidally effective amount.

A preferred application method is seed treatment.

The method according to the invention is especially suitable to increase the yield and/or quality of useful plants, such as crop yield of crop plants.

The invention covers all agronomically acceptable salts, isomers, stereoisomers, diastereoisomers, enantiomers, tautomers, atropisomers and N-oxides of those compounds. The compounds of formula (I) may exist in different geometric or optical isomeric forms or in different tautomeric forms. One or more centres of chirality may be present, in which case compounds of the formula (I) may be present as pure enantiomers, mixtures of enantiomers, pure diastereomers or mixtures of diastereomers. There may be double bonds present in the molecule, such as C═C or C═N bonds, in which case compounds of formula (I) may exist as single isomers or mixtures of isomers. Centres of tautomerisation may be present. This invention covers all such isomers and tautomers and mixtures thereof in all proportions as well as isotopic forms such as deuterated compounds. Also atropisomerism may occur as a result of a restricted rotation about a single bond.

Suitable salts of the compounds of formula (I) include acid addition salts such as those with an inorganic acid such as hydrochloric, hydrobromic, sulphuric, nitric or phosphoric acid, or an organic carboxylic acid such as oxalic, tartaric, lactic, butyric, toluic, hexanoic or phthalic acid, or a sulphonic acid such as methane, benzene or toluene sulphonic acid. Other examples of organic carboxylic acids include haloacids such as trifluoroacetic acid.

N-oxides are oxidised forms of tertiary amines or oxidised forms of nitrogen containing heteroaromatic compounds. They are described in many books for example in “Heterocyclic N-oxides” by Angelo Albini and Silvio Pietra, CRC Press, Boca Raton, Fla., 1991.

In the context of this invention “mono- to polysubstituted” in the definition of the substituents, means typically, depending on the chemical structure of the substituents, monosubstituted to seven-times substituted, preferably monosubstituted to five-times substituted, more preferably mono-, di- or tri-substituted.

In the context of the present specification the term “aryl” refers to a ring system which may be mono-, bi- or tricyclic. Examples of such rings include phenyl, naphthalenyl, anthracenyl, indenyl or phenanthrenyl. A preferred aryl group is phenyl.

The term “heteroaryl” refers to an aromatic ring system containing at least one heteroatom and consisting either of a single ring or of two or more fused rings. Preferably, single rings will contain up to three and bicyclic systems up to four heteroatoms which will preferably be chosen from nitrogen, oxygen and sulfur. Examples of such groups include pyridyl, pyridazinyl, pyrimidinyl, pyrazinyl, furanyl, thiophenyl, oxazolyl, isoxazolyl, oxadiazolyl, thiazolyl, isothiazolyl, thiadiazolyl, pyrrolyl, pyrazolyl, imidazolyl, triazolyl and tetrazolyl. A preferred heteroaryl group is pyridine. Examples of bicyclic groups are benzothiophenyl, benzimidazolyl, benzothiadiazolyl, quinolinyl, cinnolinyl and quinoxalinyl.

The term “heterocyclyl” is defined to include heteroaryl and in addition their unsaturated or partially unsaturated analogues such as 4,5,6,7-tetrahydro-benzothiophenyl, 9H-fluorenyl, 3,4-dihydro-2H-benzo-1,4-dioxepinyl, 2,3-dihydro-benzofuranyl, piperidinyl, 1,3-dioxolanyl, 1,3-dioxanyl, 4,5-dihydro-isoxazolyl, tetrahydrofuranyl and morpholinyl.

The alkyl groups, the alkenyl groups, the alkynyl groups and the alkoxy groups in the compound of formula (I) are either linear or branched or they are perhalogenated and forming haloalkyl groups, haloalkenyl groups, haloalkynyl groups or haloalkoxy groups. Halogen signifies preferably F, Cl, Br, I, and more preferred halogen signify F or Cl. A oxo substituent is ═O, thus a oxygen atom doubly bonded to carbon or another element. The term “oxo substituent” thus embraces aldehydes, carboxylic acids, ketones, sulfonic acids, amides and esters.

The preferred substituents of the substituted alkyl groups, the substituted alkenyl groups, the substituted alkynyl groups, the substituted alkoxy groups, substituted aryl groups and/or the aromatic heterocycle groups in the compound of formula (I) are selected from the following substituents F, Cl, Br, I, —OH, —CN, nitro, an oxo substituent, C₂₋₄alkenyl, C₂₋₄alkenyl, C₂₋₄alkynyl, —C(O)H, —C(O)(C₁₋₄ alkyl), —C(O)(C₁₋₄alkoxy), —C(O)NH₂, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —OC(O)(C₁₋₄alkoxy), —Si(C₁₋₄alkyl)₃, —Si(C₁₋₄alkoxy)₃, C₆₋₁₀aryl, C₆₋₁₀aryloxy, C₆₋₁₀arylthio, C₆₋₁₀ heteroaryl, —(C₁₋₈-perhaloalkyl), arylC₂₋₆alkynyl, —C₂₋₆alkenyl, heteroarylC₂₋₆alkynyl, —C₂₋₆alkenyl, C₃₋₈cycloalkyl, —NR⁸R⁹ where R⁸ and R⁹ are independently H, —C₂₋₄alkenyl, —C₂₋₄alkynyl or combine with the interjacent nitrogen to form a five- or six-membered ring which may comprise one or two or three heteroatoms (one or two N, O or S atoms in addition to the interjacent nitrogen atom), in which case the heterocyclic ring is unsubstituted or the heterocyclic ring is substituted by one or two oxo substituent, C₁₋₄ alkyl groups, —C₂₋₄alkenyl or substituted —C₂₋₄alkenyl, —C₂₋₄alkynyl or substituted —C₂₋₄alkynyl, —C(O)H, —C(O)(C₁₋₄ alkyl), —C(O)(C₁₋₄alkoxy), —C(O)NH₂, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —OC(O)(C₁₋₄ alkoxy), —Si(C₁₋₄alkyl)₃, —Si(C₁₋₄alkoxy)₃, C₆₋₁₀aryl, C₆₋₁₀aryloxy, C₆₋₁₀arylthio, C₆₋₁₀ heteroaryl, —(C₁₋₈-perhaloalkyl), arylC₁₋₄alkynyl, —C₁₋₆alkynyl, wherein all the alkyl, alkenyl, alkynyl, alkoxy, aryl, aryloxy, arylthio or heteroaryl groups are either substituted or unsubstituted, preferably these substituents of the substituted groups bear only one further substituent, more preferably these substituents of the substituted groups are not further substituted.

The more preferred substituents of the substituted alkyl groups, alkenyl groups, the alkynyl groups and the alkoxy are selected from the following substituents —OH, CN, F, Cl, C₁₋₄alkoxy, —C₁₋₄ alkylthio, C₁₋₄alkyl, C₂₋₄alkenyl, C₂₋₄alkenyl, C₂₋₄alkinyl, C₆₋₁₀aryl, —OC(O)(C₁₋₄ alkyl)—C(O)(C₁₋₄alkoxy). The alkyl groups are branched or linear. The most preferred alkyl groups are methyl, ethyl, propyl, iso-propyl, n-butyl, t-butyl (1,1-diemthylethyl), sec-butyl (1-methylpropyl), iso-butyl (2-methylpropyl), pentyl, iso-pentyl (3-methylbutyl, isoamyl), 1-methylpentyl, 1-ethylpentyl, hexyl, heptyl, or octyl. Preferred alkenyl groups are ethenyl, propenyl (1-propenyl, 2-propenyl), butenyl (1-butenyl, 2-butenyl, 3-butenyl, 2-methylpropen-1-yl, 2-methylpropen-2-yl), pentenyl (pent-1-enyl, pent-2-enyl, pent-3-enyl, 2-methylbut-1-enyl, 3-methylbut-1-enyl, 2-methylbut-2-enyl, 3-methylbut-2-enyl, 2-methylbut-3-enyl, 3-methylbut-3-enyl, 1,2-dimethylprop-2-enyl, 1,1-dimethylprop-2-enyl). Preferred alkynyl groups are ethinyl, propinyl (prop-1-inyl or prop-2-inyl (propargyl)), butyl (but-1-ynyl, but-2-ynyl, but-3-ynyl), pentinyl (pent-1-inyl, pent-2-inyl, pent-3-inyl, pent-4-yl, 3-methylbut-1-inyl, 2-methylbut-3-inyl, 1-methylbut-3-inyl). The most preferred alkyl groups and the most preferred alkoxy groups are methyl, ethyl, propyl, t-buyl, methoxy and ethoxy groups. Methyl, ethyl and methoxy groups are very particularly preferred.

Preferably the alkyl groups in the compound of formula (I) and/or the alkoxy groups in the compound of formula (I) bear not more than two further substituents, more preferably the alkyl groups in the compound of formula (I) and/or the alkoxy groups in the compound of formula (I) bear not more than one further substituent, most preferred the alkyl groups in the compound of formula (I) and/or the alkoxy groups in the compound of formula (I) are not further substituted.

The aryl and hetero aryl groups are either substituted or unsubstituted 5-membered or 6-membered aromatic monocyclic which may contain at least one heteroatom selected from N, S, O or unsubtituted or substituted 9-membered or 10-membered aromatic bicyclic ring system which may contain one or two heteroatoms selected from N, S, O.

Preferrably the unsubtituted or substituted heteroaryl which is mono cyclic or bicyclic ring system which is five to ten membered containing at least one heteroatom selected from O, N or S and has not more than 3 heteroatoms

For examples of such groups include furyl, thienyl, pyrrolyl, pyrazolyl, imidazolyl, 1,2,3-triazolyl, 1,2,4-triazolyl, 1,3,4-triazolyl, oxazolyl, isoxazolyl, thiazolyl, isothiazolyl, 1,2,4-oxadiazolyl, 1,3,4-oxadiazolyl, 1,2,5-oxadiazolyl, 1,2,3-thiadiazolyl, 1,2,4-thiadiazolyl, 1,3,4-thiadiazolyl, 1,2,5-thiadiazolyl, pyridyl, pyrimidinyl, pyridazinyl, pyrazinyl, 1,2,3-triazinyl, 1,2,4-triazinyl, 1,3,5-triazinyl, benzofuryl, benzisofuryl, benzothienyl, benzisothienyl, indolyl, isoindolyl, indazolyl, benzothiazolyl, benzisothiazolyl, benzoxazolyl, benzisoxazolyl, benzimidazolyl, 2,1,3-benzoxadiazole, quinolinyl, isoquinolinyl, cinnolinyl, phthalazinyl, quinazolinyl, quinoxalinyl, naphthyridinyl, benzotriazinyl, purinyl, pteridinyl and indolizinyl, preferably thiazolyl, imidazolyl, pyrrazolyl, pyridyl and pyrimidinyl

The aryl groups and heteroaryl groups are preferably unsubtituted or substituted 5-membered or 6-membered aromatic monocyclic ring system which may contain one or two heteroatoms selected from N or S or O wherein the substituents are selected from the group consisting of halogen, hydroxy, C₁-C₄alkyl, C₁-C₄haloalkyl, C₁-C₄alkoxy, C₁-C₄alkylthio, C₁-C₄alkoxy-C₁-C₄alkyl, C₁-C₄haloalkoxy, C₁-C₄alkoximino and C₁-C₄alkylendioxygroups, phenyl, pyridyl, thiophene, imidazole or pyrrazol groups The aryl groups and heteroaryl groups are preferably unsubstituted or substituted 9-membered or 10-membered aromatic bicyclic ring system which may contain one or two heteroatoms selected from N or S or O wherein the substituents are selected from the group consisting of halogen, hydroxy, C₁-C₄alkyl, C₁-C₄haloalkyl, C₁-C₄alkoxy, C₁-C₄alkylthio, C₁-C₄alkoxy-C₁-C₄alkyl, C₁-C₄haloalkoxy, C₁-C₄alkoximino and C₁-C₄alkylendioxygroups, more preferably naphtyl, benzofuranyl, purinyl, indolyl, benzo[b]thiophenyl or quinolinyl groups

The preferred substituents of the substituted aryl groups and heteroaryl groups in the compound of formula (I) are selected from the group consisting of halogen, hydroxy, cyano, nitro, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁-C₄alkyl, C₁-C₄haloalkyl, C₁-C₄alkoxy, C₁-C₄alkylthio, C₁-C₄alkoxy-C₁-C₄alkyl, C₁-C₄haloalkoxy, C₁-C₄alkoximino, C₁-C₄alkylendioxy, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄alkyl)(C₁₋₄alkyl), —NHC(O)(C₁₋₄alkyl), —NHC(O)(C₁₋₄alkoxy),)C(O)(C₁₋₄ alkyl), —N(C₁₋₄alkyl)C(O)(C₁₋₄ alkoxy), —OC(O) (C₁₋₄ alkyl), more preferred substituents of the substituted aryl groups or heteroaryl groups in the compound of formula (I) are selected from the following substituents F, Cl, CF₃, CN, —OH, nitro, —C₁₋₄ alkyl, —C₁₋₄ alkoxy, —C(O)(C₁₋₄ alkoxy), —C(O)H, —C(O)(C₁₋₄ Alkyl), —wherein the alkyl groups are either substituted or unsubstituted.

The most preferred substituents of the substituted aryl groups and heteroaryl groups in the compound of formula (I) are selected from the following substituents, F, Cl, —C₁₋₄Alkyl, C₁₋₄alkoxy, —CN, —C(O)(C₁₋₄ alkoxy), —C(O)(C₁₋₄ alkyl), —C(O)—N—(C₁₋₄ alkyl) and preferably F, Cl are the even more preferred substituents of the substituted aryl groups in the compound of formula (I).

In a further aspect the present invention relates to compounds of formula (I)

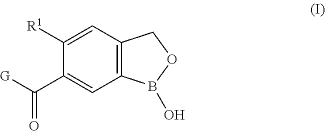

wherein
R¹ is H, fluorine, chlorine, bromine, cyano, nitro, unsubstituted or substituted C₁-C₄alkyl or unsubstituted or substituted C₁-C₄haloalkyl, unsubstituted or substituted C₁-C₄alkoxy, haloalkoxy;
G=OR², NR³R⁴
R², R³ and R⁴ independently are H, unsubstituted or substituted C₁-C₆alkyl, haloalkyl, six to 10 membered aryl, 1,3-benzodioxole-(C₀-C₂)—, five to ten membered heteroaryl which may be mono or bicyclic containing 1 to 3 hetero atoms selected from the group consisting of nitrogen, oxygen and sulfur, it not being possible for the ring system to contain more than 2 oxygen atoms and more than 2 sulfur atoms, C₃-C₆cycloalkyl, unsubstituted or substituted heterocycloalkyl containing 3 to 10 ring members containing 1 to 3 hetero atoms selected from the group consisting of nitrogen, oxygen and sulfur, it not being possible for the ring system to contain more than 2 oxygen atoms and more than 2 sulfur atoms, unsubstituted or substituted C₁-C₆alkoxy, unsubstituted or substituted C₁-C₆haloalkoxy, unsubstituted or substituted C₂-C₆alkenyl, unsubstituted or substituted C₂-C₆alkynyl, or
R³ and R⁴ form together with the nitrogen to which they are attached a 3 to 9 ring containing 1 to 3 hetero atoms selected from the group consisting of nitrogen, oxygen and sulfur, it not being possible for the ring system to contain more than 2 oxygen atoms and more than 2 sulfur atoms,
and wherein the substituents for the substituted aryl, heteroaryl, cycloalkyl, heterocycloalkyl and alkyl can be independently mono- or polysubstituted by substituents selected from oxo, —OH, CN, NO₂, F, Cl, —SH, —S—C₁₋₄ alkyl, —S(O)₂—N-heteroaryl, —S(O)₂—N-aryl, —C₁₋₄ alkyl C₁₋₄alkoxy, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁₋₄alkylamino, unsubstituted or substituted five- to ten-membered aryl, unsubstituted or substituted five- to six-membered heteroaryl, unsubstituted or substituted C₃-C₇ cycloalkyl, and unsubstituted or substituted C₃-C₇ heterocycloalkyl, C₁-C₆alkyl, C₁-C₆haloalkyl, C₁-C₆alkenyl, C₁-C₆haloalkenyl, C₁-C₆alkinyl, C₁-C₆haloalkinyl, C₁-C₆alkoxy, C₁-C₆haloalkoxy, C₁-C₆alkenyloxy, C₁-C₆haloalkenyloxy, C₁-C₆alkinyloxy, C₁-C₆haloalkinyl, C₁-C₆alkoxy-C₁-C₆alkyl, C₁-C₆haloalkoxy, C₁-C₆alkoximino, C₁-C₆alkylendioxy, —C(O)(C₁₋₄ alkyl), —(C₁₋₄ alkyl)-C(O)(C₁₋₄ alkyl), —C(O)OH, —(C₁₋₄ alkyl)-C(O)OH, —S—S(O)₂—OH, —S(O)₂—OH, indolin, unsubstituted or substituted six- to ten-membered-aryl(alkylene)₍₀₋₃₎ and unsubstituted or substituted six- to ten-membered-aryl(alkylene)₍₀₋₃₎oxy;
wherein the heterocycloalkyl and heteroaryl containing 3 to 10 ring members containing 1 to 3 hetero atoms selected from the group consisting of nitrogen, oxygen and sulfur, it not being possible for the ring system to contain more than 2 oxygen atoms and more than 2 sulfur atoms
and wherein the heterocycloalkyl and the heteroaryl contain 1 to 3 hetero atoms selected from the group consisting of nitrogen, oxygen and sulfur, it not being possible for the ring system to contain more than 2 oxygen atoms and more than 2 sulfur atoms;
provided that the compound of formula (I) is not 1,3-dihydro-1-hydroxy-2,1-Benzoxaborole-7-carboxylic acid methyl ester or 3-dihydro-1-hydroxy-2,1-Benzoxaborole-7-carboxylic acid or 1,3-dihydro-1-hydroxy-N-phenyl-2,1-Benzoxaborole-6-carboxamide or 4-[[(1,3-dihydro-1-hydroxy-2,1-benzoxaborol-6-yl)carbonyl]amino]-benzenesulfonic acid or 1,3-dihydro-1-hydroxy-2,1-Benzoxaborole-6-carboxylic acid,
and agronomically acceptable salts, stereoisomers, diastereoisomers, enantiomers, tautomers, atriopisomers and N-oxides of those compounds.

Preferably

R¹ fluorine, chlorine
G is OR², NR³R⁴
R² is a C₁-C₆alkyl, C₁-C₆haloalkyl
R³ and R⁴ independently are H, C₁-C₆alkyl, C₁-C₆haloalkyl, aryl, heteroaryl, C₃-C₆cycloalkyl, heterocycloalkyl, alkoxy, haloalkoxy, C₂-C₆alkenyl, C₂-C₆alkynyl,

More preferably

R¹ fluorine, chlorine
G is OR², NR³R⁴
R² is a C₁-C₆alkyl (preferably C₁-C₄alkyl)
R³ and R⁴ independently are H, C₁-C₆alkyl (preferably C₁-C₄alkyl), heterocycloalkyl, alkoxy, haloalkoxy,

Most preferably

R¹ fluorine, chlorine
G is OR², NR³R⁴
R² is a C₁-C₆alkyl (preferably C₁-C₄alkyl)
R³ and R⁴ independently are H, C₁-C₄alkyl, C₁-C₄alkoxy, C₁-C₄haloalkoxy heterocycloalkyl comprising at least one include N or O in the ring;

In particularly preferred embodiments for the methods and compounds of the present invention the preferred groups R¹, R², R³, R⁴, and G, in any combination thereof, are as set out below.

Preferably R¹ is H, fluorine, chlorine, bromine;

More preferably R¹ is fluorine, chlorine, bromine;
More preferably R¹ is fluorine, chlorine;

Preferably R² is a C₁-C₆alkyl, C₁-C₆haloalkyl

R² is a C₁-C₆alkyl (preferably C₁-C₄alkyl)

Preferably R³ and R⁴ independently are H, C₁-C₆alkyl, C₁-C₆haloalkyl, aryl, heteroaryl, C₃-C₆cycloalkyl, heterocycloalkyl, alkoxy, haloalkoxy, C₂-C₆alkenyl, C₂-C₆alkynyl,

R³ and R⁴ independently are H, methyl, heterocycloalkyl comprising at least one heteroatom including N or O in the ring, methoxy, trifluoromethoxy;

In a preferred embodiment invention G is NR³R⁴

In a preferred embodiment invention G is OR²;

In one embodiment R² is Ethyl, prop-2-ynyl,

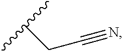 [SMILES: *CC#N]

### Allyl, Isopropyl, 2-F-ethyl,

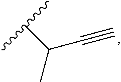 [SMILES: *C(C)C#C]

but-3-ynyl, but-2-ynyl,

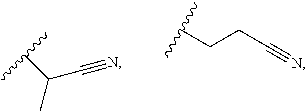

tetrahydrofuran-2-ylmethyl,

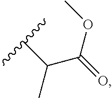 [SMILES: *C(C)C(=O)OC]

trimethylsilylmethyl, 3,3,3-trifluoropropyl, 4-methoxy-4-oxo-but-2-ynyl, 2-chloro-2,2-difluoro-ethyl, heptyl, 2-methylsulfonylethyl, (3-fluorophenyl)methyl, 3-trimethylsilylprop-2-ynyl,

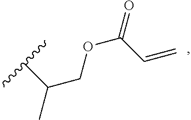 [SMILES: *C(C)COC(=O)C=C]

1-methoxycarbonylbut-3-enyl, 3-trimethylsilylallyl, 1-phenylprop-2-ynyl, 3-phenylprop-2-ynyl, tetrahydrothiopyran-4-ylmethyl, 6-methoxytetrahydropyran-3-yl, 3-trimethylsilylpropyl, 2-butylsulfanylethyl, 2-(4-chlorophenoxy)ethyl, 2-ethoxycarbonylcyclohexyl, 6-(trifluoromethyl)-3-pyridyl]methyl, (4-phenylphenyl)methyl, 2-(2,6-dichlorophenyl)ethyl, 2-(2,4-dichlorophenyl)ethyl, 4-(2-naphthyl)butyl, [2-chloro-4-(trifluoromethyl)phenyl]methyl, [3-chloro-5-(trifluoromethyl)2-pyridyl]methyl, (4-oxo-4-pyrrolidin-1-yl-butyl), 1-naphthylmethyl, 2-[2-(2-m ethoxyethoxy)ethoxy]ethyl, (2-methoxy-2-oxo-1-phenyl-ethyl), 2-(4-methoxyphenoxy)ethyl, benzenesulfonylmethyl, phenacyl, cyclobutylmethyl, 2-dimethylaminoethyl, thietan-3-yl, [2-fluoro-1-(fluoromethyl)ethyl], 3-(1-methylpyrazol-4-yl)propyl, (2-chlorothiazol-5-yl)methyl, 2-dimethoxyphosphorylethyl, 1-[ethoxy(methyl)phosphoryl]ethyl, (1-methyl-2-morpholino-ethyl);

In one embodiment R³ is ethyl-, butyl-, but-2-yl-, allyl, benzyl, phenyl, methyl, methyl, methyl, (1-methyl-1H-imidazol-4-yl)-methyl-, (1H-benzimidazol-2-yl)-methyl-, 3-bromo-propyl-, 3,3,3-trifluoro-propyl-, (1-hydroxycyclohexyl)methyl, 2-oxotetrahydrothiophen-3-yl, 6-ethoxycarbonylcyclohex-3-en-1-yl, [2-hydroxy-2-(4-hydroxyphenyl)ethyl], 2-(1,3-benzodioxol-5-yl)ethyl, 2-benzylsulfanylethyl, 4-Methanesulfonyl-benzyl, N′,N′-dimethylaminoethyl, sec-Butyl, Butan-1-ol-2-yl, 1-methoxy-prop-2-yl-, 2,2-Difluoro-ethyl, Ethynyl-cyclohexyl, 2-([1′,3′]dioxolan-2′-yl)-eth-1-yl-, tetrahydrofuran-2-ylmeth-yl-, 2-methyl-cyclohex-1-yl-, 2-Morpholin-4-yl-ethyl, 3-pyrrolidin-1-ylpropyl, 2-sulfosulfanylethyl, (pyrid-3-yl)-methyl-, 3-(1-piperidyl)propyl, Benzyl, 3-(4-chlorophenyl)isoxazol-5-ylmethyl, 2-fluoro-phenyl-meth-yl-, 1-phenyl-eth-1-yl-, 2-phenyl-eth-1-yl-, (1,2,2,6,6-pentamethyl-4-piperidyl, 2-(thiophen-2′-yl)-eth-1-yl-, 2-Phenoxy-ethyl, (3-chloro-phenyl)-methyl-, (2,3-dihydro-benzo[1,4]dioxin-6-yl)-methyl-, 2-Acetylamino-ethyl, (4-methoxy-phenyl)-methyl-, 4-Pyrazol-1-yl-benzyl, (2-trifluoromethoxy-phenyl)-methyl-, 2-(indol-3′-yl)-eth-1-yl-, 2-trifluoromethyl-benzyl-, 2-Methylsulfanyl-ethyl, 2-Piperidin-1-yl-benzyl, 4-Phenoxy-benzyl, (6-Chloro-pyridin-3-yl)-methyl, 1-Benzyl-pyrrolidin-3-yl, 2-Piperidin-1-yl-benzyl, Furan-2-yl-methyl, 2-chloro-phenyl-, 4-methoxycarbonylphenyl, 4-isopropylphenyl, 2-methyl-phenyl-, 2-chloro-6-methyl-phenyl-, quinolin-5-yl-, 2,4-dimethoxy-phenyl-, 3-fluoro-phenyl-, 1H-Indazol-5-yl, 3-phenylphenyl, 4-pyrrol-1-ylphenyl, 4-Piperidin-1-yl-phenyl, (2-benzoylphenyl), 2-methoxycarbonylbenzothiophen-5-yl, 2-methoxy-5-phenyl-phenyl, 2-methylsulfanylphenyl, 1,3-benzothiazol-6-yl, 2-morpholino-5-(trifluoromethyl)phenyl, 2-(1H-indol-2-yl)phenyl, 2-morpholinophenyl, 4-Methyl-2-oxo-2H-chromen-7-yl, 4-(dimethylsulfamoyl)phenyl, 4-(2-pyridylsulfamoyl)phenyl, 1,3-dimethyl-1H-pyrazol-5-yl-, 4-methylthiazol-2-yl, 5-methylsulfanyl-1H-[1,2,4]-triazol-3-yl, 3-methyl-2-pyridyl, 4-methyl-6-methylsulfanyl-1,3,5-triazin-2-yl, 4-hydroxy-6-methyl-pyrimidin-2-yl, 5-methoxycarbonyl-2-pyridyl, Quinolin-2-yl, 5-methyl-3-phenyl-isoxazol-4-yl, 9H-Purin-6-yl, 5-acetyl-4-methyl-thiazol-2-yl, 5-phenyl-1H-pyrazol-3-yl, 4-methyl-1,3-benzothiazol-2-yl, 5-methyl-1,3,4-thiadiazol-2-yl, 4-(4-chlorophenyl)thiadiazol-5-yl, 6-phenoxy-3-pyridyl, 3-cyano-5-phenyl-2-furyl, 4-cyano-2-phenyl-pyrazol-3-yl, 3-ethoxycarbonyl-4,5,6,7-tetrahydrobenzothiophen-2-yl, 2-methoxycarbonyl-3-thienyl, 4-methyl-6-(2-thienyl)pyrimidin-2-yl, 4,6-dimethyl-2H-pyrazolo[3,4-b]pyridin-3-yl, 4-(p-tolyl)thiazol-2-yl, 5-phenyl-2-pyridyl, or R³ and R⁴ form together —CH2-CH2-O—CH2-CH2-, —CH2-CH2-NH—CH2-CH2-,

In one embodiment R³ and R⁴ form together —CH2-CH2-O—CH2-CH2-, —CH2-CH2-NH—CH2-CH2-;

In one embodiment R⁴ is methoxy, H, methyl,

In one embodiment R² is Ethyl, prop-2-ynyl,

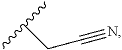 [SMILES: *CC#N]

### Allyl, Isopropyl, 2-F-ethyl,

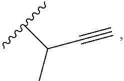 [SMILES: *C(C)C#C]

but-3-ynyl, but-2-ynyl,

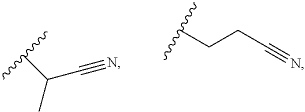

tetrahydrofuran-2-ylmethyl,

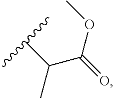 [SMILES: *C(C)C(=O)OC]

trimethylsilylmethyl, 3,3,3-trifluoropropyl, 4-methoxy-4-oxo-but-2-ynyl, 2-chloro-2,2-difluoro-ethyl, heptyl, 2-methylsulfonylethyl, (3-fluorophenyl)methyl, 3-trimethylsilylprop-2-ynyl,

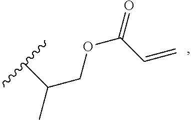 [SMILES: *C(C)COC(=O)C=C]

1-methoxycarbonylbut-3-enyl, 3-trimethylsilylallyl, 1-phenylprop-2-ynyl, 3-phenylprop-2-ynyl, tetrahydrothiopyran-4-ylmethyl, 6-methoxytetrahydropyran-3-yl, 3-trimethylsilylpropyl, 2-butylsulfanylethyl, 2-(4-chlorophenoxy)ethyl, 2-ethoxycarbonylcyclohexyl, 6-(trifluoromethyl)-3-pyridyl]methyl, (4-phenylphenyl)methyl, 2-(2,6-dichlorophenyl)ethyl, 2-(2,4-dichlorophenyl)ethyl, 4-(2-naphthyl)butyl, [2-chloro-4-(trifluoromethyl)phenyl]methyl, [3-chloro-5-(trifluoromethyl)2-pyridyl]methyl, (4-oxo-4-pyrrolidin-1-yl-butyl), 1-naphthylmethyl, 2-[2-(2-m ethoxyethoxy)ethoxy]ethyl, (2-methoxy-2-oxo-1-phenyl-ethyl), 2-(4-methoxyphenoxy)ethyl, benzenesulfonylmethyl, phenacyl, cyclobutylmethyl, 2-dimethylaminoethyl, thietan-3-yl, [2-fluoro-1-(fluoromethyl)ethyl], 3-(1-methylpyrazol-4-yl)propyl, (2-chlorothiazol-5-yl)methyl, 2-dimethoxyphosphorylethyl, 1-[ethoxy(methyl)phosphoryl]ethyl, (1-methyl-2-morpholino-ethyl);
R³ is ethyl-, butyl-, but-2-yl-, allyl, benzyl, phenyl, methyl, methyl, methyl, (1-methyl-1H-imidazol-4-yl)-methyl-, (1H-benzimidazol-2-yl)-methyl-, 3-bromo-propyl-, 3,3,3-trifluoro-propyl-, (1-hydroxycyclohexyl)methyl, 2-oxotetrahydrothiophen-3-yl, 6-ethoxycarbonylcyclohex-3-en-1-yl, [2-hydroxy-2-(4-hydroxyphenyl)ethyl], 2-(1,3-benzodioxol-5-yl)ethyl, 2-benzylsulfanylethyl, 4-Methanesulfonyl-benzyl, N′,N′-dimethylaminoethyl, sec-Butyl, Butan-1-ol-2-yl, 1-methoxy-prop-2-yl-, 2,2-Difluoro-ethyl, Ethynyl-cyclohexyl, 2-([1′,3′]dioxolan-2′-yl)-eth-1-yl-, tetrahydrofuran-2-ylmeth-yl-, 2-methyl-cyclohex-1-yl-, 2-Morpholin-4-yl-ethyl, 3-pyrrolidin-1-ylpropyl, 2-sulfosulfanylethyl, (pyrid-3-yl)-methyl-, 3-(1-piperidyl)propyl, Benzyl, 3-(4-chlorophenyl)isoxazol-5-ylmethyl, 2-fluoro-phenyl-meth-yl-, 1-phenyl-eth-1-yl-, 2-phenyl-eth-1-yl-, (1,2,2,6,6-pentamethyl-4-piperidyl, 2-(thiophen-2′-yl)-eth-1-yl-, 2-Phenoxy-ethyl, (3-chloro-phenyl)-methyl-, (2,3-dihydro-benzo[1,4]dioxin-6-yl)-methyl-, 2-Acetylamino-ethyl, (4-methoxy-phenyl)-methyl-, 4-Pyrazol-1-yl-benzyl, (2-trifluoromethoxy-phenyl)-methyl-, 2-(indol-3′-yl)-eth-1-yl-, 2-trifluoromethyl-benzyl-, 2-Methylsulfanyl-ethyl, 2-Piperidin-1-yl-benzyl, 4-Phenoxy-benzyl, (6-Chloro-pyridin-3-yl)-methyl, 1-Benzyl-pyrrolidin-3-yl, 2-Piperidin-1-yl-benzyl, Furan-2-yl-methyl, 2-chloro-phenyl-, 4-methoxycarbonylphenyl, 4-isopropylphenyl, 2-methyl-phenyl-, 2-chloro-6-methyl-phenyl-, quinolin-5-yl-, 2,4-dimethoxy-phenyl-, 3-fluoro-phenyl-, 1H-Indazol-5-yl, 3-phenylphenyl, 4-pyrrol-1-ylphenyl, 4-Piperidin-1-yl-phenyl, (2-benzoylphenyl), 2-methoxycarbonylbenzothiophen-5-yl, 2-methoxy-5-phenyl-phenyl, 2-methylsulfanylphenyl, 1,3-benzothiazol-6-yl, 2-morpholino-5-(trifluoromethyl)phenyl, 2-(1H-indol-2-yl)phenyl, 2-morpholinophenyl, 4-Methyl-2-oxo-2H-chromen-7-yl, 4-(dimethylsulfamoyl)phenyl, 4-(2-pyridylsulfamoyl)phenyl, 1,3-dimethyl-1H-pyrazol-5-yl-, 4-methylthiazol-2-yl, 5-methylsulfanyl-1H-[1,2,4]-triazol-3-yl, 3-methyl-2-pyridyl, 4-methyl-6-methylsulfanyl-1,3,5-triazin-2-yl, 4-hydroxy-6-methyl-pyrimidin-2-yl, 5-methoxycarbonyl-2-pyridyl, Quinolin-2-yl, 5-methyl-3-phenyl-isoxazol-4-yl, 9H-Purin-6-yl, 5-acetyl-4-methyl-thiazol-2-yl, 5-phenyl-1H-pyrazol-3-yl, 4-methyl-1,3-benzothiazol-2-yl, 5-methyl-1,3,4-thiadiazol-2-yl, 4-(4-chlorophenyl)thiadiazol-5-yl, 6-phenoxy-3-pyridyl, 3-cyano-5-phenyl-2-furyl, 4-cyano-2-phenyl-pyrazol-3-yl, 3-ethoxycarbonyl-4,5,6,7-tetrahydrobenzothiophen-2-yl, 2-methoxycarbonyl-3-thienyl, 4-methyl-6-(2-thienyl)pyrimidin-2-yl, 4,6-dimethyl-2H-pyrazolo[3,4-b]pyridin-3-yl, 4-(p-tolyl)thiazol-2-yl, 5-phenyl-2-pyridyl, or R³ and R⁴ form together —CH2-CH2-O—CH2-CH2-, —CH2-CH2-NH—CH2-CH2-,
Or R³ and R⁴ form together —CH2-CH2-O—CH2-CH2-, —CH2-CH2-NH—CH2-CH2-; R⁴ is methoxy, H, methyl,

In one embodiment R¹ is H, fluorine, chlorine, bromine; preferably R¹ is fluorine, chlorine, bromine; more preferably R¹ is fluorine, chlorine; R² is Ethyl, prop-2-ynyl,

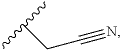 [SMILES: *CC#N]

### Allyl, Isopropyl, 2-F-ethyl,

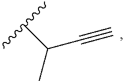 [SMILES: *C(C)C#C]

but-3-ynyl, but-2-ynyl,

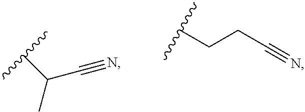

tetrahydrofuran-2-ylmethyl,

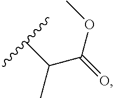 [SMILES: *C(C)C(=O)OC]

trimethylsilylmethyl, 3,3,3-trifluoropropyl, 4-methoxy-4-oxo-but-2-ynyl, 2-chloro-2,2-difluoro-ethyl, heptyl, 2-methylsulfonylethyl, (3-fluorophenyl)methyl, 3-trimethylsilylprop-2-ynyl,

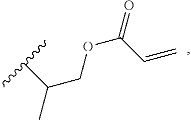 [SMILES: *C(C)COC(=O)C=C]

1-methoxycarbonylbut-3-enyl, 3-trimethylsilylallyl, 1-phenylprop-2-ynyl, 3-phenylprop-2-ynyl, tetrahydrothiopyran-4-ylmethyl, 6-methoxytetrahydropyran-3-yl, 3-trimethylsilylpropyl, 2-butylsulfanylethyl, 2-(4-chlorophenoxy)ethyl, 2-ethoxycarbonylcyclohexyl, 6-(trifluoromethyl)-3-pyridyl]methyl, (4-phenylphenyl)methyl, 2-(2,6-dichlorophenyl)ethyl, 2-(2,4-dichlorophenyl)ethyl, 4-(2-naphthyl)butyl, [2-chloro-4-(trifluoromethyl)phenyl]methyl, [3-chloro-5-(trifluoromethyl)2-pyridyl]methyl, (4-oxo-4-pyrrolidin-1-yl-butyl), 1-naphthylmethyl, 2-[2-(2-methoxyethoxy)ethoxy]ethyl, (2-methoxy-2-oxo-1-phenyl-ethyl), 2-(4-methoxyphenoxy)ethyl, benzenesulfonylmethyl, phenacyl, cyclobutylmethyl, 2-dimethylaminoethyl, thietan-3-yl, [2-fluoro-1-(fluoromethyl)ethyl], 3-(1-methylpyrazol-4-yl)propyl, (2-chlorothiazol-5-yl)methyl, 2-dimethoxyphosphorylethyl, 1-[ethoxy(methyl)phosphoryl]ethyl, (1-methyl-2-morpholino-ethyl);
R³ is ethyl-, butyl-, but-2-yl-, allyl, benzyl, phenyl, methyl, methyl, methyl, (1-methyl-1H-imidazol-4-yl)-methyl-, (1H-benzimidazol-2-yl)-methyl-, 3-bromo-propyl-, 3,3,3-trifluoro-propyl-, (1-hydroxycyclohexyl)methyl, 2-oxotetrahydrothiophen-3-yl, 6-ethoxycarbonylcyclohex-3-en-1-yl, [2-hydroxy-2-(4-hydroxyphenyl)ethyl], 2-(1,3-benzodioxol-5-yl)ethyl, 2-benzylsulfanylethyl, 4-Methanesulfonyl-benzyl, N′,N′-dimethylaminoethyl, sec-Butyl, Butan-1-ol-2-yl, 1-methoxy-prop-2-yl-, 2,2-Difluoro-ethyl, Ethynyl-cyclohexyl, 2-([1′,3′]dioxolan-2′-yl)-eth-1-yl-, tetrahydrofuran-2-ylmeth-yl-, 2-methyl-cyclohex-1-yl-, 2-Morpholin-4-yl-ethyl, 3-pyrrolidin-1-ylpropyl, 2-sulfosulfanylethyl, (pyrid-3-yl)-methyl-, 3-(1-piperidyl)propyl, Benzyl, 3-(4-chlorophenyl)isoxazol-5-ylmethyl, 2-fluoro-phenyl-meth-yl-, 1-phenyl-eth-1-yl-, 2-phenyl-eth-1-yl-, (1,2,2,6,6-pentamethyl-4-piperidyl, 2-(thiophen-2′-yl)-eth-1-yl-, 2-Phenoxy-ethyl, (3-chloro-phenyl)-methyl-, (2,3-dihydro-benzo[1,4]dioxin-6-yl)-methyl-, 2-Acetylamino-ethyl, (4-methoxy-phenyl)-methyl-, 4-Pyrazol-1-yl-benzyl, (2-trifluoromethoxy-phenyl)-methyl-, 2-(indol-3′-yl)-eth-1-yl-, 2-trifluoromethyl-benzyl-, 2-Methylsulfanyl-ethyl, 2-Piperidin-1-yl-benzyl, 4-Phenoxy-benzyl, (6-Chloro-pyridin-3-yl)-methyl, 1-Benzyl-pyrrolidin-3-yl, 2-Piperidin-1-yl-benzyl, Furan-2-yl-methyl, 2-chloro-phenyl-, 4-methoxycarbonylphenyl, 4-isopropylphenyl, 2-methyl-phenyl-, 2-chloro-6-methyl-phenyl-, quinolin-5-yl-, 2,4-dimethoxy-phenyl-, 3-fluoro-phenyl-, 1H-Indazol-5-yl, 3-phenylphenyl, 4-pyrrol-1-ylphenyl, 4-Piperidin-1-yl-phenyl, (2-benzoylphenyl), 2-methoxycarbonylbenzothiophen-5-yl, 2-methoxy-5-phenyl-phenyl, 2-methylsulfanylphenyl, 1,3-benzothiazol-6-yl, 2-morpholino-5-(trifluoromethyl)phenyl, 2-(1H-indol-2-yl)phenyl, 2-morpholinophenyl, 4-Methyl-2-oxo-2H-chromen-7-yl, 4-(dimethylsulfamoyl)phenyl, 4-(2-pyridylsulfamoyl)phenyl, 1,3-dimethyl-1H-pyrazol-5-yl-, 4-methylthiazol-2-yl, 5-methylsulfanyl-1H-[1,2,4]-triazol-3-yl, 3-methyl-2-pyridyl, 4-methyl-6-methylsulfanyl-1,3,5-triazin-2-yl, 4-hydroxy-6-methyl-pyrimidin-2-yl, 5-methoxycarbonyl-2-pyridyl, Quinolin-2-yl, 5-methyl-3-phenyl-isoxazol-4-yl, 9H-Purin-6-yl, 5-acetyl-4-methyl-thiazol-2-yl, 5-phenyl-1H-pyrazol-3-yl, 4-methyl-1,3-benzothiazol-2-yl, 5-methyl-1,3,4-thiadiazol-2-yl, 4-(4-chlorophenyl)thiadiazol-5-yl, 6-phenoxy-3-pyridyl, 3-cyano-5-phenyl-2-furyl, 4-cyano-2-phenyl-pyrazol-3-yl, 3-ethoxycarbonyl-4,5,6,7-tetrahydrobenzothiophen-2-yl, 2-methoxycarbonyl-3-thienyl, 4-methyl-6-(2-thienyl)pyrimidin-2-yl, 4,6-dimethyl-2H-pyrazolo[3,4-b]pyridin-3-yl, 4-(p-tolyl)thiazol-2-yl, 5-phenyl-2-pyridyl, or R³ and R⁴ form together —CH2-CH2-O—CH2-CH2-, —CH2-CH2-NH—CH2-CH2-,
Or R³ and R⁴ form together —CH2-CH2-O—CH2-CH2-, —CH2-CH2-NH—CH2-CH2-;
R⁴ is methoxy, H, methyl,

In all compounds shown in the schemes below R¹, R², R³, R⁴, and G are as defined above.

Compounds described in the present invention can be prepared using commercially available starting materials or known intermediates using synthetic methods known in the art or described herein.

The following general chemistry routes were used as indicated in generating the examples and can be applied, using the knowledge of one of skill in the art, to other appropriate compounds to obtain additional analogues.

Compounds of formula I may be prepared by reacting a compound of formula (II)

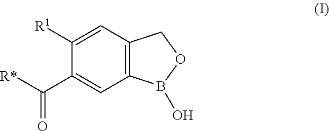

wherein n, R¹ and R⁵ are as defined under formula (I) R* is halogen, hydroxy or C₁₋₆ alkoxy;
with a compound of formula III-A and III-B

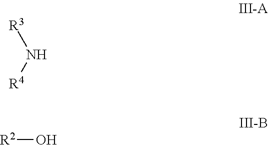

in which R², R³ and R⁴ are as defined under formula I,
Compounds of formula III-A and III-B are known and commercially available.

The reactions for the preparation of compounds of formula (I) are advantageously carried out in aprotic inert organic solvents. Such solvents are hydrocarbons such as benzene, toluene, xylene or cyclohexane, chlorinated hydrocarbons such as dichloromethane, trichloromethane, tetrachloromethane or chlorobenzene, ethers such as diethyl ether, ethylene glycol dimethyl ether, diethylene glycol dimethyl ether, tetrahydrofuran or dioxane, nitriles such as acetonitrile or propionitrile, amides such as N,N-dimethylformamide, diethylformamide or N-methylpyrrolidinone. The reaction temperatures are advantageously between −20° C. and +120° C. In general, the reactions are slightly exothermic and, as a rule, they can be carried out at ambient temperature. To shorten the reaction time, or else to start the reaction, the mixture may be heated briefly to the boiling point of the reaction mixture. The reaction times can also be shortened by adding a few drops of base as reaction catalyst. Suitable bases are, in particular, tertiary amines such as trimethylamine, triethylamine, quinuclidine, 4-dimethylaminopyridine 1,4-diazabicyclo[2.2.2]octane, 1,5-diazabicyclo[4.3.0]non-5-ene or 1,5-diazabicyclo[5.4.0]undec-7-ene. However, inorganic bases such as hydrides, e.g. sodium hydride or calcium hydride, hydroxides, e.g. sodium hydroxide or potassium hydroxide, carbonates such as sodium carbonate and potassium carbonate, or hydrogen carbonates such as potassium hydrogen carbonate and sodium hydrogen carbonate may also be used as bases. The bases can be used as such or else with catalytic amounts of a phase-transfer catalyst, for example a crown ether, in particular 18-crown-6, or a tetraalkylammonium salt.

When R* is hydroxy, such reactions are usually carried out in the presence of a coupling reagent, such as DCC (N,N′-dicyclohexylcarbodiimide), EDC (1-ethyl-3-[3-dimethylamino-propyl]carbodiimide hydrochloride) or BOP-CI (bis(2-oxo-3-oxazolidinyl)phosphonic chloride), in the presence of a base, such as pyridine, triethylamine, 4-(dimethylamino)-pyridine or diisopropylethylamine, and optionally in the presence of a nucleophilic catalyst, such as hydroxybenzotriazole. When R* is Cl, such reactions are usually carried out under basic conditions (for example in the presence of pyridine, triethylamine, 4-(dimethylamino)-pyridine or diisopropylethylamine), again optionally in the presence of a nucleophilic catalyst. Alternatively, it is possible to conduct the reaction in a biphasic system comprising an organic solvent, preferably ethyl acetate, and an aqueous solvent, preferably a solution of sodium bicarbonate. When R* is C₁-C₆alkoxy it is sometimes possible to convert the ester directly to the amide by heating the ester and amine together in a thermal process.

The intermediates of formula (II) can be prepared using synthetic methods described herein or in analogy to the known methods by those skilled in art such as, the method incorporated by reference Bioorg. Med. Chem. Lett. 2010, 20, 7317.

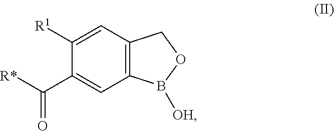

Compounds of formula (II) can be prepared by using the synthetic methods described herein. The Scheme-1, Scheme-2, Scheme-3, Scheme-4 and Scheme-5 describes the synthetic route for the preparation of the key intermediate, formula (II)

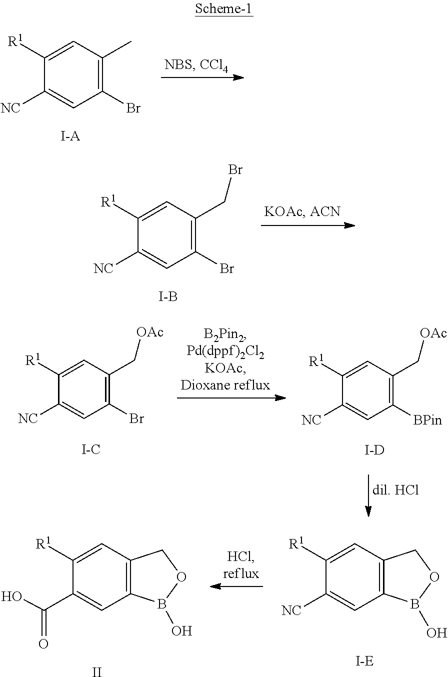

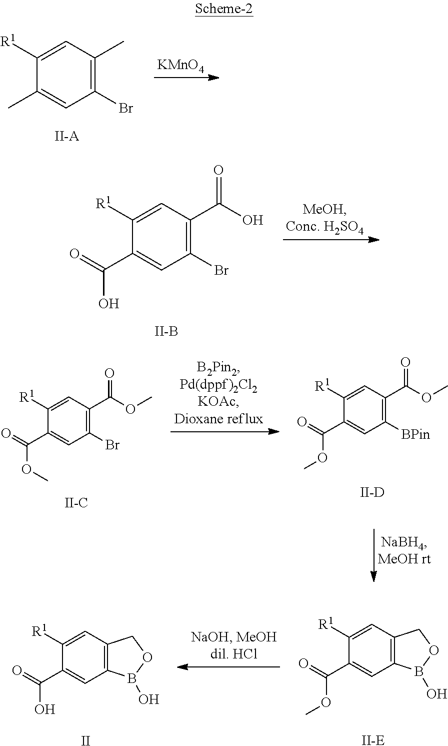

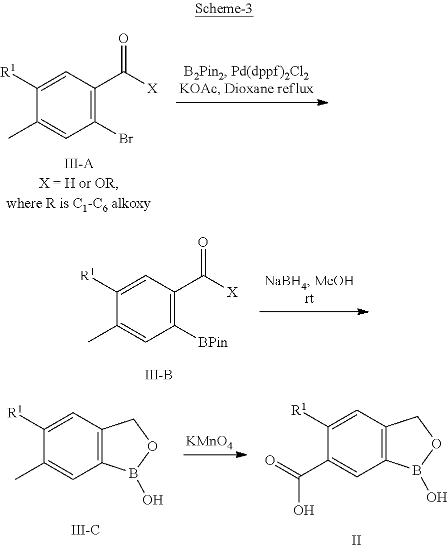

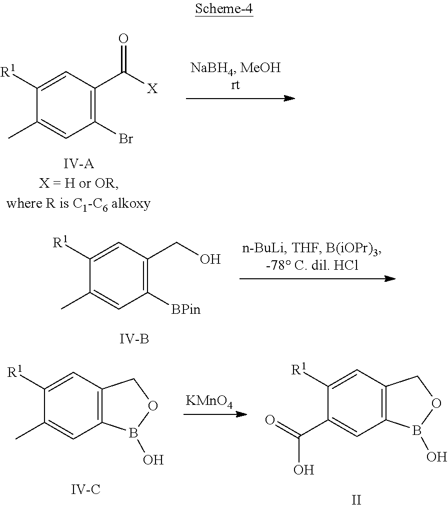

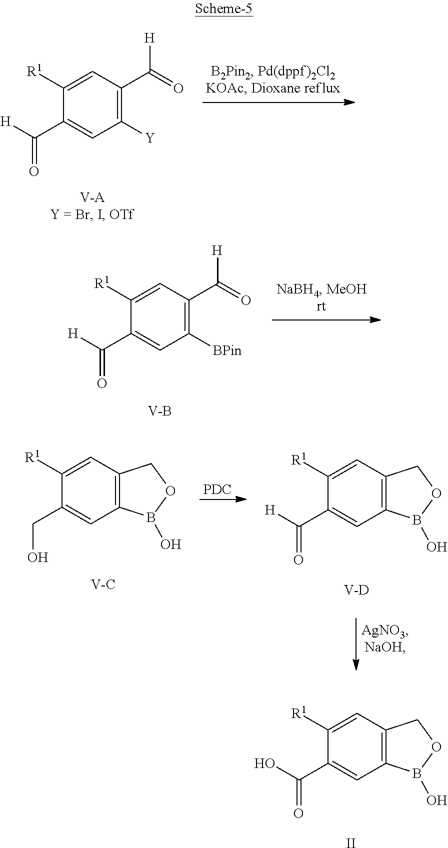

The invention therefore also relates to a method of controlling or preventing infestation of useful plants by phytopathogenic microorganisms, wherein a compound of formula (I) is applied as active ingredient to the plants, to parts thereof or the locus thereof. The compounds of formula (I) according to the invention are distinguished by excellent activity at low rates of application, by being well tolerated by plants and by being environmentally safe. They have very useful curative, preventive and systemic properties and are used for protecting numerous useful plants. The compounds of formula (I) can be used to inhibit or destroy the diseases that occur on plants or parts of plants (fruit, blossoms, leaves, stems, tubers, roots) of different crops of useful plants, while at the same time protecting also those parts of the plants that grow later e.g. from phytopathogenic microorganisms.

It is also possible to use compounds of formula (I) as dressing agents for the treatment of plant propagation material, in particular of seeds (fruit, tubers, grains) and plant cuttings (e.g. rice), for the protection against fungal infections as well as against phytopathogenic fungi occurring in the soil.

Furthermore, the compounds of formula (I) according to the invention may be used for controlling fungi in related areas, for example in the protection of technical materials, including wood and wood related technical products, in food storage or in hygiene management.

The methods according to the instant invention are particularly effective to protect useful plants or plant propagation material thereof against phytopathogenic fungi belonging to the following classes: Ascomycetes (e.g. the genus Cochliobolus, Colletotrichum, Fusarium, Gaeumannomyces, Giberella, Monographella, Microdochium, Penicillium, Phoma, Pyricularia, Magnaporthe, Septoria, Pseudocercosporella, Tapesia and Thielaviopsis); Basidiomycetes (e.g. the genus Phakopsora, Puccinia, Rhizoctonia, Thanatephorus, Sphacelotheca, Tilletia, Typhula and Ustilago); Fungi imperfecti (also known as Deuteromycetes; e.g. the genus Ascochyta, Diplodia, Erysiphe, Fusarium, Helminthosporium, Phomopsis, Pyrenophora and Verticillium); Oomycetes (e.g. Aphanomyces, Peronospora, Peronosclerospora, Phytophthora, Plasmopara, Pseudoperonospora, Pythium); and Zygomycets (e.g. the genus Rhizopus).

Within the scope of the invention, useful plants to be protected typically comprise the following species of plants: cereal (wheat, barley, rye, oat, rice, maize, sorghum and related species); beet (sugar beet and fodder beet); pomes, drupes and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (pumpkins, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamomum, camphor) or plants such as tobacco, nuts, coffee, eggplants, sugar cane, tea, pepper, vines, hops, bananas and natural rubber plants, as well as ornamentals.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); NatureGard® Agrisure® GT Advantage (GA21 glyphosate-tolerant trait), Agrisure® CB Advantage (Bt11 corn borer (CB) trait), Agrisure® RW (corn rootworm trait) and Protecta®.

The term “crops” is to be understood as including also crop plants which have been so transformed by the use of recombinant DNA techniques that they are capable of synthesising one or more selectively acting toxins, such as are known, for example, from toxin-producing bacteria, especially those of the genus Bacillus.

Toxins that can be expressed by such transgenic plants include, for example, insecticidal proteins from Bacillus cereus or Bacillus popilliae; or insecticidal proteins from Bacillus thuringiensis, such as δ-endotoxins, e.g. Cry1Ab, Cry1Ac, Cry1F, Cry1Fa2, Cry2Ab, Cry3A, Cry3Bb1 or Cry9C, or vegetative insecticidal proteins (Vip), e.g. Vip1, Vip2, Vip3 or Vip3A; or insecticidal proteins of bacteria colonising nematodes, for example Photorhabdus spp. or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins, plant lectins, such as pea lectins, barley lectins or snowdrop lectins; agglutinins; proteinase inhibitors, such as trypsin inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In the context of the present invention there are to be understood by δ-endotoxins, for example Cry1Ab, Cry1Ac, Cry1F, Cry1Fa2, Cry2Ab, Cry3A, Cry3Bb1 or Cry9C, or vegetative insecticidal proteins (Vip), for example Vip1, Vip2, Vip3 or Vip3A, expressly also hybrid toxins, truncated toxins and modified toxins. Hybrid toxins are produced recombinantly by a new combination of different domains of those proteins (see, for example, WO 02/15701). Truncated toxins, for example a truncated Cry1Ab, are known. In the case of modified toxins, one or more amino acids of the naturally occurring toxin are replaced. In such amino acid replacements, preferably non-naturally present protease recognition sequences are inserted into the toxin, such as, for example, in the case of Cry3A055, a cathepsin-G-recognition sequence is inserted into a Cry3A toxin (see WO03/018810).

Examples of such toxins or transgenic plants capable of synthesising such toxins are disclosed, for example, in EP-A-0 374 753, WO93/07278, WO95/34656, EP-A-0 427 529, EP-A-451 878 and WO03/052073.

The processes for the preparation of such transgenic plants are generally known to the person skilled in the art and are described, for example, in the publications mentioned above. CryI-type deoxyribonucleic acids and their preparation are known, for example, from WO 95/34656, EP-A-0 367 474, EP-A-0 401 979 and WO 90/13651.

The toxin contained in the transgenic plants imparts to the plants tolerance to harmful insects. Such insects can occur in any taxonomic group of insects, but are especially commonly found in the beetles (Coleoptera), two-winged insects (Diptera) and butterflies (Lepidoptera).

Transgenic plants containing one or more genes that code for an insecticidal resistance and express one or more toxins are known and some of them are commercially available. Examples of such plants are: YieldGard® (maize variety that expresses a Cry1Ab toxin); YieldGard Rootworm® (maize variety that expresses a Cry3Bb1 toxin); YieldGard Plus® (maize variety that expresses a Cry1Ab and a Cry3Bb1 toxin); Starlink® (maize variety that expresses a Cry9C toxin); Herculex I® (maize variety that expresses a Cry1Fa2 toxin and the enzyme phosphinothricine N-acetyltransferase (PAT) to achieve tolerance to the herbicide glufosinate ammonium); NuCOTN 33B® (cotton variety that expresses a Cry1Ac toxin); Bollgard I® (cotton variety that expresses a Cry1Ac toxin); Bollgard II® (cotton variety that expresses a Cry1Ac and a Cry2Ab toxin); VipCot® (cotton variety that expresses a Vip3A and a Cry1Ab toxin); NewLeaf® (potato variety that expresses a Cry3A toxin); NatureGard®, Agrisure® GT Advantage (GA21 glyphosate-tolerant trait), Agrisure® CB Advantage (Bt11 corn borer (CB) trait) and Protecta®.

Further examples of such transgenic crops are:

1. Bt11 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated Cry1Ab toxin. Bt11 maize also transgenically expresses the enzyme PAT to achieve tolerance to the herbicide glufosinate ammonium.
2. Bt176 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a Cry1Ab toxin. Bt176 maize also transgenically expresses the enzyme PAT to achieve tolerance to the herbicide glufosinate ammonium.
3. MIR604 Maize from Syngenta Seeds SAS, Chemin de l'Hobit 27, F-31 790 St. Sauveur, France, registration number C/FR/96/05/10. Maize which has been rendered insect-resistant by transgenic expression of a modified Cry3A toxin. This toxin is Cry3A055 modified by insertion of a cathepsin-G-protease recognition sequence. The preparation of such transgenic maize plants is described in WO 03/018810.
4. MON 863 Maize from Monsanto Europe S.A. 270-272 Avenue de Tervuren, B-1150 Brussels, Belgium, registration number C/DE/02/9. MON 863 expresses a Cry3Bb1 toxin and has resistance to certain Coleoptera insects.
5. IPC 531 Cotton from Monsanto Europe S.A. 270-272 Avenue de Tervuren, B-1150 Brussels, Belgium, registration number C/ES/96/02.
6. 1507 Maize from Pioneer Overseas Corporation, Avenue Tedesco, 7 B-1160 Brussels, Belgium, registration number C/NL/00/10. Genetically modified maize for the expression of the protein Cry1F for achieving resistance to certain Lepidoptera insects and of the PAT protein for achieving tolerance to the herbicide glufosinate ammonium.
7. NK603 ×MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603×MON 810 Maize transgenically expresses the protein CP4 EPSPS, obtained from Agrobacterium sp. strain CP4, which imparts tolerance to the herbicide Roundup® (contains glyphosate), and also a Cry1Ab toxin obtained from Bacillus thuringiensis subsp. kurstaki which brings about tolerance to certain Lepidoptera, include the European corn borer.

Transgenic crops of insect-resistant plants are also described in BATS (Zentrum für Biosicherheit and Nachhaltigkeit, Zentrum BATS, Clarastrasse 13, 4058 Basel, Switzerland) Report 2003, (http://bats.ch).

The term “crops” is to be understood as including also crop plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818 and EP-A-0 353 191. The methods of producing such transgenic plants are generally known to the person skilled in the art and are described, for example, in the publications mentioned above.

Crops may also be modified for enhanced resistance to fungal (for example Fusarium, Anthracnose, or Phytophthora), bacterial (for example Pseudomonas) or viral (for example potato leafroll virus, tomato spotted wilt virus, cucumber mosaic virus) pathogens.

Crops also include those that have enhanced resistance to nematodes, such as the soybean cyst nematode.

Crops that are tolerance to abiotic stress include those that have enhanced tolerance to drought, high salt, high temperature, chill, frost, or light radiation, for example through expression of NF-YB or other proteins known in the art.

Antipathogenic substances which can be expressed by such transgenic plants include, for example, ion channel blockers, such as blockers for sodium and calcium channels, for example the viral KP1, KP4 or KP6 toxins; stilbene synthases; bibenzyl synthases; chitinases; glucanases; the so-called “pathogenesis-related proteins” (PRPs; see e.g. EP-A-0 392 225); antipathogenic substances produced by microorganisms, for example peptide antibiotics or heterocyclic antibiotics (see e.g. WO 95/33818) or protein or polypeptide factors involved in plant pathogen defence (so-called “plant disease resistance genes”, as described in WO 03/000906).

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

The compounds of formula (I) can be used in unmodified form or, preferably, together with carriers and adjuvants conventionally employed in the art of formulation.

Therefore the invention also relates to compositions for controlling and protecting against phytopathogenic microorganisms, comprising a compound of formula (I) and an inert carrier, and to a method of controlling or preventing infestation of useful plants by phytopathogenic microorganisms, wherein a composition, comprising a compound of formula (I) as active ingredient and an inert carrier, is applied to the plants, to parts thereof or the locus thereof.

To this end compounds of formula (I) and inert carriers are conveniently formulated in known manner to emulsifiable concentrates, coatable pastes, directly sprayable or dilutable solutions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

Suitable carriers and adjuvants (auxiliaries) can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

The invention therefore also relates to pesticidal compositions such as emulsifiable concentrates, suspension concentrates, microemulsions, oil dispersibles, directly sprayable or dilutable solutions, spreadable pastes, dilute emulsions, soluble powders, dispersible powders, wettable powders, dusts, granules or encapsulations in polymeric substances, which comprise—at least—one of the active ingredients according to the invention and which are to be selected to suit the intended aims and the prevailing circumstances.

In these compositions, the active ingredient is employed in pure form, a solid active ingredient for example in a specific particle size, or, preferably, together with—at least—one of the auxiliaries conventionally used in the art of formulation, such as extenders, for example solvents or solid carriers, or such as surface-active compounds (surfactants).

Examples of suitable solvents are: unhydrogenated or partially hydrogenated aromatic hydrocarbons, preferably the fractions C₈ to C₁₂ of alkylbenzenes, such as xylene mixtures, alkylated naphthalenes or tetrahydronaphthalene, aliphatic or cycloaliphatic hydrocarbons, such as paraffins or cyclohexane, alcohols such as ethanol, propanol or butanol, glycols and their ethers and esters such as propylene glycol, dipropylene glycol ether, ethylene glycol or ethylene glycol monomethyl ether or ethylene glycol monoethyl ether, ketones, such as cyclohexanone, isophorone or diacetone alcohol, strongly polar solvents, such as N-methylpyrrolid-2-one, dimethyl sulfoxide or N,N-dimethylformamide, water, unepoxidized or epoxidized vegetable oils, such as unexpodized or epoxidized rapeseed, castor, coconut or soya oil, and silicone oils.

Solid carriers which are used for example for dusts and dispersible powders are, as a rule, ground natural minerals such as calcite, talc, kaolin, montmorillonite or attapulgite. To improve the physical properties, it is also possible to add highly disperse silicas or highly disperse absorbtive polymers. Suitable adsorptive carriers for granules are porous types, such as pumice, brick grit, sepiolite or bentonite, and suitable non-sorptive carrier materials are calcite or sand. In addition, a large number of granulated materials of inorganic or organic nature can be used, in particular dolomite or comminuted plant residues.

Suitable surface-active compounds are, depending on the type of the active ingredient to be formulated, non-ionic, cationic and/or anionic surfactants or surfactant mixtures which have good emulsifying, dispersing and wetting properties. The surfactants mentioned below are only to be considered as examples; a large number of further surfactants which are conventionally used in the art of formulation and suitable according to the invention are described in the relevant literature.

Suitable non-ionic surfactants are, especially, polyglycol ether derivatives of aliphatic or cycloaliphatic alcohols, of saturated or unsaturated fatty acids or of alkyl phenols which may contain approximately 3 to approximately 30 glycol ether groups and approximately 8 to approximately 20 carbon atoms in the (cyclo)aliphatic hydrocarbon radical or approximately 6 to approximately 18 carbon atoms in the alkyl moiety of the alkyl phenols. Also suitable are water-soluble polyethylene oxide adducts with polypropylene glycol, ethylenediaminopolypropylene glycol or alkyl polypropylene glycol having 1 to approximately 10 carbon atoms in the alkyl chain and approximately 20 to approximately 250 ethylene glycol ether groups and approximately 10 to approximately 100 propylene glycol ether groups. Normally, the abovementioned compounds contain 1 to approximately 5 ethylene glycol units per propylene glycol unit. Examples which may be mentioned are nonylphenoxypolyethoxyethanol, castor oil polyglycol ether, polypropylene glycol/polyethylene oxide adducts, tributylpheno-xypolyethoxyethanol, polyethylene glycol or octylphenoxypolyethoxyethanol. Also suitable are fatty acid esters of polyoxyethylene sorbitan, such as polyoxyethylene sorbitan trioleate.

The cationic surfactants are, especially, quarternary ammonium salts which generally have at least one alkyl radical of approximately 8 to approximately 22 C atoms as substituents and as further substituents (unhalogenated or halogenated) lower alkyl or hydroxyalkyl or benzyl radicals. The salts are preferably in the form of halides, methylsulfates or ethylsulfates. Examples are stearyltrimethylammonium chloride and benzylbis(2-chloroethyl)ethylammonium bromide.

Examples of suitable anionic surfactants are water-soluble soaps or water-soluble synthetic surface-active compounds. Examples of suitable soaps are the alkali, alkaline earth or (unsubstituted or substituted) ammonium salts of fatty acids having approximately 10 to approximately 22 C atoms, such as the sodium or potassium salts of oleic or stearic acid, or of natural fatty acid mixtures which are obtainable for example from coconut or tall oil; mention must also be made of the fatty acid methyl taurates. However, synthetic surfactants are used more frequently, in particular fatty sulfonates, fatty sulfates, sulfonated benzimidazole derivatives or alkylaryl sulfonates. As a rule, the fatty sulfonates and fatty sulfates are present as alkali, alkaline earth or (substituted or unsubstituted) ammonium salts and they generally have an alkyl radical of approximately 8 to approximately 22 C atoms, alkyl also to be understood as including the alkyl moiety of acyl radicals; examples which may be mentioned are the sodium or calcium salts of lignosulfonic acid, of the dodecylsulfuric ester or of a fatty alcohol sulfate mixture prepared from natural fatty acids. This group also includes the salts of the sulfuric esters and sulfonic acids of fatty alcohol/ethylene oxide adducts. The sulfonated benzimidazole derivatives preferably contain 2 sulfonyl groups and a fatty acid radical of approximately 8 to approximately 22 C atoms. Examples of alkylarylsulfonates are the sodium, calcium or triethanolammonium salts of decylbenzenesulfonic acid, of dibutylnaphthalenesulfonic acid or of a naphthalenesulfonic acid/formaldehyde condensate. Also possible are, furthermore, suitable phosphates, such as salts of the phosphoric ester of a p-nonylphenol/(4-14)ethylene oxide adduct, or phospholipids.

As a rule, the compositions comprise 0.1 to 99%, especially 0.1 to 95%, of active ingredient and 1 to 99.9%, especially 5 to 99.9%, of at least one solid or liquid adjuvant, it being possible as a rule for 0 to 25%, especially 0.1 to 20%, of the composition to be surfactants (% in each case meaning percent by weight). Whereas concentrated compositions tend to be preferred for commercial goods, the end consumer as a rule uses dilute compositions which have substantially lower concentrations of active ingredient.

Typically, a pre-mix formulation for foliar application comprises 0.1 to 99.9%, especially 1 to 95%, of the desired ingredients, and 99.9 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Normally, a tank-mix formulation for seed treatment application comprises 0.25 to 80%, especially 1 to 75%, of the desired ingredients, and 99.75 to 20%, especially 99 to 25%, of a solid or liquid auxiliaries (including, for example, a solvent such as water), where the auxiliaries can be a surfactant in an amount of 0 to 40%, especially 0.5 to 30%, based on the tank-mix formulation.

Typically, a pre-mix formulation for seed treatment application comprises 0.5 to 99.9%, especially 1 to 95%, of the desired ingredients, and 99.5 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Whereas commercial products will preferably be formulated as concentrates (e.g., pre-mix composition (formulation)), the end user will normally employ dilute formulations (e.g., tank mix composition).

Preferred seed treatment pre-mix formulations are aqueous suspension concentrates. The formulation can be applied to the seeds using conventional treating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art.

In general, the pre-mix compositions of the invention contain 0.5 to 99.9 especially 1 to 95, advantageously 1 to 50%, by mass of the desired ingredients, and 99.5 to 0.1, especially 99 to 5%, by mass of a solid or liquid adjuvant (including, for example, a solvent such as water), where the auxiliaries (or adjuvant) can be a surfactant in an amount of 0 to 50, especially 0.5 to 40%, by mass based on the mass of the pre-mix formulation.

The compounds of formula (I) or compositions, comprising a compound of formula (I) as active ingredient and an inert carrier, can be applied to the locus of the plant or plant to be treated, simultaneously or in succession with further compounds. These further compounds can be e.g. fertilizers or micronutrient donors or other preparations which influence the growth of plants. They can also be selective herbicides as well as insecticides, fungicides, bactericides, nematicides, molluscicides or mixtures of several of these preparations, if desired together with further carriers, surfactants or application promoting adjuvants customarily employed in the art of formulation.

A preferred method of applying a compound of formula (I), or a composition, comprising a compound of formula (I) as active ingredient and an inert carrier, is foliar application. The frequency of application and the rate of application will depend on the risk of infestation by the corresponding pathogen.

However, the compounds of formula (I) can also penetrate the plant through the roots via the soil (systemic action) by drenching the locus of the plant with a liquid formulation, or by applying the compounds in solid form to the soil, e.g. in granular form (soil application). In crops of water rice such granulates can be applied to the flooded rice field. The compounds of formula (I) may also be applied to seeds (coating) by impregnating the seeds or tubers either with a liquid formulation of the fungicide or coating them with a solid formulation.

A formulation, i.e. a composition comprising the compound of formula (I) and, if desired, a solid or liquid adjuvant or, if desired as well, a further, other biocidally active ingredient, is prepared in a known manner, typically by intimately mixing and/or grinding the compound with extenders, for example solvents, solid carriers and, optionally, surface-active compounds (surfactants).

The activity of the compositions according to the invention can be broadened considerably, and adapted to prevailing circumstances, by adding other insecticidally, acaricidally and/or fungicidally active ingredients. The mixtures of the compounds of formula (I) with other insecticidally, acaricidally and/or fungicidally active ingredients may also have further surprising advantages which can also be described, in a wider sense, as synergistic activity. For example, better tolerance by plants, reduced phytotoxicity, insects can be controlled in their different development stages or better behaviour during their production, for example during grinding or mixing, during their storage or during their use. Suitable additions to active ingredients here are, for example, representatives of the following classes of active ingredients: organophosphorus compounds, nitrophenol derivatives, thioureas, juvenile hormones, formamidines, benzophenone derivatives, ureas, pyrrole derivatives, carbamates, pyrethroids, chlorinated hydrocarbons, acylureas, pyridylmethyleneamino derivatives, macrolides, neonicotinoids and Bacillus thuringiensis preparations.

The compositions can also comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers, fertilizers or other active ingredients for achieving specific effects, for example bactericides, fungicides, nematocides, plant activators, molluscicides or herbicides.

The compositions according to the invention are prepared in a manner known per se, in the absence of auxiliaries for example by grinding, screening and/or compressing a solid active ingredient and in the presence of at least one auxiliary for example by intimately mixing and/or grinding the active ingredient with the auxiliary (auxiliaries). These processes for the preparation of the compositions and the use of the compounds I for the preparation of these compositions are also a subject of the invention.

The application methods for the compositions, that is the methods of controlling pests of the abovementioned type, such as spraying, atomizing, dusting, brushing on, dressing, scattering or pouring—which are to be selected to suit the intended aims of the prevailing circumstances—and the use of the compositions for controlling pests of the abovementioned type are other subjects of the invention. Typical rates of concentration are between 0.1 and 1000 ppm, preferably between 0.1 and 500 ppm, of active ingredient. The rate of application per hectare is generally 1 to 2000 g of active ingredient per hectare, in particular 10 to 1000 g/ha, preferably 10 to 600 g/ha.

A preferred method of application in the field of crop protection is application to the foliage of the plants (foliar application), it being possible to select frequency and rate of application to match the danger of infestation with the pest in question. Alternatively, the active ingredient can reach the plants via the root system (systemic action), by drenching the locus of the plants with a liquid composition or by incorporating the active ingredient in solid form into the locus of the plants, for example into the soil, for example in the form of granules (soil application). In the case of paddy rice crops, such granules can be metered into the flooded paddy-field.

The compositions according to the invention are also suitable for the protection of plant propagation material, for example seeds, such as fruit, tubers or kernels, or nursery plants, against pests of the abovementioned type. The propagation material can be treated with the compositions prior to planting, for example seed can be treated prior to sowing. Alternatively, the compositions can be applied to seed kernels (coating), either by soaking the kernels in a liquid composition or by applying a layer of a solid composition. It is also possible to apply the compositions when the propagation material is planted to the site of application, for example into the seed furrow during drilling. These treatment methods for plant propagation material and the plant propagation material thus treated are further subjects of the invention.

The activity of the compositions according to the invention can be broadened considerably, and adapted to prevailing circumstances, by adding other insecticidally, acaricidally and/or fungicidally active ingredients. The mixtures of the compounds of formula (I) with other insecticidally, acaricidally and/or fungicidally active ingredients may also have further surprising advantages which can also be described, in a wider sense, as synergistic activity. For example, better tolerance by plants, reduced phytotoxicity, insects can be controlled in their different development stages or better behaviour during their production, for example during grinding or mixing, during their storage or during their use. Suitable additions to active ingredients here are, for example, representatives of the following classes of active ingredients: organophosphorus compounds, nitrophenol derivatives, thioureas, juvenile hormones, formamidines, benzophenone derivatives, ureas, pyrrole derivatives, carbamates, pyrethroids, chlorinated hydrocarbons, acylureas, pyridylmethyleneamino derivatives, macrolides, neonicotinoids and Bacillus thuringiensis preparations.

The following mixtures of the compounds of formula I with active ingredients are preferred (the abbreviation “TX” means “one compound selected from the group consisting of the compounds described in Table T1, T1-A or from the Tables 1 to 7 of the present invention”): an adjuvant selected from the group of substances consisting of petroleum oils (alternative name) (628)+TX, an acaricide selected from the group of substances consisting of 1,1-bis(4-chlorophenyl)-2-ethoxyethanol (IUPAC name) (910)+TX, 2,4-dichlorophenyl benzenesulfonate (IUPAC/Chemical Abstracts name) (1059)+TX, 2-fluoro-N-methyl-N-1-naphthylacetamide (IUPAC name) (1295)+TX, 4-chlorophenyl phenyl sulfone (IUPAC name) (981)+TX, abamectin (1)+TX, acequinocyl (3)+TX, acetoprole [CCN]+TX, acrinathrin (9)+TX, aldicarb (16)+TX, aldoxycarb (863)+TX, alpha-cypermethrin (202)+TX, amidithion (870)+TX, amidoflumet [CCN]+TX, amidothioate (872)+TX, amiton (875)+TX, amiton hydrogen oxalate (875)+TX, amitraz (24)+TX, aramite (881)+TX, arsenous oxide (882)+TX, AVI 382 (compound code)+TX, AZ 60541 (compound code)+TX, azinphos-ethyl (44)+TX, azinphos-methyl (45)+TX, azobenzene (IUPAC name) (888)+TX, azocyclotin (46)+TX, azothoate (889)+TX, benomyl (62)+TX, benoxafos (alternative name) [CCN]+TX, benzoximate (71)+TX, benzyl benzoate (IUPAC name) [CCN]+TX, bifenazate (74)+TX, bifenthrin (76)+TX, binapacryl (907)+TX, brofenvalerate (alternative name)+TX, bromo-cyclen (918)+TX, bromophos (920)+TX, bromophos-ethyl (921)+TX, bromopropylate (94)+TX, buprofezin (99)+TX, butocarboxim (103)+TX, butoxycarboxim (104)+TX, butylpyridaben (alternative name)+TX, calcium polysulfide (IUPAC name) (111)+TX, camphechlor (941)+TX, carbanolate (943)+TX, carbaryl (115)+TX, carbofuran (118)+TX, carbophenothion (947)+TX, CGA 50′439 (development code) (125)+TX, chinomethionat (126)+TX, chlorbenside (959)+TX, chlordimeform (964)+TX, chlordimeform hydrochloride (964)+TX, chlorfenapyr (130)+TX, chlorfenethol (968)+TX, chlorfenson (970)+TX, chlorfensulfide (971)+TX, chlorfenvinphos (131)+TX, chlorobenzilate (975)+TX, chloromebuform (977)+TX, chloromethiuron (978)+TX, chloropropylate (983)+TX, chlorpyrifos (145)+TX, chlorpyrifos-methyl (146)+TX, chlorthiophos (994)+TX, cinerin I (696)+TX, cinerin II (696)+TX, cinerins (696)+TX, clofentezine (158)+TX, closantel (alternative name) [CCN]+TX, coumaphos (174)+TX, crotamiton (alternative name)

[CCN]+TX, crotoxyphos (1010)+TX, cufraneb (1013)+TX, cyanthoate (1020)+TX, cyflumetofen (CAS Reg. No.: 400882-07-7)+TX, cyhalothrin (196)+TX, cyhexatin (199)+TX, cypermethrin (201)+TX, DCPM (1032)+TX, DDT (219)+TX, demephion (1037)+TX, demephion-O (1037)+TX, demephion-S (1037)+TX, demeton (1038)+TX, demeton-methyl (224)+TX, demeton-O (1038)+TX, demeton-O-methyl (224)+TX, demeton-S (1038)+TX, demeton-S-methyl (224)+TX, demeton-S-methylsulfon (1039)+TX, diafenthiuron (226)+TX, dialifos (1042)+TX, diazinon (227)+TX, dichlofluanid (230)+TX, dichlorvos (236)+TX, dicliphos (alternative name)+TX, dicofol (242)+TX, dicrotophos (243)+TX, dienochlor (1071)+TX, dimefox (1081)+TX, dimethoate (262)+TX, dinactin (alternative name) (653)+TX, dinex (1089)+TX, dinex-diclexine (1089)+TX, dinobuton (269)+TX, dinocap (270)+TX, dinocap-4 [CCN]+TX, dinocap-6 [CCN]+TX, dinocton (1090)+TX, dinopenton (1092)+TX, dinosulfon (1097)+TX, dinoterbon (1098)+TX, dioxathion (1102)+TX, diphenyl sulfone (IUPAC name) (1103)+TX, disulfiram (alternative name) [CCN]+TX, disulfoton (278)+TX, DNOC (282)+TX, dofenapyn (1113)+TX, doramectin (alternative name) [CCN]+TX, endosulfan (294)+TX, endothion (1121)+TX, EPN (297)+TX, eprinomectin (alternative name) [CCN]+TX, ethion (309)+TX, ethoate-methyl (1134)+TX, etoxazole (320)+TX, etrimfos (1142)+TX, fenazaflor (1147)+TX, fenazaquin (328)+TX, fenbutatin oxide (330)+TX, fenothiocarb (337)+TX, fenpropathrin (342)+TX, fenpyrad (alternative name)+TX, fen-pyroximate (345)+TX, fenson (1157)+TX, fentrifanil (1161)+TX, fenvalerate (349)+TX, fipronil (354)+TX, fluacrypyrim (360)+TX, fluazuron (1166)+TX, flubenzimine (1167)+TX, flucycloxuron (366)+TX, flucythrinate (367)+TX, fluenetil (1169)+TX, flufenoxuron (370)+TX, flumethrin (372)+TX, fluorbenside (1174)+TX, fluvalinate (1184)+TX, FMC 1137 (development code) (1185)+TX, formetanate (405)+TX, formetanate hydrochloride (405)+TX, formothion (1192)+TX, formparanate (1193)+TX, gamma-HCH (430)+TX, glyodin (1205)+TX, halfenprox (424)+TX, heptenophos (432)+TX, hexadecyl cyclopropanecarboxylate (IUPAC/Chemical Abstracts name) (1216)+TX, hexythiazox (441)+TX, iodomethane (IUPAC name) (542)+TX, isocarbophos (alternative name) (473)+TX, isopropyl O-(methoxyaminothiophosphoryl)salicylate (IUPAC name) (473)+TX, ivermectin (alternative name) [CCN]+TX, jasmolin I (696)+TX, jasmolin II (696)+TX, jodfenphos (1248)+TX, lindane (430)+TX, lufenuron (490)+TX, malathion (492)+TX, malonoben (1254)+TX, mecarbam (502)+TX, mephosfolan (1261)+TX, mesulfen (alternative name) [CCN]+TX, methacrifos (1266)+TX, methamidophos (527)+TX, methidathion (529)+TX, methiocarb (530)+TX, methomyl (531)+TX, methyl bromide (537)+TX, metolcarb (550)+TX, mevinphos (556)+TX, mexacarbate (1290)+TX, milbemectin (557)+TX, milbemycin oxime (alternative name) [CCN]+TX, mipafox (1293)+TX, monocrotophos (561)+TX, morphothion (1300)+TX, moxidectin (alternative name) [CCN]+TX, naled (567)+TX, NC-184 (compound code)+TX, NC-512 (compound code)+TX, nifluridide (1309)+TX, nikkomycins (alternative name) [CCN]+TX, nitrilacarb (1313)+TX, nitrilacarb 1:1 zinc chloride complex (1313)+TX, NNI-0101 (compound code)+TX, NNI-0250 (compound code)+TX, omethoate (594)+TX, oxamyl (602)+TX, oxydeprofos (1324)+TX, oxydisulfoton (1325)+TX, pp′-DDT (219)+TX, parathion (615)+TX, permethrin (626)+TX, petroleum oils (alternative name) (628)+TX, phenkapton (1330)+TX, phenthoate (631)+TX, phorate (636)+TX, phosalone (637)+TX, phosfolan (1338)+TX, phosmet (638)+TX, phosphamidon (639)+TX, phoxim (642)+TX, pirimiphos-methyl (652)+TX, polychloroterpenes (traditional name) (1347)+TX, polynactins (alternative name) (653)+TX, proclonol (1350)+TX, profenofos (662)+TX, promacyl (1354)+TX, propargite (671)+TX, propetamphos (673)+TX, propoxur (678)+TX, prothidathion (1360)+TX, prothoate (1362)+TX, pyrethrin I (696)+TX, pyrethrin II (696)+TX, pyrethrins (696)+TX, pyridaben (699)+TX, pyridaphenthion (701)+TX, pyrimidifen (706)+TX, pyrimitate (1370)+TX, quinalphos (711)+TX, quintiofos (1381)+TX, R-1492 (development code) (1382)+TX, RA-17 (development code) (1383)+TX, rotenone (722)+TX, schradan (1389)+TX, sebufos (alternative name)+TX, selamectin (alternative name) [CCN]+TX, SI-0009 (compound code)+TX, sophamide (1402)+TX, spirodiclofen (738)+TX, spiromesifen (739)+TX, SSI-121 (development code) (1404)+TX, sulfiram (alternative name) [CCN]+TX, sulfluramid (750)+TX, sulfotep (753)+TX, sulfur (754)+TX, SZI-121 (development code) (757)+TX, tau-fluvalinate (398)+TX, tebufenpyrad (763)+TX, TEPP (1417)+TX, terbam (alternative name)+TX, tetrachlorvinphos (777)+TX, tetradifon (786)+TX, tetranactin (alternative name) (653)+TX, tetrasul (1425)+TX, thiafenox (alternative name)+TX, thiocarboxime (1431)+TX, thiofanox (800)+TX, thiometon (801)+TX, thioquinox (1436)+TX, thuringiensin (alternative name) [CCN]+TX, triamiphos (1441)+TX, triarathene (1443)+TX, triazophos (820)+TX, triazuron (alternative name)+TX, trichlorfon (824)+TX, trifenofos (1455)+TX, trinactin (alternative name) (653)+TX, vamidothion (847)+TX, vaniliprole [CCN] and YI-5302 (compound code)+TX,

an algicide selected from the group of substances consisting of bethoxazin [CCN]+TX, copper dioctanoate (IUPAC name) (170)+TX, copper sulfate (172)+TX, cybutryne [CCN]+TX, dichlone (1052)+TX, dichlorophen (232)+TX, endothal (295)+TX, fentin (347)+TX, hydrated lime [CCN]+TX, nabam (566)+TX, quinoclamine (714)+TX, quinonamid (1379)+TX, simazine (730)+TX, triphenyltin acetate (IUPAC name) (347) and triphenyltin hydroxide (IUPAC name) (347)+TX, an anthelmintic selected from the group of substances consisting of abamectin (1)+TX, crufomate (1011)+TX, doramectin (alternative name) [CCN]+TX, emamectin (291)+TX, emamectin benzoate (291)+TX, eprinomectin (alternative name) [CCN]+TX, ivermectin (alternative name) [CCN]+TX, milbemycin oxime (alternative name) [CCN]+TX, moxidectin (alternative name) [CCN]+TX, piperazine [CCN]+TX, selamectin (alternative name) [CCN]+TX, spinosad (737) and thiophanate (1435)+TX,
an avicide selected from the group of substances consisting of chloralose (127)+TX, endrin (1122)+TX, fenthion (346)+TX, pyridin-4-amine (IUPAC name) (23) and strychnine (745)+TX, a bactericide selected from the group of substances consisting of 1-hydroxy-1H-pyridine-2-thione (IUPAC name) (1222)+TX, 4-(quinoxalin-2-ylamino)benzenesulfonamide (IUPAC name) (748)+TX, 8-hydroxyquinoline sulfate (446)+TX, bronopol (97)+TX, copper dioctanoate (IUPAC name) (170)+TX, copper hydroxide (IUPAC name) (169)+TX, cresol [CCN]+TX, dichlorophen (232)+TX, dipyrithione (1105)+TX, dodicin (1112)+TX, fenaminosulf (1144)+TX, formaldehyde (404)+TX, hydrargaphen (alternative name) [CCN]+TX, kasugamycin (483)+TX, kasugamycin hydrochloride hydrate (483)+TX, nickel bis(dimethyldithiocarbamate) (IUPAC name) (1308)+TX, nitrapyrin (580)+TX, octhilinone (590)+TX, oxolinic acid (606)+TX, oxytetracycline (611)+TX, potassium hydroxyquinoline sulfate (446)+TX, probenazole (658)+TX, streptomycin (744)+TX, streptomycin sesquisulfate (744)+TX, tecloftalam (766)+TX, and thiomersal (alternative name) [CCN]+TX, a biological agent selected from the group of substances consisting of Adoxophyes orana GV (alternative name) (12)+TX, Agrobacterium radiobacter (alternative name) (13)+TX, Amblyseius spp. (alternative name) (19)+TX, Anagrapha falcifera NPV (alternative name) (28)+TX, Anagrus atomus (alternative name) (29)+TX, Aphelinus abdominalis (alternative name) (33)+TX, Aphidius colemani (alternative name) (34)+TX, Aphidoletes aphidimyza (alternative name) (35)+TX, Autographa californica NPV (alternative name) (38)+TX, Bacillus firmus (alternative name) (48)+TX, Bacillus sphaericus Neide (scientific name) (49)+TX, Bacillus thuringiensis Berliner (scientific name) (51)+TX, Bacillus thuringiensis subsp. aizawai (scientific name) (51)+TX, Bacillus thuringiensis subsp. israelensis (scientific name) (51)+TX, Bacillus thuringiensis subsp. japonensis (scientific name) (51)+TX, Bacillus thuringiensis subsp. kurstaki (scientific name) (51)+TX, Bacillus thuringiensis subsp. tenebrionis (scientific name) (51)+TX, Beauveria bassiana (alternative name) (53)+TX, Beauveria brongniartii (alternative name) (54)+TX, Chrysoperla carnea (alternative name) (151)+TX, Cryptolaemus montrouzieri (alternative name) (178)+TX, Cydia pomonella GV (alternative name) (191)+TX, Dacnusa sibirica (alternative name) (212)+TX, Diglyphus isaea (alternative name) (254)+TX, Encarsia formosa (scientific name) (293)+TX, Eretmocerus eremicus (alternative name) (300)+TX, Helicoverpa zea NPV (alternative name) (431)+TX, Heterorhabditis bacteriophora and H. megidis (alternative name) (433)+TX, Hippodamia convergens (alternative name) (442)+TX, Leptomastix dactylopii (alternative name) (488)+TX, Macrolophus caliginosus (alternative name) (491)+TX, Mamestra brassicae NPV (alternative name) (494)+TX, Metaphycus helvolus (alternative name) (522)+TX, Metarhizium anisopliae var. acridum (scientific name) (523)+TX, Metarhizium anisopliae var. anisopliae (scientific name) (523)+TX, Neodiprion sertifer NPV and N. lecontei NPV (alternative name) (575)+TX, Orius spp. (alternative name) (596)+TX, Paecilomyces fumosoroseus (alternative name) (613)+TX, Phytoseiulus persimilis (alternative name) (644)+TX, Spodoptera exigua multicapsid nuclear polyhedrosis virus (scientific name) (741)+TX, Steinernema bibionis (alternative name) (742)+TX, Steinernema carpocapsae (alternative name) (742)+TX, Steinernema feltiae (alternative name) (742)+TX, Steinernema glaseri (alternative name) (742)+TX, Steinernema riobrave (alternative name) (742)+TX, Steinernema riobravis (alternative name) (742)+TX, Steinernema scapterisci (alternative name) (742)+TX, Steinernema spp. (alternative name) (742)+TX, Trichogramma spp. (alternative name) (826)+TX, Typhlodromus occidentalis (alternative name) (844) and Verticillium lecanii (alternative name) (848)+TX,
a soil sterilant selected from the group of substances consisting of iodomethane (IUPAC name) (542) and methyl bromide (537)+TX,
a chemosterilant selected from the group of substances consisting of apholate [CCN]+TX, bisazir (alternative name) [CCN]+TX, busulfan (alternative name) [CCN]+TX, diflubenzuron (250)+TX, dimatif (alternative name) [CCN]+TX, hemel [CCN]+TX, hempa [CCN]+TX, metepa [CCN]+TX, methiotepa [CCN]+TX, methyl apholate [CCN]+TX, morzid [CCN]+TX, penfluron (alternative name) [CCN]+TX, tepa [CCN]+TX, thiohempa (alternative name) [CCN]+TX, thiotepa (alternative name) [CCN]+TX, tretamine (alternative name) [CCN] and uredepa (alternative name) [CCN]+TX, an insect pheromone selected from the group of substances consisting of (E)-dec-5-en-1-yl acetate with (E)-dec-5-en-1-ol (IUPAC name) (222)+TX, (E)-tridec-4-en-1-yl acetate (IUPAC name) (829)+TX, (E)-6-methylhept-2-en-4-ol (IUPAC name) (541)+TX, (E,Z)-tetradeca-4,10-dien-1-yl acetate (IUPAC name) (779)+TX, (Z)-dodec-7-en-1-yl acetate (IUPAC name) (285)+TX, (Z)-hexadec-11-enal (IUPAC name) (436)+TX, (Z)-hexadec-11-en-1-yl acetate (IUPAC name) (437)+TX, (Z)-hexadec-13-en-11-yn-1-yl acetate (IUPAC name) (438)+TX, (Z)-icos-13-en-10-one (IUPAC name) (448)+TX, (Z)-tetradec-7-en-1-al (IUPAC name) (782)+TX, (Z)-tetradec-9-en-1-ol (IUPAC name) (783)+TX, (Z)-tetradec-9-en-1-yl acetate (IUPAC name) (784)+TX, (7E,9Z)-dodeca-7,9-dien-1-yl acetate (IUPAC name) (283)+TX, (9Z,11E)-tetradeca-9,11-dien-1-yl acetate (IUPAC name) (780)+TX, (9Z,12E)-tetradeca-9,12-dien-1-yl acetate (IUPAC name) (781)+TX, 14-methyloctadec-1-ene (IUPAC name) (545)+TX, 4-methylnonan-5-ol with 4-methylnonan-5-one (IUPAC name) (544)+TX, alpha-multistriatin (alternative name) [CCN]+TX, brevicomin (alternative name) [CCN]+TX, codlelure (alternative name) [CCN]+TX, codlemone (alternative name) (167)+TX, cuelure (alternative name) (179)+TX, disparlure (277)+TX, dodec-8-en-1-yl acetate (IUPAC name) (286)+TX, dodec-9-en-1-yl acetate (IUPAC name) (287)+TX, dodeca-8+TX, 10-dien-1-yl acetate (IUPAC name) (284)+TX, dominicalure (alternative name) [CCN]+TX, ethyl 4-methyloctanoate (IUPAC name) (317)+TX, eugenol (alternative name) [CCN]+TX, frontalin (alternative name) [CCN]+TX, gossyplure (alternative name) (420)+TX, grandlure (421)+TX, grandlure I (alternative name) (421)+TX, grandlure II (alternative name) (421)+TX, grandlure III (alternative name) (421)+TX, grandlure IV (alternative name) (421)+TX, hexalure [CCN]+TX, ipsdienol (alternative name) [CCN]+TX, ipsenol (alternative name) [CCN]+TX, japonilure (alternative name) (481)+TX, lineatin (alternative name) [CCN]+TX, litlure (alternative name) [CCN]+TX, looplure (alternative name) [CCN]+TX, medlure [CCN]+TX, megatomoic acid (alternative name) [CCN]+TX, methyl eugenol (alternative name) (540)+TX, muscalure (563)+TX, octadeca-2,13-dien-1-yl acetate (IUPAC name) (588)+TX, octadeca-3,13-dien-1-yl acetate (IUPAC name) (589)+TX, orfralure (alternative name) [CCN]+TX, oryctalure (alternative name) (317)+TX, ostramone (alternative name) [CCN]+TX, siglure [CCN]+TX, sordidin (alternative name) (736)+TX, sulcatol (alternative name) [CCN]+TX, tetradec-11-en-1-yl acetate (IUPAC name) (785)+TX, trimedlure (839)+TX, trimedlure A (alternative name) (839)+TX, trimedlure B₁ (alternative name) (839)+TX, trimedlure B₂ (alternative name) (839)+TX, trimedlure C (alternative name) (839) and trunc-call (alternative name) [CCN]+TX,
an insect repellent selected from the group of substances consisting of 2-(octylthio)ethanol (IUPAC name) (591)+TX, butopyronoxyl (933)+TX, butoxy(polypropylene glycol) (936)+TX, dibutyl adipate (IUPAC name) (1046)+TX, dibutyl phthalate (1047)+TX, dibutyl succinate (IUPAC name) (1048)+TX, diethyltoluamide [CCN]+TX, dimethyl carbate [CCN]+TX, dimethyl phthalate [CCN]+TX, ethyl hexanediol (1137)+TX, hexamide [CCN]+TX, methoquin-butyl (1276)+TX, methylneodecanamide [CCN]+TX, oxamate [CCN] and picaridin [CCN]+TX, an insecticide selected from the group of substances consisting of 1-dichloro-1-nitroethane (IUPAC/Chemical Abstracts name) (1058)+TX, 1,1-dichloro-2,2-bis(4-ethylphenyl)ethane (IUPAC name) (1056), +TX, 1,2-dichloropropane (IUPAC/Chemical Abstracts name) (1062)+TX, 1,2-dichloropropane with 1,3-dichloropropene (IUPAC name) (1063)+TX, 1-bromo-2-chloroethane (IUPAC/Chemical Abstracts name) (916)+TX, 2,2,2-trichloro-1-(3,4-dichlorophenyl)ethyl acetate (IUPAC name) (1451)+TX, 2,2-dichlorovinyl 2-ethylsulfinylethyl methyl phosphate (IUPAC name) (1066)+TX, 2-(1,3-dithiolan-2-yl)phenyl dimethylcarbamate (IUPAC/Chemical Abstracts name) (1109)+TX, 2-(2-butoxyethoxy)ethyl thiocyanate (IUPAC/Chemical Abstracts name) (935)+TX, 2-(4,5-dimethyl-1,3-dioxolan-2-yl)phenyl methylcarbamate (IUPAC/Chemical Abstracts name) (1084)+TX, 2-(4-chloro-3,5-xylyloxy)ethanol (IUPAC name) (986)+TX, 2-chlorovinyl diethyl phosphate (IUPAC name) (984)+TX, 2-imidazolidone (IUPAC name) (1225)+TX, 2-isovalerylindan-1,3-dione (IUPAC name) (1246)+TX, 2-methyl(prop-2-ynyl)aminophenyl methylcarbamate (IUPAC name) (1284)+TX, 2-thiocyanatoethyl laurate (IUPAC name) (1433)+TX, 3-bromo-1-chloroprop-1-ene (IUPAC name) (917)+TX, 3-methyl-1-phenylpyrazol-5-yl dimethylcarbamate (IUPAC name) (1283)+TX, 4-methyl(prop-2-ynyl)amino-3,5-xylyl methylcarbamate (IUPAC name) (1285)+TX, 5,5-dimethyl-3-oxocyclohex-1-enyl dimethylcarbamate (IUPAC name) (1085)+TX, abamectin (1)+TX, acephate (2)+TX, acetamiprid (4)+TX, acethion (alternative name) [CCN]+TX, acetoprole [CCN]+TX, acrinathrin (9)+TX, acrylonitrile (IUPAC name) (861)+TX, alanycarb (15)+TX, aldicarb (16)+TX, aldoxycarb (863)+TX, aldrin (864)+TX, allethrin (17)+TX, allosamidin (alternative name) [CCN]+TX, allyxycarb (866)+TX, alpha-cypermethrin (202)+TX, alpha-ecdysone (alternative name) [CCN]+TX, aluminium phosphide (640)+TX, amidithion (870)+TX, amidothioate (872)+TX, aminocarb (873)+TX, amiton (875)+TX, amiton hydrogen oxalate (875)+TX, amitraz (24)+TX, anabasine (877)+TX, athidathion (883)+TX, AVI 382 (compound code)+TX, AZ 60541 (compound code)+TX, azadirachtin (alternative name) (41)+TX, azamethiphos (42)+TX, azinphos-ethyl (44)+TX, azinphos-methyl (45)+TX, azothoate (889)+TX, Bacillus thuringiensis delta endotoxins (alternative name) (52)+TX, barium hexafluorosilicate (alternative name) [CCN]+TX, barium polysulfide (IUPAC/Chemical Abstracts name) (892)+TX, barthrin [CCN]+TX, Bayer 22/190 (development code) (893)+TX, Bayer 22408 (development code) (894)+TX, bendiocarb (58)+TX, benfuracarb (60)+TX, bensultap (66)+TX, beta-cyfluthrin (194)+TX, beta-cypermethrin (203)+TX, bifenthrin (76)+TX, bioallethrin (78)+TX, bioallethrin S-cyclopentenyl isomer (alternative name) (79)+TX, bioethanomethrin [CCN]+TX, biopermethrin (908)+TX, bioresmethrin (80)+TX, bis(2-chloroethyl) ether (IUPAC name) (909)+TX, bistrifluron (83)+TX, borax (86)+TX, brofenvalerate (alternative name)+TX, bromfenvinfos (914)+TX, bromocyclen (918)+TX, bromo-DDT (alternative name) [CCN]+TX, bromophos (920)+TX, bromophos-ethyl (921)+TX, bufencarb (924)+TX, buprofezin (99)+TX, butacarb (926)+TX, butathiofos (927)+TX, butocarboxim (103)+TX, butonate (932)+TX, butoxycarboxim (104)+TX, butylpyridaben (alternative name)+TX, cadusafos (109)+TX, calcium arsenate [CCN]+TX, calcium cyanide (444)+TX, calcium polysulfide (IUPAC name) (111)+TX, camphechlor (941)+TX, carbanolate (943)+TX, carbaryl (115)+TX, carbofuran (118)+TX, carbon disulfide (IUPAC/Chemical Abstracts name) (945)+TX, carbon tetrachloride (IUPAC name) (946)+TX, carbophenothion (947)+TX, carbosulfan (119)+TX, cartap (123)+TX, cartap hydrochloride (123)+TX, cevadine (alternative name) (725)+TX, chlorbicyclen (960)+TX, chlordane (128)+TX, chlordecone (963)+TX, chlordimeform (964)+TX, chlordimeform hydrochloride (964)+TX, chlorethoxyfos (129)+TX, chlorfenapyr (130)+TX, chlorfenvinphos (131)+TX, chlorfluazuron (132)+TX, chlormephos (136)+TX, chloroform [CCN]+TX, chloropicrin (141)+TX, chlorphoxim (989)+TX, chlorprazophos (990)+TX, chlorpyrifos (145)+TX, chlorpyrifos-methyl (146)+TX, chlorthiophos (994)+TX, chromafenozide (150)+TX, cinerin I (696)+TX, cinerin II (696)+TX, cinerins (696)+TX, cis-resmethrin (alternative name)+TX, cismethrin (80)+TX, clocythrin (alternative name)+TX, cloethocarb (999)+TX, closantel (alternative name) [CCN]+TX, clothianidin (165)+TX, copper acetoarsenite [CCN]+TX, copper arsenate [CCN]+TX, copper oleate [CCN]+TX, coumaphos (174)+TX, coumithoate (1006)+TX, crotamiton (alternative name) [CCN]+TX, crotoxyphos (1010)+TX, crufomate (1011)+TX, cryolite (alternative name) (177)+TX, CS 708 (development code) (1012)+TX, cyanofenphos (1019)+TX, cyanophos (184)+TX, cyanthoate (1020)+TX, cyclethrin [CCN]+TX, cycloprothrin (188)+TX, cyfluthrin (193)+TX, cyhalothrin (196)+TX, cypermethrin (201)+TX, cyphenothrin (206)+TX, cyromazine (209)+TX, cythioate (alternative name) [CCN]+TX, d-limonene (alternative name) [CCN]+TX, d-tetramethrin (alternative name) (788)+TX, DAEP (1031)+TX, dazomet (216)+TX, DDT (219)+TX, decarbofuran (1034)+TX, deltamethrin (223)+TX, demephion (1037)+TX, demephion-O (1037)+TX, demephion-S (1037)+TX, demeton (1038)+TX, demeton-methyl (224)+TX, demeton-O (1038)+TX, demeton-O-methyl (224)+TX, demeton-S (1038)+TX, demeton-S-methyl (224)+TX, demeton-S-methylsulphon (1039)+TX, diafenthiuron (226)+TX, dialifos (1042)+TX, diamidafos (1044)+TX, diazinon (227)+TX, dicapthon (1050)+TX, dichlofenthion (1051)+TX, dichlorvos (236)+TX, dicliphos (alternative name)+TX, dicresyl (alternative name) [CCN]+TX, dicrotophos (243)+TX, dicyclanil (244)+TX, dieldrin (1070)+TX, diethyl 5-methylpyrazol-3-yl phosphate (IUPAC name) (1076)+TX, diflubenzuron (250)+TX, dilor (alternative name) [CCN]+TX, dimefluthrin [CCN]+TX, dimefox (1081)+TX, dimetan (1085)+TX, dimethoate (262)+TX, dimethrin (1083)+TX, dimethylvinphos (265)+TX, dimetilan (1086)+TX, dinex (1089)+TX, dinex-diclexine (1089)+TX, dinoprop (1093)+TX, dinosam (1094)+TX, dinoseb (1095)+TX, dinotefuran (271)+TX, diofenolan (1099)+TX, dioxabenzofos (1100)+TX, dioxacarb (1101)+TX, dioxathion (1102)+TX, disulfoton (278)+TX, dithicrofos (1108)+TX, DNOC (282)+TX, doramectin (alternative name) [CCN]+TX, DSP (1115)+TX, ecdysterone (alternative name) [CCN]+TX, EI 1642 (development code) (1118)+TX, emamectin (291)+TX, emamectin benzoate (291)+TX, EMPC (1120)+TX, empenthrin (292)+TX, endosulfan (294)+TX, endothion (1121)+TX, endrin (1122)+TX, EPBP (1123)+TX, EPN (297)+TX, epofenonane (1124)+TX, eprinomectin (alternative name) [CCN]+TX, esfenvalerate (302)+TX, etaphos (alternative name) [CCN]+TX, ethiofencarb (308)+TX, ethion (309)+TX, ethiprole (310)+TX, ethoate-methyl (1134)+TX, ethoprophos (312)+TX, ethyl formate (IUPAC name) [CCN]+TX, ethyl-DDD (alternative name) (1056)+TX, ethylene dibromide (316)+TX, ethylene dichloride (chemical name) (1136)+TX, ethylene oxide [CCN]+TX, etofenprox (319)+TX, etrimfos (1142)+TX, EXD (1143)+TX, famphur (323)+TX, fenamiphos (326)+TX, fenazaflor (1147)+TX, fenchlorphos (1148)+TX, fenethacarb (1149)+TX, fenfluthrin (1150)+TX, fenitrothion (335)+TX, fenobucarb (336)+TX, fenoxacrim (1153)+TX, fenoxycarb (340)+TX, fenpirithrin (1155)+TX, fenpropathrin (342)+TX, fenpyrad (alternative name)+TX, fensulfothion (1158)+TX, fenthion (346)+TX, fenthion-ethyl [CCN]+TX, fenvalerate (349)+TX, fipronil (354)+TX, flonicamid (358)+TX, flubendiamide (CAS. Reg. No.: 272451-65-7)+TX, flucofuron (1168)+TX, flucycloxuron (366)+TX, flucythrinate (367)+TX, fluenetil (1169)+TX, flufenerim [CCN]+TX, flufenoxuron (370)+TX, flufenprox (1171)+TX, flumethrin (372)+TX, fluvalinate (1184)+TX, FMC 1137 (development code) (1185)+TX, fonofos (1191)+TX, formetanate (405)+TX, formetanate hydrochloride (405)+TX, formothion (1192)+TX, formparanate (1193)+TX, fosmethilan (1194)+TX, fospirate (1195)+TX, fosthiazate (408)+TX, fosthietan (1196)+TX, furathiocarb (412)+TX, furethrin (1200)+TX, gamma-cyhalothrin (197)+TX, gamma-HCH (430)+TX, guazatine (422)+TX, guazatine acetates (422)+TX, GY-81 (development code) (423)+TX, halfenprox (424)+TX, halofenozide (425)+TX, HCH (430)+TX, HEOD (1070)+TX, heptachlor (1211)+TX, heptenophos (432)+TX, heterophos [CCN]+TX, hexaflumuron (439)+TX, HHDN (864)+TX, hydramethylnon (443)+TX, hydrogen cyanide (444)+TX, hydroprene (445)+TX, hyquincarb (1223)+TX, imidacloprid (458)+TX, imiprothrin (460)+TX, indoxacarb (465)+TX, iodomethane (IUPAC name) (542)+TX, IPSP (1229)+TX, isazofos (1231)+TX, isobenzan (1232)+TX, isocarbophos (alternative name) (473)+TX, isodrin (1235)+TX, isofenphos (1236)+TX, isolane (1237)+TX, isoprocarb (472)+TX, isopropyl 0-(methoxy-aminothiophosphoryl)salicylate (IUPAC name) (473)+TX, isoprothiolane (474)+TX, isothioate (1244)+TX, isoxathion (480)+TX, ivermectin (alternative name) [CCN]+TX, jasmolin I (696)+TX, jasmolin II (696)+TX, jodfenphos (1248)+TX, juvenile hormone I (alternative name) [CCN]+TX, juvenile hormone II (alternative name) [CCN]+TX, juvenile hormone III (alternative name) [CCN]+TX, kelevan (1249)+TX, kinoprene (484)+TX, lambda-cyhalothrin (198)+TX, lead arsenate [CCN]+TX, lepimectin (CCN)+TX, leptophos (1250)+TX, lindane (430)+TX, lirimfos (1251)+TX, lufenuron (490)+TX, lythidathion (1253)+TX, m-cumenyl methylcarbamate (IUPAC name) (1014)+TX, magnesium phosphide (IUPAC name) (640)+TX, malathion (492)+TX, malonoben (1254)+TX, mazidox (1255)+TX, mecarbam (502)+TX, mecarphon (1258)+TX, menazon (1260)+TX, mephosfolan (1261)+TX, mercurous chloride (513)+TX, mesulfenfos (1263)+TX, metaflumizone (CCN)+TX, metam (519)+TX, metam-potassium (alternative name) (519)+TX, metam-sodium (519)+TX, methacrifos (1266)+TX, methamidophos (527)+TX, methanesulfonyl fluoride (IUPAC/Chemical Abstracts name) (1268)+TX, methidathion (529)+TX, methiocarb (530)+TX, methocrotophos (1273)+TX, methomyl (531)+TX, methoprene (532)+TX, methoquin-butyl (1276)+TX, methothrin (alternative name) (533)+TX, methoxychlor (534)+TX, methoxyfenozide (535)+TX, methyl bromide (537)+TX, methyl isothiocyanate (543)+TX, methylchloroform (alternative name) [CCN]+TX, methylene chloride [CCN]+TX, metofluthrin [CCN]+TX, metolcarb (550)+TX, metoxadiazone (1288)+TX, mevinphos (556)+TX, mexacarbate (1290)+TX, milbemectin (557)+TX, milbemycin oxime (alternative name) [CCN]+TX, mipafox (1293)+TX, mirex (1294)+TX, monocrotophos (561)+TX, morphothion (1300)+TX, moxidectin (alternative name) [CCN]+TX, naftalofos (alternative name) [CCN]+TX, naled (567)+TX, naphthalene (IUPAC/Chemical Abstracts name) (1303)+TX, NC-170 (development code) (1306)+TX, NC-184 (compound code)+TX, nicotine (578)+TX, nicotine sulfate (578)+TX, nifluridide (1309)+TX, nitenpyram (579)+TX, nithiazine (1311)+TX, nitrilacarb (1313)+TX, nitrilacarb 1:1 zinc chloride complex (1313)+TX, NNI-0101 (compound code)+TX, NNI-0250 (compound code)+TX, nornicotine (traditional name) (1319)+TX, novaluron (585)+TX, noviflumuron (586)+TX, 0-5-dichloro-4-iodophenyl O-ethyl ethylphosphonothioate (IUPAC name) (1057)+TX, 0,0-diethyl 0-4-methyl-2-oxo-2H-chromen-7-yl phosphorothioate (IUPAC name) (1074)+TX, 0,0-diethyl 0-6-methyl-2-propylpyrimidin-4-yl phosphorothioate (IUPAC name) (1075)+TX, 0,0,0′,0′-tetrapropyl dithiopyrophosphate (IUPAC name) (1424)+TX, oleic acid (IUPAC name) (593)+TX, omethoate (594)+TX, oxamyl (602)+TX, oxydemeton-methyl (609)+TX, oxydeprofos (1324)+TX, oxydisulfoton (1325)+TX, pp′-DDT (219)+TX, para-dichlorobenzene [CCN]+TX, parathion (615)+TX, parathion-methyl (616)+TX, penfluron (alternative name) [CCN]+TX, pentachlorophenol (623)+TX, pentachlorophenyl laurate (IUPAC name) (623)+TX, permethrin (626)+TX, petroleum oils (alternative name) (628)+TX, PH 60-38 (development code) (1328)+TX, phenkapton (1330)+TX, phenothrin (630)+TX, phenthoate (631)+TX, phorate (636)+TX, phosalone (637)+TX, phosfolan (1338)+TX, phosmet (638)+TX, phosnichlor (1339)+TX, phosphamidon (639)+TX, phosphine (IUPAC name) (640)+TX, phoxim (642)+TX, phoxim-methyl (1340)+TX, pirimetaphos (1344)+TX, pirimicarb (651)+TX, pirimiphos-ethyl (1345)+TX, pirimiphos-methyl (652)+TX, polychlorodicyclopentadiene isomers (IUPAC name) (1346)+TX, polychloroterpenes (traditional name) (1347)+TX, potassium arsenite [CCN]+TX, potassium thiocyanate [CCN]+TX, prallethrin (655)+TX, precocene I (alternative name) [CCN]+TX, precocene II (alternative name) [CCN]+TX, precocene III (alternative name) [CCN]+TX, primidophos (1349)+TX, profenofos (662)+TX, profluthrin [CCN]+TX, promacyl (1354)+TX, promecarb (1355)+TX, propaphos (1356)+TX, propetamphos (673)+TX, propoxur (678)+TX, prothidathion (1360)+TX, prothiofos (686)+TX, prothoate (1362)+TX, protrifenbute [CCN]+TX, pymetrozine (688)+TX, pyraclofos (689)+TX, pyrazophos (693)+TX, pyresmethrin (1367)+TX, pyrethrin 1 (696)+TX, pyrethrin 11 (696)+TX, pyrethrins (696)+TX, pyridaben (699)+TX, pyridalyl (700)+TX, pyridaphenthion (701)+TX, pyrimidifen (706)+TX, pyrimitate (1370)+TX, pyriproxyfen (708)+TX, quassia (alternative name) [CCN]+TX, quinalphos (711)+TX, quinalphos-methyl (1376)+TX, quinothion (1380)+TX, quintiofos (1381)+TX, R-1492 (development code) (1382)+TX, rafoxanide (alternative name) [CCN]+TX, resmethrin (719)+TX, rotenone (722)+TX, RU 15525 (development code) (723)+TX, RU 25475 (development code) (1386)+TX, ryania (alternative name) (1387)+TX, ryanodine (traditional name) (1387)+TX, sabadilla (alternative name) (725)+TX, schradan (1389)+TX, sebufos (alternative name)+TX, selamectin (alternative name) [CCN]+TX, SI-0009 (compound code)+TX, SI-0205 (compound code)+TX, SI-0404 (compound code)+TX, SI-0405 (compound code)+TX, silafluofen (728)+TX, SN 72129 (development code) (1397)+TX, sodium arsenite [CCN]+TX, sodium cyanide (444)+TX, sodium fluoride (IUPAC/Chemical Abstracts name) (1399)+TX, sodium hexafluorosilicate (1400)+TX, sodium pentachlorophenoxide (623)+TX, sodium selenate (IUPAC name) (1401)+TX, sodium thiocyanate [CCN]+TX, sophamide (1402)+TX, spinosad (737)+TX, spiromesifen (739)+TX, spirotetrmat (CCN)+TX, sulcofuron (746)+TX, sulcofuron-sodium (746)+TX, sulfluramid (750)+TX, sulfotep (753)+TX, sulfuryl fluoride (756)+TX, sulprofos (1408)+TX, tar oils (alternative name) (758)+TX, tau-fluvalinate (398)+TX, tazimcarb (1412)+TX, TDE (1414)+TX, tebufenozide (762)+TX, tebufenpyrad (763)+TX, tebupirimfos (764)+TX, teflubenzuron (768)+TX, tefluthrin (769)+TX, temephos (770)+TX, TEPP (1417)+TX, terallethrin (1418)+TX, terbam (alternative name)+TX, terbufos (773)+TX, tetrachloroethane [CCN]+TX, tetrachlorvinphos (777)+TX, tetramethrin (787)+TX, theta-cypermethrin (204)+TX, thiacloprid (791)+TX, thiafenox (alternative name)+TX, thiamethoxam (792)+TX, thicrofos (1428)+TX, thiocarboxime (1431)+TX, thiocyclam (798)+TX, thiocyclam hydrogen oxalate (798)+TX, thiodicarb (799)+TX, thiofanox (800)+TX, thiometon (801)+TX, thionazin (1434)+TX, thiosultap (803)+TX, thiosultap-sodium (803)+TX, thuringiensin (alternative name) [CCN]+TX, tolfenpyrad (809)+TX, tralomethrin (812)+TX, transfluthrin (813)+TX, transpermethrin (1440)+TX, triamiphos (1441)+TX, triazamate (818)+TX, triazophos (820)+TX, triazuron (alternative name)+TX, trichlorfon (824)+TX, trichlormetaphos-3 (alternative name) [CCN]+TX, trichloronat (1452)+TX, trifenofos (1455)+TX, triflumuron (835)+TX, trimethacarb (840)+TX, triprene (1459)+TX, vamidothion (847)+TX, vaniliprole [CCN]+TX, veratridine (alternative name) (725)+TX, veratrine (alternative name) (725)+TX, XMC (853)+TX, xylylcarb (854)+TX, YI-5302 (compound code)+TX, zeta-cypermethrin (205)+TX, zetamethrin (alternative name)+TX, zinc phosphide (640)+TX, zolaprofos (1469) and ZXI 8901 (development code) (858)+TX, cyantraniliprole [736994-63-19+TX, chlorantraniliprole [500008-45-7]+TX, cyenopyrafen [560121-52-0]+TX, cyflumetofen [400882-07-7]+TX, pyrifluquinazon [337458-27-2]+TX, spinetoram [187166-40-1+187166-15-0]+TX, spirotetramat [203313-25-1]+TX, sulfoxaflor [946578-00-3]+TX, flufiprole [704886-18-0]+TX, meperfluthrin [915288-13-0]+TX, tetramethylfluthrin [84937-88-2]+TX, triflumezopyrim (disclosed in WO 2012/092115)+TX, a molluscicide selected from the group of substances consisting of bis(tributyltin) oxide (IUPAC name) (913)+TX, bromoacetamide [CCN]+TX, calcium arsenate [CCN]+TX, cloethocarb (999)+TX, copper acetoarsenite [CCN]+TX, copper sulfate (172)+TX, fentin (347)+TX, ferric phosphate (IUPAC name) (352)+TX, metaldehyde (518)+TX, methiocarb (530)+TX, niclosamide (576)+TX, niclosamide-olamine (576)+TX, pentachlorophenol (623)+TX, sodium pentachlorophenoxide (623)+TX, tazimcarb (1412)+TX, thiodicarb (799)+TX, tributyltin oxide (913)+TX, trifenmorph (1454)+TX, trimethacarb (840)+TX, triphenyltin acetate (IUPAC name) (347) and triphenyltin hydroxide (IUPAC name) (347)+TX, pyriprole [394730-71-3]+TX,
a nematicide selected from the group of substances consisting of AKD-3088 (compound code)+TX, 1,2-dibromo-3-chloropropane (IUPAC/Chemical Abstracts name) (1045)+TX, 1,2-dichloropropane (IUPAC/Chemical Abstracts name) (1062)+TX, 1,2-dichloropropane with 1,3-dichloropropene (IUPAC name) (1063)+TX, 1,3-dichloropropene (233)+TX, 3,4-dichlorotetrahydrothiophene 1,1-dioxide (IUPAC/Chemical Abstracts name) (1065)+TX, 3-(4-chlorophenyl)-5-methylrhodanine (IUPAC name) (980)+TX, 5-methyl-6-thioxo-1,3,5-thiadiazinan-3-ylacetic acid (IUPAC name) (1286)+TX, 6-isopentenylaminopurine (alternative name) (210)+TX, abamectin (1)+TX, acetoprole [CCN]+TX, alanycarb (15)+TX, aldicarb (16)+TX, aldoxycarb (863)+TX, AZ 60541 (compound code)+TX, benclothiaz [CCN]+TX, benomyl (62)+TX, butylpyridaben (alternative name)+TX, cadusafos (109)+TX, carbofuran (118)+TX, carbon disulfide (945)+TX, carbosulfan (119)+TX, chloropicrin (141)+TX, chlorpyrifos (145)+TX, cloethocarb (999)+TX, cytokinins (alternative name) (210)+TX, dazomet (216)+TX, DBCP (1045)+TX, DCIP (218)+TX, diamidafos (1044)+TX, dichlofenthion (1051)+TX, dicliphos (alternative name)+TX, dimethoate (262)+TX, doramectin (alternative name) [CCN]+TX, emamectin (291)+TX, emamectin benzoate (291)+TX, eprinomectin (alternative name) [CCN]+TX, ethoprophos (312)+TX, ethylene dibromide (316)+TX, fenamiphos (326)+TX, fenpyrad (alternative name)+TX, fensulfothion (1158)+TX, fosthiazate (408)+TX, fosthietan (1196)+TX, furfural (alternative name) [CCN]+TX, GY-81 (development code) (423)+TX, heterophos [CCN]+TX, iodomethane (IUPAC name) (542)+TX, isamidofos (1230)+TX, isazofos (1231)+TX, ivermectin (alternative name) [CCN]+TX, kinetin (alternative name) (210)+TX, mecarphon (1258)+TX, metam (519)+TX, metam-potassium (alternative name) (519)+TX, metam-sodium (519)+TX, methyl bromide (537)+TX, methyl isothiocyanate (543)+TX, milbemycin oxime (alternative name) [CCN]+TX, moxidectin (alternative name) [CCN]+TX, Myrothecium verrucaria composition (alternative name) (565)+TX, NC-184 (compound code)+TX, oxamyl (602)+TX, phorate (636)+TX, phosphamidon (639)+TX, phosphocarb [CCN]+TX, sebufos (alternative name)+TX, selamectin (alternative name) [CCN]+TX, spinosad (737)+TX, terbam (alternative name)+TX, terbufos (773)+TX, tetrachlorothiophene (IUPAC/Chemical Abstracts name) (1422)+TX, thiafenox (alternative name)+TX, thionazin (1434)+TX, triazophos (820)+TX, triazuron (alternative name)+TX, xylenols [CCN]+TX, YI-5302 (compound code) and zeatin (alternative name) (210)+TX, fluensulfone [318290-98-1]+TX, a nitrification inhibitor selected from the group of substances consisting of potassium ethylxanthate [CCN] and nitrapyrin (580)+TX,
a plant activator selected from the group of substances consisting of acibenzolar (6)+TX, acibenzolar-S-methyl (6)+TX, probenazole (658) and Reynoutria sachalinensis extract (alternative name) (720)+TX,
a rodenticide selected from the group of substances consisting of 2-isovalerylindan-1,3-dione (IUPAC name) (1246)+TX, 4-(quinoxalin-2-ylamino)benzenesulfonamide (IUPAC name) (748)+TX, alpha-chlorohydrin [CCN]+TX, aluminium phosphide (640)+TX, antu (880)+TX, arsenous oxide (882)+TX, barium carbonate (891)+TX, bisthiosemi (912)+TX, brodifacoum (89)+TX, bromadiolone (91)+TX, bromethalin (92)+TX, calcium cyanide (444)+TX, chloralose (127)+TX, chlorophacinone (140)+TX, cholecalciferol (alternative name) (850)+TX, coumachlor (1004)+TX, coumafuryl (1005)+TX, coumatetralyl (175)+TX, crimidine (1009)+TX, difenacoum (246)+TX, difethialone (249)+TX, diphacinone (273)+TX, ergocalciferol (301)+TX, flocoumafen (357)+TX, fluoroacetamide (379)+TX, flupropadine (1183)+TX, flupropadine hydrochloride (1183)+TX, gamma-HCH (430)+TX, HCH (430)+TX, hydrogen cyanide (444)+TX, iodomethane (IUPAC name) (542)+TX, lindane (430)+TX, magnesium phosphide (IUPAC name) (640)+TX, methyl bromide (537)+TX, norbormide (1318)+TX, phosacetim (1336)+TX, phosphine (IUPAC name) (640)+TX, phosphorus [CCN]+TX, pindone (1341)+TX, potassium arsenite [CCN]+TX, pyrinuron (1371)+TX, scilliroside (1390)+TX, sodium arsenite [CCN]+TX, sodium cyanide (444)+TX, sodium fluoroacetate (735)+TX, strychnine (745)+TX, thallium sulfate [CCN]+TX, warfarin (851) and zinc phosphide (640)+TX,
a synergist selected from the group of substances consisting of 2-(2-butoxyethoxy)ethyl piperonylate (IUPAC name) (934)+TX, 5-(1,3-benzodioxol-5-yl)-3-hexylcyclohex-2-enone (IUPAC name) (903)+TX, farnesol with nerolidol (alternative name) (324)+TX, MB-599 (development code) (498)+TX, MGK 264 (development code) (296)+TX, piperonyl butoxide (649)+TX, piprotal (1343)+TX, propyl isomer (1358)+TX, S421 (development code) (724)+TX, sesamex (1393)+TX, sesasmolin (1394) and sulfoxide (1406)+TX,
an animal repellent selected from the group of substances consisting of anthraquinone (32)+TX, chloralose (127)+TX, copper naphthenate [CCN]+TX, copper oxychloride (171)+TX, diazinon (227)+TX, dicyclopentadiene (chemical name) (1069)+TX, guazatine (422)+TX, guazatine acetates (422)+TX, methiocarb (530)+TX, pyridin-4-amine (IUPAC name) (23)+TX, thiram (804)+TX, trimethacarb (840)+TX, zinc naphthenate [CCN] and ziram (856)+TX,
a virucide selected from the group of substances consisting of imanin (alternative name) [CCN] and ribavirin (alternative name) [CCN]+TX,
a wound protectant selected from the group of substances consisting of mercuric oxide (512)+TX, octhilinone (590) and thiophanate-methyl (802)+TX,
and biologically active compounds selected from the group consisting of azaconazole (60207-31-0]+TX, bitertanol [70585-36-3]+TX, bromuconazole [116255-48-2]+TX, cyproconazole [94361-06-5]+TX, difenoconazole [119446-68-3]+TX, diniconazole [83657-24-3]+TX, epoxiconazole [106325-08-0]+TX, fenbuconazole [114369-43-6]+TX, fluquinconazole [136426-54-5]+TX, flusilazole [85509-19-9]+TX, flutriafol [76674-21-0]+TX, hexaconazole [79983-71-4]+TX, imazalil [35554-44-0]+TX, imibenconazole [86598-92-7]+TX, ipconazole [125225-28-7]+TX, metconazole [125116-23-6]+TX, myclobutanil [88671-89-0]+TX, pefurazoate [101903-30-4]+TX, penconazole [66246-88-6]+TX, prothioconazole [178928-70-6]+TX, pyrifenox [88283-41-4]+TX, prochloraz [67747-09-5]+TX, propiconazole [60207-90-1]+TX, simeconazole [149508-90-7]+TX, tebucon-azole [107534-96-3]+TX, tetraconazole [112281-77-3]+TX, triadimefon [43121-43-3]+TX, triadimenol [55219-65-3]+TX, triflumizole [99387-89-0]+TX, triticonazole [131983-72-7]+TX, ancymidol [12771-68-5]+TX, fenarimol [60168-88-9]+TX, nuarimol [63284-71-9]+TX, bupirimate [41483-43-6]+TX, dimethirimol [5221-53-4]+TX, ethirimol [23947-60-6]+TX, dodemorph [1593-77-7]+TX, fenpropidine [67306-00-7]+TX, fenpropimorph [67564-91-4]+TX, spiroxamine [118134-30-8]+TX, tridemorph [81412-43-3]+TX, cyprodinil [121552-61-2]+TX, mepanipyrim [110235-47-7]+TX, pyrimethanil [53112-28-0]+TX, fenpiclonil [74738-17-3]+TX, fludioxonil [131341-86-1]+TX, benalaxyl [71626-11-4]+TX, furalaxyl [57646-30-7]+TX, metalaxyl [57837-19-1]+TX, R-metalaxyl [70630-17-0]+TX, ofurace [58810-48-3]+TX, oxadixyl [77732-09-3]+TX, benomyl [17804-35-2]+TX, carbendazim [10605-21-7]+TX, debacarb [62732-91-6]+TX, fuberidazole [3878-19-1]+TX, thiabendazole [148-79-8]+TX, chlozolinate [84332-86-5]+TX, dichlozoline [24201-58-9]+TX, iprodione [36734-19-7]+TX, myclozoline [54864-61-8]+TX, procymidone [32809-16-8]+TX, vinclozoline [50471-44-8]+TX, boscalid [188425-85-6]+TX, carboxin [5234-68-4]+TX, fenfuram [24691-80-3]+TX, flutolanil [66332-96-5]+TX, mepronil [55814-41-0]+TX, oxycarboxin [5259-88-1]+TX, penthiopyrad [183675-82-3]+TX, thifluzamide [130000-40-7]+TX, guazatine [108173-90-6]+TX, dodine [2439-10-3] [112-65-2] (free base)+TX, iminoctadine [13516-27-3]+TX, azoxystrobin [131860-33-8]+TX, dimoxystrobin [149961-52-4]+TX, enestroburin {Proc. BCPC, Int. Congr., Glasgow, 2003, 1, 93}+TX, fluoxastrobin [361377-29-9]+TX, kresoxim-methyl [143390-89-0]+TX, metominostrobin [133408-50-1]+TX, trifloxystrobin [141517-21-7]+TX, orysastrobin [248593-16-0]+TX, picoxystrobin [117428-22-5]+TX, pyraclostrobin [175013-18-0]+TX, ferbam [14484-64-1]+TX, mancozeb [8018-01-7]+TX, maneb [12427-38-2]+TX, metiram [9006-42-2]+TX, propineb [12071-83-9]+TX, thiram [137-26-8]+TX, zineb [12122-67-7]+TX, ziram [137-30-4]+TX, captafol [2425-06-1]+TX, captan [133-06-2]+TX, dichlofluanid [1085-98-9]+TX, fluoroimide [41205-21-4]+TX, folpet [133-07-3]+TX, tolylfluanid [731-27-1]+TX, bordeaux mixture [8011-63-0]+TX, copperhydroxid [20427-59-2]+TX, copperoxychlorid [1332-40-7]+TX, coppersulfat [7758-98-7]+TX, copperoxid [1317-39-1]+TX, mancopper [53988-93-5]+TX, oxine-copper [10380-28-6]+TX, dinocap [131-72-6]+TX, nitrothal-isopropyl [10552-74-6]+TX, edifenphos [17109-49-8]+TX, iprobenphos [26087-47-8]+TX, isoprothiolane [50512-35-1]+TX, phosdiphen [36519-00-3]+TX, pyrazophos [13457-18-6]+TX, tolclofos-methyl [57018-04-9]+TX, acibenzolar-S-methyl [135158-54-2]+TX, anilazine [101-05-3]+TX, benthiavalicarb [413615-35-7]+TX, blasticidin-S [2079-00-7]+TX, chinomethionat [2439-01-2]+TX, chloroneb [2675-77-6]+TX, chlorothalonil [1897-45-6]+TX, cyflufenamid [180409-60-3]+TX, cymoxanil [57966-95-7]+TX, dichlone [117-80-6]+TX, diclocymet [139920-32-4]+TX, diclomezine [62865-36-5]+TX, dicloran [99-30-9]+TX, diethofencarb [87130-20-9]+TX, dimetho-morph [110488-70-5]+TX, SYP-L190 (Flumorph) [211867-47-9]+TX, dithianon [3347-22-6]+TX, ethaboxam [162650-77-3]+TX, etridiazole [2593-15-9]+TX, famoxadone [131807-57-3]+TX, fenamidone [161326-34-7]+TX, fenoxanil [115852-48-7]+TX, fentin [668-34-8]+TX, ferimzone [89269-64-7]+TX, fluazinam [79622-59-6]+TX, fluopicolide [239110-15-7]+TX, flusulfamide [106917-52-6]+TX, fenhexamid [126833-17-8]+TX, fosetyl-aluminium [39148-24-8]+TX, hymexazol [10004-44-1]+TX, iprovalicarb [140923-17-7]+TX, IKF-916 (Cyazofamid) [120116-88-3]+TX, kasugamycin [6980-18-3]+TX, methasulfocarb [66952-49-6]+TX, metrafenone [220899-03-6]+TX, pencycuron [66063-05-6]+TX, phthalide [27355-22-2]+TX, polyoxins [11113-80-7]+TX, probenazole [27605-76-1]+TX, propamocarb [25606-41-1]+TX, proquinazid [189278-12-4]+TX, pyroquilon [57369-32-1]+TX, quinoxyfen [124495-18-7]+TX, quintozene [82-68-8]+TX, sulfur [7704-34-9]+TX, tiadinil [223580-51-6]+TX, triazoxide [72459-58-6]+TX, tricyclazole [41814-78-2]+TX, triforine [26644-46-2]+TX, validamycin [37248-47-8]+TX, zoxamide (RH7281) [156052-68-5]+TX, mandipropamid [374726-62-2]+TX, isopyrazam [881685-58-1]+TX, sedaxane [874967-67-6]+TX, 3-difluoromethyl-1-methyl-1H-pyrazole-4-carboxylic acid (9-dichloromethylene-1,2,3,4-tetrahydro-1,4-methano-naphthalen-5-yl)-amide (dislosed in WO 2007/048556)+TX, 3-difluoromethyl-1-methyl-1H-pyrazole-4-carboxylic acid (3′,4′,5′-trifluoro-biphenyl-2-yl)-amide (disclosed in WO 2006/087343)+TX, [(3S,4R,4aR,6S,6aS,12R,12aS,12bS)-3-[(cyclopropylcarbonyl)oxy]-1,3,4,4a,5,6,6a,12,12a,12b-decahydro-6,12-dihydroxy-4,6a,12b-trimethyl-11-oxo-9-(3-pyridinyl)-2H,11Hnaphtho[2,1-b]pyrano[3,4-e]pyran-4-yl]methyl-cyclopropanecarboxylate [915972-17-7]+TX, 1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide [926914-55-8]+TX, flufiprole [704886-18-0]+TX, cyclaniliprole [1031756-98-5]+TX, tetraniliprole [1229654-66-3]+TX, guadipyr (described in WO2010/060231)+TX and
cycloxaprid (described in WO 2005/077934)+TX.

The references in brackets behind the active ingredients, e.g. [3878-19-1] refer to the Chemical Abstracts Registry number. The above described mixing partners are known. Where the active ingredients are included in “The Pesticide Manual” [The Pesticide Manual—A World Compendium; Thirteenth Edition; Editor: C. D. S. TomLin; The British Crop Protection Council], they are described therein under the entry number given in round brackets hereinabove for the particular compound; for example, the compound “abamectin” is described under entry number (1). Where “[CCN]” is added hereinabove to the particular compound, the compound in question is included in the “Compendium of Pesticide Common Names”, which is accessible on the internet [A. Wood; Compendium of Pesticide Common Names, Copyright 1995-2004]; for example, the compound “acetoprole” is described under the internet address http://www.alanwood.net/pesticides/acetoprole.html.

Most of the active ingredients described above are referred to hereinabove by a so-called “common name”, the relevant “ISO common name” or another “common name” being used in individual cases. If the designation is not a “common name”, the nature of the designation used instead is given in round brackets for the particular compound; in that case, the IUPAC name, the IUPAC/Chemical Abstracts name, a “chemical name”, a “traditional name”, a “compound name” or a “develoment code” is used or, if neither one of those designations nor a “common name” is used, an “alternative name” is employed. “CAS Reg. No” means the Chemical Abstracts Registry Number.

The active ingredient mixture of the compounds of formula I selected from Table T1, T1-A or from the Tables 1 to 7 with active ingredients described above comprises a compound selected from Table T1, T1-A or from the Tables 1 to 7 and an active ingredient as described above preferably in a mixing ratio of from 100:1 to 1:6000, especially from 50:1 to 1:50, more especially in a ratio of from 20:1 to 1:20, even more especially from 10:1 to 1:10, very especially from 5:1 and 1:5, special preference being given to a ratio of from 2:1 to 1:2, and a ratio of from 4:1 to 2:1 being likewise preferred, above all in a ratio of 1:1, or 5:1, or 5:2, or 5:3, or 5:4, or 4:1, or 4:2, or 4:3, or 3:1, or 3:2, or 2:1, or 1:5, or 2:5, or 3:5, or 4:5, or 1:4, or 2:4, or 3:4, or 1:3, or 2:3, or 1:2, or 1:600, or 1:300, or 1:150, or 1:35, or 2:35, or 4:35, or 1:75, or 2:75, or 4:75, or 1:6000, or 1:3000, or 1:1500, or 1:350, or 2:350, or 4:350, or 1:750, or 2:750, or 4:750. Those mixing ratios are by weight.

The mixtures as described above can be used in a method for controlling pests, which comprises applying a composition comprising a mixture as described above to the pests or their environment, with the exception of a method for treatment of the human or animal body by surgery or therapy and diagnostic methods practised on the human or animal body.

The mixtures comprising a compound of formula I selected from Table T1, T1-A or from the Tables 1 to 7 and one or more active ingredients as described above can be applied, for example, in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the compounds of formula I selected from Table T1, T1-A or from the Tables 1 to 7 and the active ingredients as described above is not essential for working the present invention.

The compositions according to the invention can also comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers, fertilizers or other active ingredients for achieving specific effects, for example bactericides, fungicides, nematocides, plant activators, molluscicides or herbicides.

The compositions according to the invention are prepared in a manner known per se, in the absence of auxiliaries for example by grinding, screening and/or compressing a solid active ingredient and in the presence of at least one auxiliary for example by intimately mixing and/or grinding the active ingredient with the auxiliary (auxiliaries). These processes for the preparation of the compositions and the use of the compounds I for the preparation of these compositions are also a subject of the invention.

The application methods for the compositions, that is the methods of controlling pests of the abovementioned type, such as spraying, atomizing, dusting, brushing on, dressing, scattering or pouring—which are to be selected to suit the intended aims of the prevailing circumstances—and the use of the compositions for controlling pests of the abovementioned type are other subjects of the invention. Typical rates of concentration are between 0.1 and 1000 ppm, preferably between 0.1 and 500 ppm, of active ingredient. The rate of application per hectare is generally 1 to 2000 g of active ingredient per hectare, in particular 10 to 1000 g/ha, preferably 10 to 600 g/ha.

A preferred method of application in the field of crop protection is application to the foliage of the plants (foliar application), it being possible to select frequency and rate of application to match the danger of infestation with the pest in question. Alternatively, the active ingredient can reach the plants via the root system (systemic action), by drenching the locus of the plants with a liquid composition or by incorporating the active ingredient in solid form into the locus of the plants, for example into the soil, for example in the form of granules (soil application). In the case of paddy rice crops, such granules can be metered into the flooded paddy-field.

The compounds of the invention and compositions thereof are also be suitable for the protection of plant propagation material, for example seeds, such as fruit, tubers or kernels, or nursery plants, against pests of the abovementioned type. The propagation material can be treated with the compound prior to planting, for example seed can be treated prior to sowing. Alternatively, the compound can be applied to seed kernels (coating), either by soaking the kernels in a liquid composition or by applying a layer of a solid composition. It is also possible to apply the compositions when the propagation material is planted to the site of application, for example into the seed furrow during drilling. These treatment methods for plant propagation material and the plant propagation material thus treated are further subjects of the invention. Typical treatment rates would depend on the plant and pest/fungi to be controlled and are generally between 1 to 200 grams per 100 kg of seeds, preferably between 5 to 150 grams per 100 kg of seeds, such as between 10 to 100 grams per 100 kg of seeds.

The term seed embraces seeds and plant propagules of all kinds including but not limited to true seeds, seed pieces, suckers, corns, bulbs, fruit, tubers, grains, rhizomes, cuttings, cut shoots and the like and means in a preferred embodiment true seeds.

The present invention also comprises seeds coated or treated with or containing a compound of formula I. The term “coated or treated with and/or containing” generally signifies that the active ingredient is for the most part on the surface of the seed at the time of application, although a greater or lesser part of the ingredient may penetrate into the seed material, depending on the method of application. When the said seed product is (re)planted, it may absorb the active ingredient. In an embodiment, the present invention makes available a plant propagation material adhered thereto with a compound of formula (I). Further, it is hereby made available, a composition comprising a plant propagation material treated with a compound of formula (I).

Seed treatment comprises all suitable seed treatment techniques known in the art, such as seed dressing, seed coating, seed dusting, seed soaking and seed pelleting. The seed treatment application of the compound formula (I) can be carried out by any known methods, such as spraying or by dusting the seeds before sowing or during the sowing/planting of the seeds.

The following Examples illustrate, but do not limit, the invention.

The compounds of the invention can be distinguished from known compounds by virtue of greater efficacy at low application rates, which can be verified by the person skilled in the art using the experimental procedures outlined in the Examples, using lower application rates if necessary, for example 50 ppm, 12.5 ppm, 6 ppm, 3 ppm, 1.5 ppm or 0.8 ppm.

### PREPARATION EXAMPLES

### Example P1

### Preparation of 2-bromoterephthalic acid

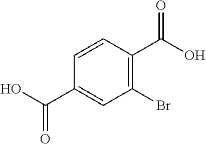 [SMILES: O=C(O)c1ccc(C(=O)O)c(Br)c1]

To a solution of 2-bromo-1,4-dimethyl-benzene (20 g, 108.1 mmol) in water (400 ml) was added potassium permanganate (69 g, 432.3 mmol) in portions at ambient temperature. The reaction mass was heated at 70° C. for 12 h. The dark coloured reaction mass was cooled to room temperature and acidified to pH 2 using 2N HCl. Aqueous solution extracted with ethyl acetate (3×100 ml). Combined organic layers were dried over sodium sulfate and evaporated under reduced pressure. The crude was subject to flash chromatography over silicagel with cyclohexane/ethyl acetate 85:15 to 50:50 as eluent to obtain 2-bromoterephthalic acid (13.5 g, 51% of theoretical yield) as a white solid.

¹H NMR (400 MHz, DMSO-d₆) δ ppm 7.80-7.84 (m, 2H) 7.98 (dd, J=7.91, 1.63 Hz, 2H) 8.14 (d, J=1.51 Hz, 2H) 13.62 (br. s., 2H)

MS [M−H]⁻: 244.9 (rt 0.87-0.92 min)

### Example P2

### Preparation of 2-bromo-5-fluoro-terephthalic acid

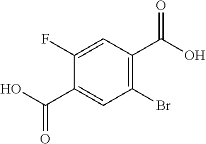 [SMILES: O=C(O)c1cc(Br)c(C(=O)O)cc1F]

To a solution of 1-bromo-4-fluoro-2,5-dimethyl-benzene (5 g, 23.8847 mmol) in water (150 ml) was added potassium permanganate (8.68 g, 54.934 mmol) in portions at ambient temperature. The reaction mass was heated at 70° C. for 16 h. The dark colored reaction mass was cooled to room temperature and filtered. The filtrate was acidified to pH 2 using 2N HCl. The white solid thus obtained was collected by filtration and washed with water (10 ml) and dried under vacuum to obtain 2-bromo-5-fluoro-terephthalic acid (1.8 g, 29% of theoretical yield) as a white solid.

MS [M−H]⁻: 261.1/262.1 (rt 0.65-0.67 min)

### Example P3

### Preparation of dimethyl 2-bromobenzene-1,4-dicarboxylate

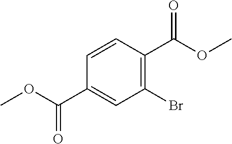

A solution of 2-bromoterephthalic acid (5.000 g, 20.41 mmol) in thionyl chloride (20.00 mL, 273 mmol) was heated at 100° C. for 5 h. The dark colored reaction mass was cooled to room temperature and solvent was evaporated off under reduced pressure. The residual mass was cooled to 0° C. and methanol (20 ml) and triethylamine (5 ml, 35.5 mmol) were added slowly under nitrogen. The reaction mixture was then stirred for 2 h at ambient temperature. The solution was evaporated to dryness under reduced pressure. The residual mass was dissolved in ethylacetate (100 ml) and washed with water (2×25 ml), followed by 2N HCl (2×25 ml) and finally with saturated sodium bicarbonate solution. Combined organic layers were dried over sodium sulfate and evaporated under reduced pressure to obtain dimethyl 2-bromobenzene-1,4-dicarboxylate (5.5 g, 99% of theoretical yield) as a white solid.

¹H NMR (400 MHz, CHLOROFORM-d) δ ppm 3.95 (d, J=1.25 Hz, 3H) 3.96 (d, J=1.25 Hz, 3H) 7.81 (dd, J=8.03, 1.25 Hz, 1H) 8.00 (d, J=8.03 Hz, 1H) 8.31 (s, 1H)

MS [M−H]⁻: 272.9/273.9 (rt 1.90-1.97 min)

### Example P4

### Preparation of dimethyl 2-bromo-5-chloro-benzene-1,4-dicarboxylate

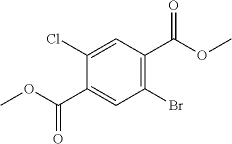

To a solution of 2-bromo-5-chloro-terephthalic (50 g, 178.91 mmol) in methanol (500 mL) was added concentrated sulfuric acid (50 ml) drop wise at 0° C. The reaction was refluxed for 6 h. The reaction mass was cooled to room temperature and solvent was evaporated off under reduced pressure. The residual mass was dissolved in ethylacetate (100 ml) and washed with water (2×25 ml) and finally with saturated sodium bicarbonate solution. Combined organic layers were dried over sodium sulfate and evaporated under reduced pressure to obtain dimethyl 2-bromo-5-chloro-benzene-1,4-dicarboxylate (48.5 g, 158 mmol, 88.2% of theoretical yield) as a white solid.

¹H NMR (400 MHz, DMSO-d6) δ ppm 3.89 (s, 6H) 7.97 (s, 1H) 8.15 31 (s, 1H)

### Example P5

### Preparation of dimethyl 2-(4,4,5,5-tetramethyl-1,3,2-dioxaborolan-2-yl)benzene-1,4-dicarboxylate

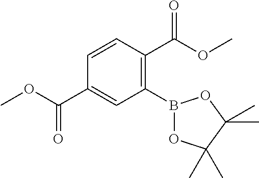

To a stirred solution of dimethyl 2-bromobenzene-1,4-dicarboxylate (15.8 g, 57.9 mmol) in 1,4 dioxane (140 mL) was added fused potassium acetate (17.2 g, 174 mmol), 4,4,5,5-tetramethyl-2-(4,4,5,5-tetramethyl-1,3,2-dioxaborolan-2-yl)-1,3,2-dioxaborolane (19.1 g, 75.2 mmol) and finally [1,1′-Bis(diphenylphosphino)ferrocene]-dichloropalladium(II) dichloromethane adduct (2.41 g, 2.89 mmol) under nitrogen. The reaction mixture was heated at 100° C. for 3 h. The reaction mixture was cooled to ambient temperature and diluted with water (100 mL) and then extracted with ethyl acetate (3×200 mL). Combined organic layer was washed with water (3×200 mL) followed by brine wash (200 mL). Organic layer was dried over sodium sulfate, filtered and evaporated completely to give crude compound. This crude obtained was purified by flash chromatography using 10% ethyl acetate in hexane as eluent to afford desired compound dimethyl 2-(4,4,5,5-tetramethyl-1,3,2-dioxaborolan-2-yl)benzene-1,4-dicarboxylate (15 g, 81% of theoretical yield).

¹H NMR (400 MHz, CHLOROFORM-d) δ ppm 1.41-1.45 (m, 15H) 3.94 (s, 6H) 8.00 (s, 1H) 8.05-8.13 (m, 1H) 8.16 (s, 1H)

### Example P6

### Preparation of methyl 1-hydroxy-3H-2,1-benzoxaborole-6-carboxylate

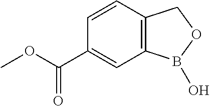

To a stirred solution of dimethyl 2-(4,4,5,5-tetramethyl-1,3,2-dioxaborolan-2-yl)benzene-1,4-dicarboxylate (17 g, 53.11 mmol) in methanol (170 mL) was added sodium borohydride (4.2 g, 106.2 mmol) in portions at 0° C. The reaction mixture was then allowed to stir at ambient temperature for 12 h. The reaction mixture was diluted with water (100 mL) and evaporated under reduced pressure. The residual mass was diluted with 2N HCl to pH 2 and stirred for 4 h. Precipitation of fine white solid occurred, which was collected by filtration and washed with water and dried under vacuum to afford methyl 1-hydroxy-3H-2,1-benzoxaborole-6-carboxylate (9 g, 88% of theoretical yield) as a white solid.

¹H NMR (400 MHz, DMSO-d₆) δ ppm 3.33 (s, 3H) 3.88 (s, 3H) 5.07 (s, 2H) 7.56 (dd, J=8.03, 0.75 Hz, 1H) 8.07 (d, J=8.13 Hz, 1H) 8.41 (s, 1H) 9.39 (s, 1H)

LC-MS-M+H− 193 (RT; 1.40-1.42)

### Example P7

### Preparation of 1-hydroxy-3H-2,1-benzoxaborole-6-carboxylic acid

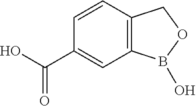 [SMILES: O=C(O)c1ccc2c(c1)B(O)OC2]

To a stirred solution of methyl 1-hydroxy-3H-2,1-benzoxaborole-6-carboxylate (5 g, 26.04 mmol) in water (10 mL) was added sodium hydroxide (2.6 g, 65.1 mmol) dissolved in 10 ml water. Reaction mass was stirred at 50° C. for 12 h. The reaction mixture was cooled to 10° C. and diluted with 2N HCl to pH 2. Precipitation of fine white solid occurred, which was collected by filtration and washed with water and dried under vacuum to afford 1-hydroxy-3H-2,1-benzoxaborole-6-carboxylic acid (4.2 g, 91% of theoretical yield) as a white solid.

¹H NMR (400 MHz, DMSO-d6) δ ppm 4.91-5.03 (m, 1H) 5.05 (s, 2H) 7.45-7.58 (m, 1H) 7.98-8.10 (m, 1H) 8.39-8.41 (m, 1H) 8.63-10.03 (m, 1H) 11.60-14.04 (m, 1H)

MS [M−H]⁻: 177 (rt 1.07-1.10 min)

### Example P8

### Preparation of ethyl 1-hydroxy-3H-2,1-benzoxaborole-6-carboxylate

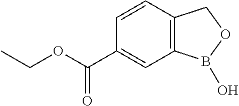

To a stirred solution of 1-hydroxy-3H-2,1-benzoxaborole-6-carboxylic acid (0.1 g, 26.04 mmol) in ethanol (2 mL) was added conc. Sulphuric acid (0.2 ml). Reaction mass was refluxed overnight. The reaction mixture was the cooled to ambient temperature and solvent was evaporated under reduced pressure. The residual mass thus obtained was dissolved in ethyl acetate (10 mL). Organic layer was washed with water (3×200 mL) followed by brine wash (200 mL). Organic layer was then dried over sodium sulfate, filtered and evaporated completely to give crude compound. The crude obtained was purified by flash chromatography over silicagel with hexane/ethyl acetate 1:0 to 80:20 as eluent to afford desired compound ethyl 1-hydroxy-3H-2,1-benzoxaborole-6-carboxylate (0.101 g, 90% of theoretical yield).

¹H NMR (400 MHz, DMSO-d6) δ ppm 1.18-1.37 (m, 3H) 4.34 (q, J=7.03 Hz, 2H) 5.07 (s, 2H) 7.56 (d, J=7.91 Hz, 1H) 8.07 (dd, J=7.91, 1.63 Hz, 1H) 8.41 (dd, J=1.51, 0.75 Hz, 1H) 9.39 (s, 1H)

MS [M+H]⁺⁻: 207.1 (rt 1.56-1.60 min)

### Example P9

### Preparation of 3-thienyl methyl 1-hydroxy-3H-2,1-benzoxaborole-6-carboxylate

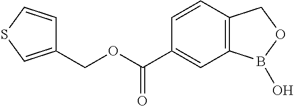 [SMILES: O=C(OCc1ccsc1)c1ccc2c(c1)B(O)OC2]

To a stirred solution of 1-hydroxy-3H-2,1-benzoxaborole-6-carboxylic acid (0.150 g, 0.843 mmol) in dichloromethane (10 mL/g, 23.4 mmol) were added 3-thienylmethanol (0.106 g, 0.927 mmol), 3-(ethyliminomethyleneamino)-N,N-dimethyl-propan-1-amine hydrochloride (0.178 g, 0.927 mmol) and DMAP (0.002 g, 0.0169 mmol) and the RM was stirred at ambient temperature for 5 h. Reaction mixture was diluted 10 ml water and then acidified with dil.HCl till pH-3. The aqueous layer was then extracted with dichloromethane (2×50 ml). The combined organic layer was washed with brine solution (2×10 ml) and then dried over anhydrous sodium sulfate, filtered and evaporated completely to give crude compound. The crude mass thus obtained was purified by flash chromatography over silica gel with hexane/ethyl acetate 1:0 to 70:30 as eluent to afford desired compound 3-thienylmethyl 1-hydroxy-3H-2,1-benzoxaborole-6-carboxylate (0.120 g, 52% of theoretical yield).

¹H NMR (400 MHz, DMSO-d6) δ ppm 1.17 (s, 1H) 1.22 (s, 1H) 2.50 (dt, J=3.70, 1.79 Hz, 3H) 3.34 (s, 1H) 5.06 (s, 2H) 5.54 (s, 2H) 7.06 (t, J=4.41 Hz, 1H) 7.28 (d, J=3.64 Hz, 1H) 7.54-7.62 (m, 2H) 8.06 (d, J=7.83 Hz, 1H) 8.40 (s, 1H) 9.42 (s, 1H)

### Example P10

### Preparation of N-[(4-chlorophenyl)methyl]-1-hydroxy-3H-2,1-benzoxaborole-6-carboxamide

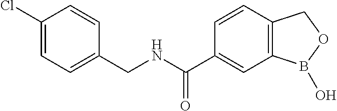 [SMILES: O=C(NCc1ccc(Cl)cc1)c1ccc2c(c1)B(O)OC2]

To a stirred solution of 1-hydroxy-3H-2,1-benzoxaborole-6-carboxylic acid (0.080 g, 0.4496 mmol) in dichloromethane (10 mL/g, 23.4 mmol) were added (4-chlorophenyl)methanamine (0.070 g 0.4945 mmol), HATU (0.188 g, 0.4945 mmol) and triethylamine (0.136 g, 1.349 mmol) and the RM was stirred at ambient temperature for 12 h. Reaction mixture was diluted 10 ml water. The aqueous layer was then extracted with dichloromethane (2×50 ml). The combined organic layer was washed with brine solution (2×10 ml) and then dried over anhydrous sodium sulfate, filtered and evaporated completely to give crude compound. The crude mass thus obtained was purified by flash chromatography over silica gel with hexane/ethyl acetate 1:0 to 70:30 as eluent to afford desired compound N-[(4-chlorophenyl)methyl]-1-hydroxy-3H-2,1-benzoxaborole-6-carboxamide (0.055 g, 40% of theoretical yield).

¹H NMR (400 MHz, DMSO-d6) δ ppm 4.47 (d, J=6.02 Hz, 2H) 5.04 (s, 2H) 7.33-7.41 (m, 4H) 7.50 (d, J=7.78 Hz, 1H) 7.97 (dd, J=8.03, 1.76 Hz, 1H) 8.25 (s, 1H) 9.09 (t, J=6.10 Hz, 1H) 9.30 (s, 1H)

MS [M+H]⁺⁻: 302.1/303.1 (rt 1.66-168 min)

### Example P11

### Preparation of 1-hydroxy-N-methoxy-N-methyl-3H-2,1-benzoxaborole-6-carboxamide

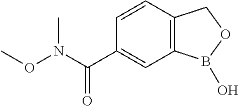 [SMILES: CON(C)C(=O)c1ccc2c(c1)B(O)OC2]

To a stirred solution of 1-hydroxy-3H-2,1-benzoxaborole-6-carboxylic acid (0.1 g, 0.562 mmol) in dichloromethane (10 mL) were added N,O-dimethylhydroxylamine (0.043 g 0.6743 mmol), Propylphosphonic anhydride (0.282 g, 0.843 mmol) and triethylamine (0.17 g, 1.686 mmol). The reaction mixture was stirred at ambient temperature for 3 h. Reaction mixture was diluted 10 ml water and aqueous layer was then extracted with dichloromethane (2×50 ml). The combined organic layer was washed with 2N HCl (1×10 ml), water (2×10 ml) finally with brine solution (2×10 ml). The organic layer was dried over anhydrous sodium sulfate, filtered and evaporated completely to afford desired compound 1-hydroxy-N-methoxy-N-methyl-3H-2,1-benzoxaborole-6-carboxamide (0.050 g, 40% of theoretical yield).

¹H NMR (400 MHz, DMSO-d6) δ ppm 3.23-3.31 (m, 3H) 3.54 (s, 3H) 5.04 (s, 2H) 7.48 (d, J=8.03 Hz, 1H) 7.69 (d, J=7.53 Hz, 1H) 7.97 (s, 1H) 9.34 (s, 1H)

MS [M+H]⁺⁻: 220.7/221.7 (rt 1.27-1.36 min)

The following tables illustrate the invention:

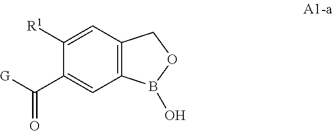

Table 1: This table discloses the 161 specific compounds of the formula A1-a, wherein R¹ is Cl, G has the specific meaning given in the corresponding line appropriately selected from the 161 lines T2.001 to T2.161 of Table T2.

Table 2: This table discloses the 161 specific compounds of the formula A1-a, wherein R¹ is F, G has the specific meaning given in the corresponding line appropriately selected from the 161 lines T2.001 to T2.161 of Table T2.

Table 3: This table discloses the 161 specific compounds of the formula A1-a, wherein R¹ is H, G has the specific meaning given in the corresponding line appropriately selected from the 161 lines T2.001 to T2.161 of Table T2.

Table 4: This table discloses the 161 specific compounds of the formula A1-a, wherein R¹ is OMe, G has the specific meaning given in the corresponding line appropriately selected from the 161 lines T2.001 to T2.161 of Table T2.

Table 5: This table discloses the 161 specific compounds of the formula A1-a, wherein R¹ is CF3, and G has the specific meaning given in the corresponding line appropriately selected from the 161 lines T2.001 to T2.161 of Table T2.

Table 6: This table discloses the 161 specific compounds of the formula A1-a, wherein R¹ is CN, G has the specific meaning given in the corresponding line appropriately selected from the 161 lines T2.001 to T2.161 of Table T2.

Table 7: This table discloses the 161 specific compounds of the formula A1-a, wherein R¹ is Me, G has the specific meaning given in the corresponding line appropriately selected from the 161 lines T2.001 to T2.161 of Table T2.

TABLE T2

| Cmpd No. | G | R2 | R3 | R4 |
|---|---|---|---|---|
| T2.001 | OR² | Ethyl | — | — |
| T2.002 | OR² | prop-2-ynyl | — | — |
| T2.003 | OR² | 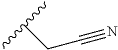 [SMILES: *CC#N] | — | — |
| T2.004 | OR² | Allyl | — | — |
| T2.005 | OR² | Isopropyl | — | — |
| T2.006 | OR² | 2-F-ethyl | — | — |
| T2.007 | OR² | 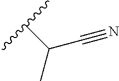 [SMILES: *C(C)C#N] | — | — |
| T2.008 | OR² | but-3-ynyl | — | — |
| T2.009 | OR² | but-2-ynyl | — | — |
| T2.010 | OR² | 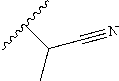 [SMILES: *C(C)C#N] | — | — |
| T2.011 | OR² | 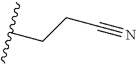 [SMILES: *CCC#N] | — | — |
| T2.012 | OR² | tetrahydrofuran-2-ylmethyl | — | — |
| T2.013 | OR² | 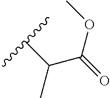 [SMILES: *C(C)C(=O)OC] | — | — |
| T2.014 | OR² | trimethylsilylmethyl | — | — |
| T2.015 | OR² | 3,3,3-trifluoropropyl | — | — |
| T2.016 | OR² | 4-methoxy-4-oxo-but-2-ynyl | — | — |
| T2.017 | OR² | 2-chloro-2,2-difluoro-ethyl | — | — |
| T2.018 | OR² | heptyl | — | — |
| T2.019 | OR² | 2-methylsulfonylethyl | — | — |
| T2.020 | OR² | (3-fluorophenyl)methyl | — | — |
| T2.021 | OR² | 3-trimethylsilylprop-2-ynyl | — | — |
| T2.022 | OR² | 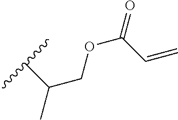 [SMILES: *C(C)COC(=O)C=C] | — | — |
| T2.023 | OR² | 1-methoxycarbonylbut-3-enyl | — | — |
| T2.024 | OR² | 3-trimethylsilylallyl | — | — |
| T2.025 | OR² | 1-phenylprop-2-ynyl | — | — |
| T2.026 | OR² | 3-phenylprop-2-ynyl | — | — |
| T2.027 | OR² | tetrahydrothiopyran-4-ylmethyl | — | — |
| T2.028 | OR² | 6-methoxytetrahydropyran-3-yl | — | — |
| T2.029 | OR² | 3-trimethylsilylpropyl | — | — |
| T2.030 | OR² | 2-butylsulfanylethyl | — | — |
| T2.031 | OR² | 2-(4-chlorophenoxy)ethyl | — | — |
| T2.032 | OR² | 2-ethoxycarbonylcyclohexyl | — | — |
| T2.033 | OR² | 6-(trifluoromethyl)-3- | — | — |
| | | pyridyl]methyl | | |
| T2.034 | OR² | (4-phenylphenyl)methyl | — | — |
| T2.035 | OR² | 2-(2,6-dichlorophenyl)ethyl | — | — |
| T2.036 | OR² | 2-(2,4-dichlorophenyl)ethyl | — | — |
| T2.037 | OR² | 4-(2-naphthyl)butyl | — | — |
| T2.038 | OR² | [2-chloro-4- | — | — |
| | | (trifluoromethyl)phenyl]methyl | | |
| T2.039 | OR² | [3-chloro-5- | — | — |
| | | (trifluoromethyl)2- | | |
| | | pyridyl]methyl | | |
| T2.040 | OR² | (4-oxo-4-pyrrolidin-1-yl-butyl) | — | — |
| T2.041 | OR² | 1-naphthylmethyl | — | — |
| T2.042 | OR² | 2-[2-(2- | — | — |
| | | methoxyethoxy)ethoxy]ethyl | | |
| T2.043 | OR² | (2-methoxy-2-oxo-1-phenyl- | — | — |
| | | ethyl) | | |
| T2.044 | OR² | 2-(4-methoxyphenoxy)ethyl | — | — |
| T2.045 | OR² | benzenesulfonylmethyl | — | — |
| T2.046 | OR² | phenacyl | — | — |
| T2.047 | OR² | cyclobutylmethyl | — | — |
| T2.048 | OR² | 2-dimethylaminoethyl | — | — |
| T2.049 | OR² | thietan-3-yl | — | — |
| T2.050 | OR² | [2-fluoro-1- | — | — |
| | | (fluoromethyl)ethyl] | | |
| T2.051 | OR² | 3-(1-methylpyrazol-4- | — | — |
| | | yl)propyl | | |
| T2.052 | OR² | (2-chlorothiazol-5-yl)methyl | — | — |
| T2.053 | OR² | 2-dimethoxyphosphorylethyl | — | — |
| T2.054 | OR² | 1-[ethoxy(methyl) | — | — |
| | | phosphoryl]ethyl | | |
| T2.055 | OR² | (1-methyl-2-morpholino- | — | — |
| | | ethyl) | | |
| T2.056 | NR³R⁴ | — | ethyl- | H |
| T2.057 | NR³R⁴ | — | butyl- | H |
| T2.058 | NR³R⁴ | — | but-2-yl- | H |
| T2.059 | NR³R⁴ | — | Allyl | H |
| T2.060 | NR³R⁴ | — | benzyl | H |
| T2.061 | NR³R⁴ | — | phenyl | H |
| T2.062 | NR³R⁴ | — | methyl | methoxy |
| T2.063 | NR³R⁴ | — | methyl | H |
| T2.064 | NR³R⁴ | — | methyl | methyl |
| T2.065 | NR³R⁴ | — | (1-methyl-1H-imidazol-4-yl)- | H |
| | | | methyl- | |
| T2.066 | NR³R⁴ | — | (1H-benzimidazol-2-yl)-methyl- | H |
| T2.067 | NR³R⁴ | — | 3-bromo-propyl- | H |
| T2.068 | NR³R⁴ | — | 3,3,3-trifluoro-propyl- | H |
| T2.069 | NR³R⁴ | — | (1-hydroxycyclohexyl)methyl | H |
| T2.070 | NR³R⁴ | — | 2-oxotetrahydrothiophen-3-yl | H |
| T2.071 | NR³R⁴ | — | 6-ethoxycarbonylcyclohex-3-en-1-yl | H |
| T2.072 | NR³R⁴ | — | [2-hydroxy-2-(4- | H |
| | | | hydroxyphenyl)ethyl] | |
| T2.073 | NR³R⁴ | — | 2-(1,3-benzodioxol-5-yl)ethyl | H |
| T2.074 | NR³R⁴ | — | 2-benzylsulfanylethyl | H |
| T2.075 | NR³R⁴ | — | 4-Methenesulfonyl-benzyl | H |
| T2.076 | NR³R⁴ | — | N′,N′-dimethylaminoethyl | H |
| T2.077 | NR³R⁴ | — | sec-Butyl | H |
| T2.078 | NR³R⁴ | — | Butan-1-ol-2-yl | H |
| T2.079 | NR³R⁴ | — | 1-methoxy-prop-2-yl- | H |
| T2.080 | NR³R⁴ | — | 2,2-Difluoro-ethyl | H |
| T2.081 | NR³R⁴ | — | Ethynyl-cyclohexyl | H |
| T2.082 | NR³R⁴ | — | 2-([1′,3′]dioxolan-2′-yl)-eth-1-yl- | H |
| T2.083 | NR³R⁴ | — | tetrahydrofuran-2-ylmeth-yl- | H |
| T2.084 | NR³R⁴ | — | 2-methyl-cyclohex-1-yl- | H |
| T2.085 | NR³R⁴ | — | 2-Morpholin-4-yl-ethyl | H |
| T2.086 | NR³R⁴ | — | 3-pyrrolidin-1-ylpropyl | H |
| T2.087 | NR³R⁴ | — | 2-sulfosulfanylethyl | H |
| T2.088 | NR³R⁴ | — | (pyrid-3-yl)-methyl- | H |
| T2.089 | NR³R⁴ | — | 3-(1-piperidyl)propyl | H |
| T2.090 | NR³R⁴ | — | Benzyl | H |
| T2.091 | NR³R⁴ | — | 3-(4-chlorophenyl)isoxazol-5-ylmethyl | H |
| T2.092 | NR³R⁴ | — | 2-fluoro-phenyl-meth-yl- | H |
| T2.093 | NR³R⁴ | — | 1-phenyl-eth-1-yl- | H |
| T2.094 | NR³R⁴ | — | 2-phenyl-eth-1-yl- | H |
| T2.095 | NR³R⁴ | — | (1,2,2,6,6-pentamethyl-4-piperidyl | H |
| T2.096 | NR³R⁴ | — | 2-(thiophen-2′-yl)-eth-1-yl- | H |
| T2.097 | NR³R⁴ | — | 2-Phenoxy-ethyl | H |
| T2.098 | NR³R⁴ | — | (3-chloro-phenyl)-methyl- | H |
| T2.099 | NR³R⁴ | — | (2,3-dihydro-benzo[1,4]dioxin-6-yl)- | H |
| | | | methyl- | |
| T2.100 | NR³R⁴ | — | 2-Acetylamino-ethyl | H |
| T2.101 | NR³R⁴ | — | (4-methoxy-phenyl)-methyl- | H |
| T2.102 | NR³R⁴ | — | 4-Pyrazol-1-yl-benzyl | H |
| T2.103 | NR³R⁴ | — | (2-trifluoromethoxy-phenyl)-methyl- | H |
| T2.104 | NR³R⁴ | — | 2-(indol-3′-yl)-eth-1-yl- | H |
| T2.105 | NR³R⁴ | — | 2-trifluoromethyl-benzyl- | H |
| T2.106 | NR³R⁴ | — | 2-Methylsulfanyl-ethyl | H |
| T2.107 | NR³R⁴ | — | 2-Piperidin-1-yl-benzyl | H |
| T2.108 | NR³R⁴ | — | 4-Phenoxy-benzyl | H |
| T2.109 | NR³R⁴ | — | (6-Chloro-pyridin-3-yl)-methyl | H |
| T2.110 | NR³R⁴ | — | 1-Benzyl-pyrrolidin-3-yl | H |
| T2.111 | NR³R⁴ | — | 2-Piperidin-1-yl-benzyl | H |
| T2.112 | NR³R⁴ | — | Furan-2-yl-methyl | H |
| T2.113 | NR³R⁴ | — | 2-chloro-phenyl- | H |
| T2.114 | NR³R⁴ | — | 4-methoxycarbonylphenyl | H |
| T2.115 | NR³R⁴ | — | 4-isopropylphenyl | H |
| T2.116 | NR³R⁴ | — | 2-methyl-phenyl- | H |
| T2.117 | NR³R⁴ | — | 2-chloro-6-methyl-phenyl- | H |
| T2.118 | NR³R⁴ | — | quinolin-5-yl- | H |
| T2.119 | NR³R⁴ | — | 2,4-dimethoxy-phenyl- | H |
| T2.120 | NR³R⁴ | — | 3-fluoro-phenyl- | H |
| T2.121 | NR³R⁴ | — | 1H-Indazol-5-yl | H |
| T2.122 | NR³R⁴ | — | 3-phenylphenyl | H |
| T2.123 | NR³R⁴ | — | 4-pyrrol-1-ylphenyl | H |
| T2.124 | NR³R⁴ | — | 4-Piperidin-1-yl-phenyl | H |
| T2.125 | NR³R⁴ | — | (2-benzoylphenyl) | H |
| T2.126 | NR³R⁴ | — | 2-methoxycarbonylbenzothiophen-5-yl | H |
| T2.127 | NR³R⁴ | — | 2-methoxy-5-phenyl-phenyl | H |
| T2.128 | NR³R⁴ | — | 2-methylsulfanylphenyl | H |
| T2.129 | NR³R⁴ | — | 1,3-benzothiazol-6-yl | H |
| T2.130 | NR³R⁴ | — | 2-morpholino-5- | H |
| | | | (trifluoromethyl)phenyl | |
| T2.131 | NR³R⁴ | — | 2-(1H-indol-2-yl)phenyl | H |
| T2.132 | NR³R⁴ | — | 2-morpholinophenyl | H |
| T2.133 | NR³R⁴ | — | 4-Methyl-2-oxo-2H-chromen-7-yl | H |
| T2.134 | NR³R⁴ | — | 4-(dimethylsulfamoyl)phenyl | H |
| T2.135 | NR³R⁴ | — | 4-(2-pyridylsulfamoyl)phenyl | H |
| T2.136 | NR³R⁴ | — | 1,3-dimethyl-1H-pyrazol-5-yl- | H |
| T2.137 | NR³R⁴ | — | 4-methylthiazol-2-yl | H |
| T2.138 | NR³R⁴ | — | 5-methylsulfanyl-1H-[1,2,4]-triazol-3-yl | H |
| T2.139 | NR³R⁴ | — | 3-methyl-2-pyridyl | H |
| T2.140 | NR³R⁴ | — | 4-methyl-6-methylsulfanyl-1,3,5- | H |
| | | | triazin-2-yl | |
| T2.141 | NR³R⁴ | — | 4-hydroxy-6-methyl-pyrimidin-2-yl | H |
| T2.142 | NR³R⁴ | — | 5-methoxycarbonyl-2-pyridyl | H |
| T2.143 | NR³R⁴ | — | Quinolin-2-yl | H |
| T2.144 | NR³R⁴ | — | 5-methyl-3-phenyl-isoxazol-4-yl | H |
| T2.145 | NR³R⁴ | — | 9H-Purin-6-yl | H |
| T2.146 | NR³R⁴ | — | 5-acetyl-4-methyl-thiazol-2-yl | H |
| T2.147 | NR³R⁴ | — | 5-phenyl-1H-pyrazol-3-yl | H |
| T2.148 | NR³R⁴ | — | 4-methyl-1,3-benzothiazol-2-yl | H |
| T2.149 | NR³R⁴ | — | 5-methyl-1,3,4-thiadiazol-2-yl | H |
| T2.150 | NR³R⁴ | — | 4-(4-chlorophenyl)thiadiazol-5-yl | H |
| T2.151 | NR³R⁴ | — | 6-phenoxy-3-pyridyl | H |
| T2.152 | NR³R⁴ | — | 3-cyano-5-phenyl-2-furyl | H |
| T2.153 | NR³R⁴ | — | 4-cyano-2-phenyl-pyrazol-3-yl | H |
| T2.154 | NR³R⁴ | — | 3-ethoxycarbonyl-4,5,6,7- | H |
| | | | tetrahydrobenzothiophen-2-yl | |
| T2.155 | NR³R⁴ | — | 2-methoxycarbonyl-3-thienyl | H |
| T2.156 | NR³R⁴ | — | 4-methyl-6-(2-thienyl)pyrimidin-2-yl | H |
| T2.157 | NR³R⁴ | — | 4,6-dimethyl-2H-pyrazolo[3,4- | H |
| | | | b]pyridin-3-yl | |
| T2.158 | NR³R⁴ | — | 4-(p-tolyl)thiazol-2-yl | H |
| T2.159 | NR³R⁴ | — | 5-phenyl-2-pyridyl | H |
| T2.160 | NR³R⁴ | — | —CH2—CH2—O—CH2—CH2— | |
| T2.161 | NR³R⁴ | — | —CH2—CH2—NH—CH2—CH2— | |

TABLE T1
Table of selected examples
The compounds in Table T1 the flowing formula:

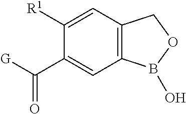

and the substituents have the meaning as follows:

| Cpd.No. | G | R¹ | R² | R³ | R⁴ | R⁵ | m.p. (° C.) |
|---|---|---|---|---|---|---|---|
| 1 | OR² | H | H | — | — | — | |
| 2 | NR²R³ | Cl | — | H | 4-Cl—Ph | — | 201-203 |
| 3 | OR² | Cl | CH₃—CH₂— | — | — | — | 129-131 |
| 4 | OR² | F | H | — | — | — | 216-218 |
| 5 | OR² | F | CH₃—CH₂— | — | — | — | 149-151 |
| 6 | NR²R³ | F | — | H | 4-Cl—Ph | — | 207-209 |
| 7 | NR²R³ | F | — | H | 4-Cl—CH₂—Ph | — | 179-181 |
| 8 | NR²R³ | F | — | H | 4-CN—CH₂—Ph | — | 187-189 |
| 9 | NR²R³ | H | — | H | 4-CN—CH₂—Ph | — | 136-138 |
| 10 | NR²R³ | H | — | H | 4-Cl—CH₂—Ph | — | 198-200 |
| 11 | OR2 | Cl | H | — | — | — | 220-222 |
| 12 | NR²R³ | Cl | — | H | 4-F—CH₂—Ph | — | — |
| 13 | NR²R³ | F | — | H | 4-F—Ph | — | 182-184 |
| 14 | NR²R³ | F | — | H | 4-F—CH₂—Ph | — | 179-181 |
| 15 | NR²R³ | Cl | — | H | 4-F—Ph | — | — |
| 16 | OR² | H | CH₃— | — | — | — | 167-169 |
| 17 | OR² | H | CH₃—CH₂— | — | — | — | 150-152 |
| 18 | OR² | H | CF₃—CH₂— | — | — | — | 120-122 |
| 19 | OR² | Cl | CF₃—CH₂— | — | — | — | 123-125 |
| 20 | OR² | F | CF₃—CH₂— | — | — | — | 124-126 |
| 21 | OR² | Cl | CH₃— | — | — | — | 162-164 |
| 22 | NR²R³ | Cl | — | —CH₂—CH₂—O—CH₂—CH₂— | | — | 206-208 |
| 23 | OR² | F | CH₃— | — | — | — | 168-170 |
| 24 | NR²R³ | Cl | — | H | CH₂═CH—CH₂— | — | 138-140 |
| 25 | NR²R³ | Cl | — | —CH₂—CH₂—CH₂—CH₂—CH₂— | | — | |
| 26 | NR²R³ | F | — | H | 4-CF₃—Ph | — | 183-188 |
| 27 | NR²R³ | F | — | H | 2,4-F—Ph | — | 165-171 |
| 28 | NR²R³ | H | — | —CH₂—CH₂—O—CH₂—CH₂— | | | 144-146 |
| 29 | NR²R³ | H | — | H | 4-Cl—Ph | — | 216-218 |
| 30 | NR²R³ | H | — | H | 4-F—Ph | — | 210-212 |
| 31 | NR²R³ | H | — | H | 2,4-F—Ph | — | — |
| 32 | NR²R³ | H | — | —CH₂—CH₂—CH₂—CH₂—CH₂— | | — | |
| 33 | NR²R³ | Cl | — | H | CH₃ | — | — |
| 34 | NR²R³ | H | — | H | CH₃ | — | — |
| 35 | NR²R³ | H | — | CH₃ | CH₃—O— | — | 169-171 |
| 36 | NR²R³ | H | — | CH₃ | CH₃—O— | — | 136-138 |
| 37 | OR² | Cl | CH₃—CH₂—CH₂— | — | — | — | — |
| 38 | NR²R³ | H | — | H | CH₃—O— | — | — |
| 39 | OR² | H | CH₃—CH₂—CH₂— | — | — | — | 98-100 |
| 40 | OR² | Cl | (CH₃)₂CH— | — | — | — | 108-110 |
| 41 | OR² | Cl | (CH₃)₂CH— | — | — | — | 116-118 |

| | MS | | LCMS | |
|---|---|---|---|---|
| Cpd.No. | [M + H]⁺ | Rₜ (min) | method | 1H-NMR data: ppm (multiplicity/number of Hs) |
| 1 | 177 | 1.07-1.10 | M2 | 1H NMR (400 MHz, DMSO-d6) δ ppm 4.91- |
| | | | | 5.03 (m, 1H) 5.05 (s, 2H) 7.45-7.58 (m, |
| | | | | 1H) 7.98-8.10 (m, 1H) 8.39-8.41 (m, |
| | | | | 1H) 8.63-10.03 (m, 1H) 11.60-14.04 (m, 1H) |
| 2 | 321.9 | 1.82-1.82 | M2 | 1H NMR (400 MHz, DMSO-d6) δ ppm 5.05 |
| | | | | (s, 2H) 7.36-7.49 (m, 2H) 7.67 (s, 1H) |
| | | | | 7.71-7.80 (m, 2H) 7.88 (s, 1H) 9.44 (br. |
| | | | | s., 1H) 10.66 (s, 1H) |
| 3 | 241.1 | 1.68-1.73 | M2 | 1H NMR (400 MHz, DMSO-d6) δ ppm 1.33 |
| | | | | (t, J = 7.03 Hz, 3H) 4.34 (q, J = 7.03 Hz, 2H) |
| | | | | 5.03 (s, 2H) 7.67 (s, 1H) 8.16 (s, 1H) 9.46 (s, 1H) |
| 4 | 195 | 1.08-1.11 | M2 | 1H NMR (400 MHz, DMSO-d6) δ ppm 5.02 |
| | | | | (s, 2H) 7.37 (d, J = 11.29 Hz, 1H) 8.29 (d, |
| | | | | J = 7.53 Hz, 1H) 9.38 (s, 1H) 13.17 (br. s., 1H) |
| 5 | 225.1 | 1.57-1.60 | M2 | 1H NMR (400 MHz, DMSO-d6) δ ppm 1.32 |
| | | | | (t, J = 7.03 Hz, 3H) 4.33 (q, J = 7.19 Hz, 2H) |
| | | | | 5.03 (s, 2H) 7.41 (d, J = 11.29 Hz, 1H) 8.30 |
| | | | | (d, J = 7.53 Hz, 1H) 9.42 (s, 1H) |
| 6 | 306 | 1.79-1.81 | M2 | 1H NMR (400 MHz, DMSO-d6) δ ppm 5.05 |
| | | | | (s, 2H) 7.40-7.45 (m, 3H) 7.76 (d, J = 7.99 |
| | | | | Hz, 2H) 8.01 (d, J = 7.03 Hz, 1H) 9.39 (s, |
| | | | | 1H) 10.57 (s, 1H) |
| 7 | 320 | 1.73-1.75 | M2 | 1H NMR (400 MHz, DMSO-d6) δ ppm 4.46 |
| | | | | (d, J = 6.02 Hz, 2H) 5.02 (s, 2H) 7.34-7.43 |
| | | | | (m, 5H) 8.00 (d, J = 7.28 Hz, 1H) 8.92 (t, |
| | | | | J = 6.17 Hz, 1H) 9.35 (s, 1H) |
| 8 | 311 | 1.50-1.53 | M2 | 1H NMR (400 MHz, DMSO-d6) δ ppm 4.56 |
| | | | | (d, J = 6.02 Hz, 2H) 5.02 (s, 2H) 7.38 (d, |
| | | | | J = 10.79 Hz, 1H) 7.53 (m, J = 8.28 Hz, 2H) |
| | | | | 7.77-7.89 (m, 2H) 8.03 (d, J = 7.28 Hz, |
| | | | | 1H) 9.00 (t, J = 6.00 Hz, 1H) 9.35 (br. s., 1H) |
| 9 | 293.1 | 1.44-1.48 | M2 | 1H NMR (400 MHz, DMSO-d6) δ ppm 4.52 |
| | | | | (d, J = 6.02 Hz, 3H) 5.01 (s, 2H) 7.48 (d, |
| | | | | J = 7.63 Hz, 4H) 7.71-7.78 (m, 3H) 7.95 |
| | | | | (dd, J = 8.03, 1.76 Hz, 1H) 8.23 (d, J = 0.75 |
| | | | | Hz, 1H) 9.14 (t, J = 5.87 Hz, 1H) 9.27 (s, 1H) |
| 10 | 302.1 | 1.66-1.68 | M2 | 1H NMR (400 MHz, DMSO-d6) δ ppm 4.47 |
| | | | | (d, J = 6.02 Hz, 2H) 5.04 (s, 2H) 7.33-7.41 |
| | | | | (m, 4H) 7.50 (d, J = 7.78 Hz, 1H) 7.97 (dd, |
| | | | | J = 8.03, 1.76 Hz, 1H) 8.25 (s, 1H) 9.09 (t, |
| | | | | J = 6.10 Hz, 1H) 9.30 (s, 1H) |
| 11 | 211 | 1.16-1.22 | M2 | 1H NMR (400 MHz, DMSO-d6) δ ppm 5.02 |
| | | | | (s, 2H) 7.63 (s, 1H) 8.16 (s, 1H) 9.42 (s, |
| | | | | 1H) 13.29 (br. s., 1H) |
| 12 | 320 | 1.64-1.67 | M2 | 1H NMR (400 MHz, DMSO-d6) δ ppm 4.44 |
| | | | | (d, J = 6.02 Hz, 2H) 5.01 (s, 2H) 7.15-7.26 |
| | | | | (m, 2H) 7.37-7.45 (m, 2H) 7.59 (s, 1H) |
| | | | | 7.77 (s, 1H) 9.00 (t, J = 5.98 Hz, 1H) 9.38 (s, 1H) |
| 13 | 290.1 | 1.65-1.69 | M2 | 1H NMR (400 MHz, DMSO-d6) δ ppm 5.00- |
| | | | | 5.10 (m, 2H) 7.20 (t, J = 8.36 Hz, 2H) 7.42 |
| | | | | (d, J = 10.54 Hz, 1H) 7.70-7.80 (m, 2H) |
| | | | | 8.01 (d, J = 7.03 Hz, 1H) 9.39 (br. s., 1H) 10.48 (s, 1H) |
| 14 | 304.1 | 1.63-1.65 | M2 | 1H NMR (400 MHz, DMSO-d6) δ ppm 4.40- |
| | | | | 4.50 (m, 3H) 5.02 (s, 2H) 7.09-7.26 (m, |
| | | | | 3H) 7.33-7.41 (m, 4H) 7.99 (d, J = 7.28 |
| | | | | Hz, 1H) 8.90 (t, J = 5.95 Hz, 1H) 9.34 (br. s., 1H) |
| 15 | 306 | 1.68-1.72 | M2 | 1H NMR (400 MHz, DMSO-d6) δ ppm 5.05 |
| | | | | (s, 2H) 7.20 (t, J = 8.02 Hz, 2H) 7.66 (s, |
| | | | | 1H) 7.74 (t, J = 6.31 Hz, 3H) 7.87 (s, 1H) |
| | | | | 9.45 (s, 1H) 10.57 (s, 1H) |
| 16 | 193.1 | 1.38-1.42 | M2 | 1H NMR (400 MHz, DMSO-d6) δ ppm 3.84- |
| | | | | 3.92 (m, 3H) 5.07 (s, 2H) 7.56 (d, J = 8.03 |
| | | | | Hz, 1H) 8.02-8.12 (m, 1H) 8.41 (s, 1H) 9.39 (s, 1H) |
| 17 | 207.1 | 1.56-1.60 | M2 | 1H NMR (400 MHz, DMSO-d6) δ ppm 1.18- |
| | | | | 1.37 (m, 3H) 4.34 (q, J = 7.03 Hz, 2H) |
| | | | | 5.07 (s, 2H) 7.56 (d, J = 7.91 Hz, 1H) 8.07 |
| | | | | (dd, J = 7.91, 1.63 Hz, 1H) 8.41 (dd, J = 1.51, |
| | | | | 0.75 Hz, 1H) 9.39 (s, 1H) |
| 18 | 261.1 | 1.76-1.78 | M2 | 1H NMR (400 MHz, DMSO-d6) δ ppm 5.00- |
| | | | | 5.11 (m, 4H) 7.62 (d, J = 7.85 Hz, 1H) |
| | | | | 8.10 (dd, J = 8.03, 1.51 Hz, 1H) 8.45 (d, |
| | | | | J = 1.00 Hz, 1H) 9.47 (s, 1H) |
| 19 | 294.9 | 1.82-1.88 | M2 | 1H NMR (400 MHz, DMSO-d6) δ ppm 5.01- |
| | | | | 5.10 (m, 4H) 7.74 (s, 1H) 8.28 (s, 1H) 9.57 (s, 1H) |
| 20 | 277 | 1.73-1.78 | M2 | 1H NMR (400 MHz, CHLOROFORM-d) δ |
| | | | | ppm 5.04-5.13 (m, 4H) 7.52 (s, 1H) 7.55 |
| | | | | (s, 1H) 8.42 (d, J = 7.53 Hz, 1H) 9.57 (s, 1H) |
| 21 | 227 | 1.54-1.60 | M2 | 1H NMR (400 MHz, DMSO-d6) δ ppm 3.88 |
| | | | | (s, 3H) 5.03 (s, 2H) 7.67 (s, 1H) 8.18 (s, 1H) 9.46 (s, 1H) |
| 22 | 206-208 | 281.9 | 1.20-1.27 | M2 |
| 23 | 210.9 | 1.35-1.39 | M2 | 1H NMR (400 MHz, DMSO-d6) δ ppm 3.87 |
| | | | | (s, 3H) 5.04 (s, 2H) 7.43 (d, J = 11.04 Hz, |
| | | | | 1H) 8.32 (d, J = 7.53 Hz, 1H) 9.43 (s, 1H) |
| 24 | 252 | 1.27-1.30 | M2 | 1H NMR (400 MHz, CHLOROFORM-d) δ |
| | | | | ppm 3.90-3.97 (m, 2H) 5.07 (s, 2H) 5.15- |
| | | | | 5.21 (m, 1H) 5.28-5.36 (m, 1H) 5.90- |
| | | | | 6.00 (m, 1H) 7.64 (s, 1H) 7.82 (s, 1H) |
| | | | | 8.68 (t, J = 5.77 Hz, 1H) 9.44 (s, 1H) |
| 25 | — | 280 | 1.51-1.55 | M2 |
| 26 | 339.9 | 1.83-1.87 | M2 | 1H NMR (400 MHz, DMSO-d6) δ ppm 5.06 |
| | | | | (s, 2H) 7.45 (d, J = 10.29 Hz, 1H) 7.74 (m, |
| | | | | J = 8.53 Hz, 2H) 7.95 (m, J = 8.53 Hz, 2H) |
| | | | | 8.04 (d, J = 8.22 Hz, 1H) 9.41 (s, 1H) 10.81 (s, 1H) |
| 27 | 308 | 1.63-1.67 | M2 | 1H NMR (400 MHz, DMSO-d6) δ ppm 5.06 |
| | | | | (s, 2H) 7.09-7.25 (m, 1H) 7.25-7.47 (m, |
| | | | | 3H) 7.76 (d, J = 6.53 Hz, 2H) 8.09 (d, |
| | | | | J = 7.28 Hz, 1H) 9.39 (s, 1H) 10.16 (s, 1H) |
| 28 | 144-146 | 248 | 1.00-1.06 | M2 |
| 29 | 287.9 | 1.70-1.75 | M2 | 1H NMR (400 MHz, DMSO-d6) δ ppm 5.08 |
| | | | | (s, 2H) 7.38-7.46 (m, 2H) 7.57 (d, J = 8.03 |
| | | | | Hz, 1H) 7.81-7.87 (m, 2H) 8.05 (d, |
| | | | | J = 8.14 Hz, 1H) 8.31-8.34 (m, 1H) 9.37 |
| | | | | (br. s., 1H) 10.44 (s, 1H) |
| 30 | 272 | 1.55-1.59 | M2 | 1H NMR (400 MHz, DMSO-d6) δ ppm 5.08 |
| | | | | (s, 2H) 6.57-6.63 (m, 1H) 6.87 (t, J = 8.18 |
| | | | | Hz, 1H) 7.04-7.24 (m, 3H) 7.56 (d, |
| | | | | J = 8.03 Hz, 1H) 7.72-7.90 (m, 2H) 8.04 |
| | | | | (dd, J = 8.03, 1.76 Hz, 1H) 8.32 (s, 1H) 10.37 (s, 1H) |
| 31 | 290 | 1.52-1.58 | M2 | 1H NMR (400 MHz, DMSO-d6) δ ppm 5.08 |
| | | | | (s, 2H) 7.10-7.15 (m, 1H) 7.33-7.37 (m, |
| | | | | 1H) 7.55-7.64 (m, 3H) 8.06 (dd, J = 7.91, |
| | | | | 1.63 Hz, 1H) 8.34 (s, 1H) 9.36 (br. s., 1H) 10.17 (s, 1H) |
| 32 | — | 246 | 1.37-1.45 | M2 |
| 33 | 225.9 | 0.96-0.99 | M2 | 1H NMR (400 MHz, DMSO-d6) δ ppm 2.55- |
| | | | | 2.62 (m, 4H) 4.81-4.85 (m, 2H) 7.40 (s, |
| | | | | 1H) 7.55 (s, 1H) 8.17 (d, J = 4.77 Hz, 1H) |
| | | | | 9.21 (br. s., 1H) |
| 34 | 192 | 0.74-0.79 | M2 | 1H NMR (400 MHz, DMSO-d6) δ ppm 2.79 |
| | | | | (d, J = 4.52 Hz, 3H) 5.01-5.06 (m, 2H) |
| | | | | 7.47 (d, J = 8.03 Hz, 1H) 7.91 (dd, J = 7.91, |
| | | | | 1.63 Hz, 1H) 8.21 (s, 1H) 8.44 (d, J = 6.03 |
| | | | | Hz, 1H) 9.29 (s, 1H) |
| 35 | 2559.9 | 1.27-1.48 | M2 | 1H NMR (400 MHz, DMSO-d6) δ ppm 3.30 |
| | | | | (br. s., 3H) 3.36 (br. s., 1H) 3.42 (br. s., |
| | | | | 3H) 5.03 (s, 2H) 7.61 (s, 1H) 7.71 (s, 1H) |
| | | | | 9.39 (br. s., 1H) |
| 36 | 221.7 | 1.27-1.36 | M2 | 1H NMR (400 MHz, DMSO-d6) δ ppm 3.23- |
| | | | | 3.31 (m, 3H) 3.54 (s, 3H) 5.04 (s, 2H) |
| | | | | 7.48 (d, J = 8.03 Hz, 1H) 7.69 (d, J = 7.53 Hz, |
| | | | | 1H) 7.97 (s, 1H) 9.34 (br. |
| 37 | 254.8 | 1.96-1.98 | M2 | 1H NMR (400 MHz, DMSO-d6) δ ppm 0.78- |
| | | | | 0.92 (m, 1H) 0.99 (t, J = 7.40 Hz, 3H) 1.74 |
| | | | | (sxt, J = 7.08 Hz, 2H) 4.27 (t, J = 6.53 Hz, |
| | | | | 2H) 5.04 (s, 2H) 7.67 (s, 1H) 8.17 (s, 1H) |
| | | | | 9.49 (br. s., 1H) |
| 38 | 207.8 | 0.46-0.5 | M2 | 1H NMR (400 MHz, DMSO-d6) δ ppm 3.67- |
| | | | | 3.75 (m, 3H) 5.04 (s, 2H) 7.50 (d, J = 8.03 |
| | | | | Hz, 1H) 7.83 (d, J = 7.78 Hz, 1H) 8.14 (s, |
| | | | | 1H) 9.33 (br. s., 1H) 11.74 (br. s., 1H) |
| 39 | 220.9 | 1.83-2.1 | M2 | 1H NMR (400 MHz, DMSO-d6) δ ppm 1.00 |
| | | | | (t, J = 7.40 Hz, 4H) 1.70-1.79 (m, 2H) 4.25 |
| | | | | (t, J = 6.53 Hz, 2H) 5.07 (s, 2H) 7.56 (d, |
| | | | | J = 8.03 Hz, 1H) 8.07 (d, J = 7.74 Hz, 1H) |
| | | | | 8.41 (s, 1H) 9.41 (s, 1H) |
| 40 | 220.9 | 1.81-2.1 | M2 | 1H NMR (400 MHz, DMSO-d6) δ ppm 1.36- |
| | | | | 1.44 (m, 8H) 5.12 (s, 2H) 5.17-5.27 (m, |
| | | | | 1H) 7.61 (d, J = 8.28 Hz, 1H) 8.11 (dd, |
| | | | | J = 8.03, 1.51 Hz, 1H) 8.44 (s, 1H) 9.45 (s, 1H) |
| 41 | 254.9 | 1.90-2.1 | M2 | 1H NMR (400 MHz, DMSO-d6) δ ppm 1.35 |
| | | | | (d, J = 6.27 Hz, 6H) 4.94-5.08 (m, 2H) |
| | | | | 5.11-5.27 (m, 1H) 7.59-7.83 (m, 1H) |
| | | | | 8.01-8.27 (m, 1H) 9.47 (s, 1 |

TABLE T1-A
Table of further selected examples

| Entry | STRUCTURE | RT (min) | [M + H] (measured) | Method | MP ° C. |
|---|---|---|---|---|---|
| 50 | 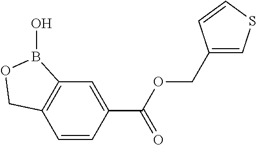 [SMILES: O=C(OCc1ccsc1)c1ccc2c(c1)B(O)OC2] | | | | 130-132 |
| 51 | 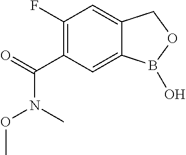 [SMILES: CON(C)C(=O)c1cc2c(cc1F)COB2O] | | | | 144-146 |
| 52 | 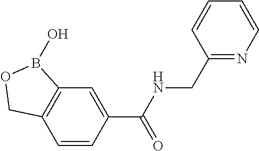 [SMILES: O=C(NCc1ccccn1)c1ccc2c(c1)B(O)OC2] | | | | |
| 53 | 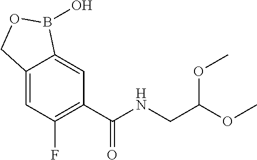 [SMILES: COC(CNC(=O)c1cc2c(cc1F)COB2O)OC] | | | | 150-152 |
| 54 | 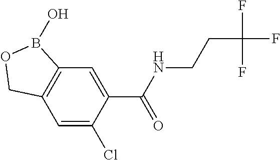 [SMILES: O=C(NCCC(F)(F)F)c1cc2c(cc1Cl)COB2O] | | | | |
| 55 | 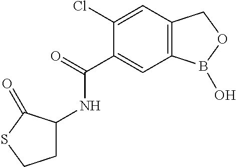 [SMILES: O=C(NC1CCSC1=O)c1cc2c(cc1Cl)COB2O] | | | | |
| 56 | 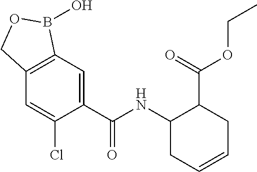 [SMILES: CCOC(=O)C1CC=CCC1NC(=O)c1cc2c(cc1Cl)COB2O] | | | | |
| 57 | 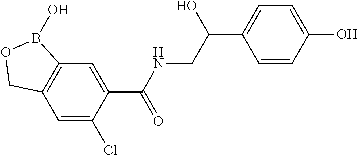 [SMILES: O=C(NCC(O)c1ccc(O)cc1)c1cc2c(cc1Cl)COB2O] | | | | |
| 58 | 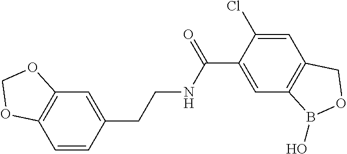 [SMILES: O=C(NCCc1ccc2c(c1)OCO2)c1cc2c(cc1Cl)COB2O] | | | | |
| 59 | 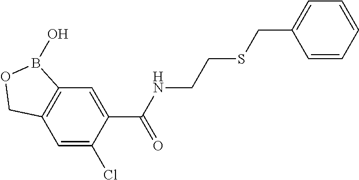 [SMILES: O=C(NCCSCc1ccccc1)c1cc2c(cc1Cl)COB2O] | | | | |
| 60 | 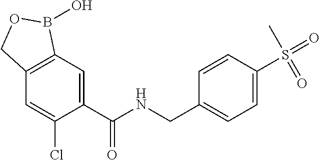 [SMILES: CS(=O)(=O)c1ccc(CNC(=O)c2cc3c(cc2Cl)COB3O)cc1] | | | | |
| 61 | 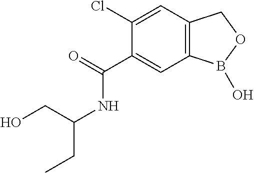 [SMILES: CCC(CO)NC(=O)c1cc2c(cc1Cl)COB2O] | | | | |
| 62 | 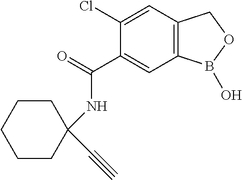 [SMILES: C#CC1(NC(=O)c2cc3c(cc2Cl)COB3O)CCCCC1] | | | | |
| 63 | 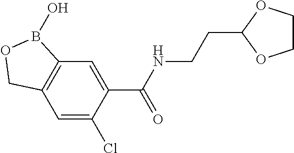 [SMILES: O=C(NCCC1OCCO1)c1cc2c(cc1Cl)COB2O] | | | | |
| 64 | 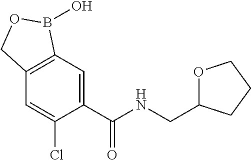 [SMILES: O=C(NCC1CCCO1)c1cc2c(cc1Cl)COB2O] | | | | |
| 65 | 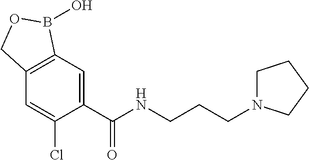 [SMILES: O=C(NCCCN1CCCC1)c1cc2c(cc1Cl)COB2O] | | | | |
| 66 | 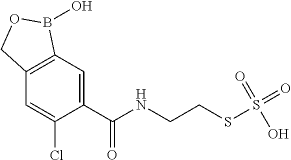 [SMILES: O=C(NCCSS(=O)(=O)O)c1cc2c(cc1Cl)COB2O] | | | | |
| 67 | 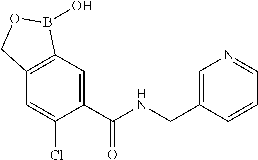 [SMILES: O=C(NCc1cccnc1)c1cc2c(cc1Cl)COB2O] | | | | |
| 68 | 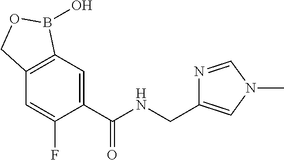 [SMILES: Cn1cnc(CNC(=O)c2cc3c(cc2F)COB3O)c1] | | | | |
| 69 | 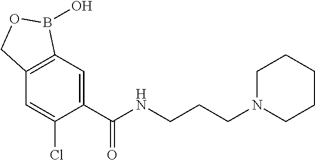 [SMILES: O=C(NCCCN1CCCCC1)c1cc2c(cc1Cl)COB2O] | | | | |
| 70 | 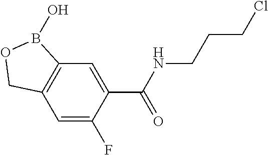 [SMILES: O=C(NCCCCl)c1cc2c(cc1F)COB2O] | | | | |
| 71 | 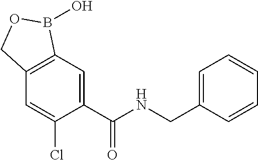 [SMILES: O=C(NCc1ccccc1)c1cc2c(cc1Cl)COB2O] | | | | |
| 72 | 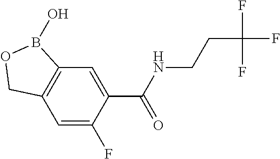 [SMILES: O=C(NCCC(F)(F)F)c1cc2c(cc1F)COB2O] | | | | |
| 73 | 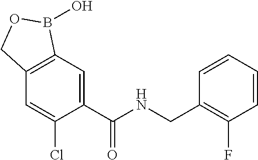 [SMILES: O=C(NCc1ccccc1F)c1cc2c(cc1Cl)COB2O] | | | | |
| 74 | 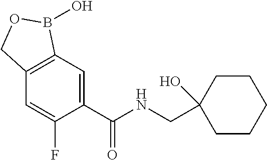 [SMILES: O=C(NCC1(O)CCCCC1)c1cc2c(cc1F)COB2O] | | | | |
| 75 | 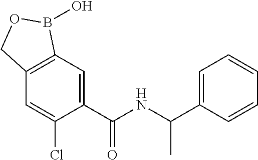 [SMILES: CC(NC(=O)c1cc2c(cc1Cl)COB2O)c1ccccc1] | | | | |
| 76 | 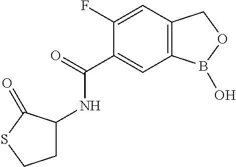 [SMILES: O=C(NC1CCSC1=O)c1cc2c(cc1F)COB2O] | | | | |
| 77 | 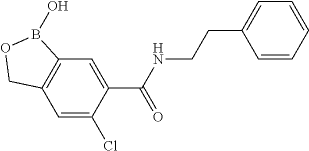 [SMILES: O=C(NCCc1ccccc1)c1cc2c(cc1Cl)COB2O] | | | | |
| 78 | 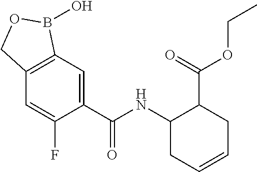 [SMILES: CCOC(=O)C1CC=CCC1NC(=O)c1cc2c(cc1F)COB2O] | | | | |
| 79 | 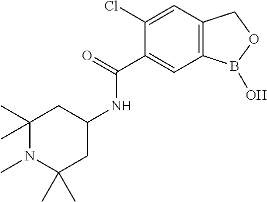 [SMILES: CN1C(C)(C)CC(NC(=O)c2cc3c(cc2Cl)COB3O)CC1(C)C] | | | | |
| 80 | 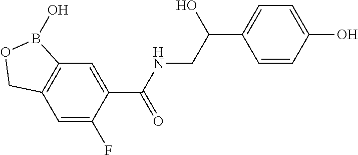 [SMILES: O=C(NCC(O)c1ccc(O)cc1)c1cc2c(cc1F)COB2O] | | | | |
| 81 | 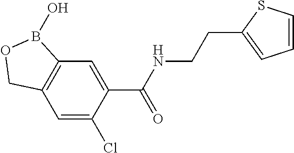 [SMILES: O=C(NCCc1cccs1)c1cc2c(cc1Cl)COB2O] | | | | |
| 82 | 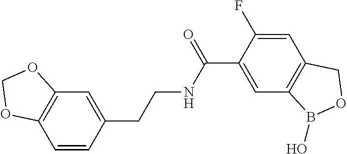 [SMILES: O=C(NCCc1ccc2c(c1)OCO2)c1cc2c(cc1F)COB2O] | | | | |
| 83 | 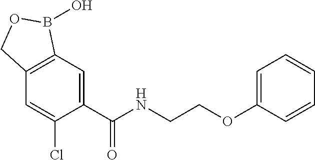 [SMILES: O=C(NCCOc1ccccc1)c1cc2c(cc1Cl)COB2O] | | | | |
| 84 | 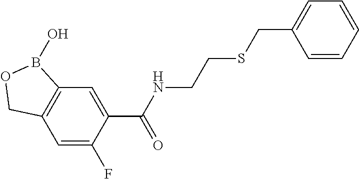 [SMILES: O=C(NCCSCc1ccccc1)c1cc2c(cc1F)COB2O] | | | | |
| 85 | 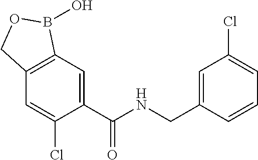 [SMILES: O=C(NCc1cccc(Cl)c1)c1cc2c(cc1Cl)COB2O] | | | | 263-265 |
| 86 | 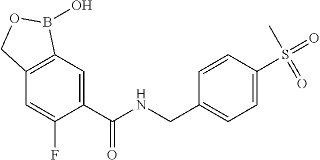 [SMILES: CS(=O)(=O)c1ccc(CNC(=O)c2cc3c(cc2F)COB3O)cc1] | | | | |
| 87 | 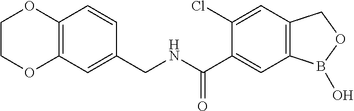 [SMILES: O=C(NCc1ccc2c(c1)OCCO2)c1cc2c(cc1Cl)COB2O] | | | | |
| 88 | 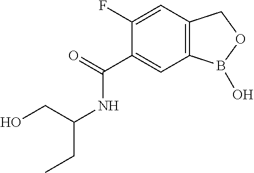 [SMILES: CCC(CO)NC(=O)c1cc2c(cc1F)COB2O] | | | | |
| 89 | 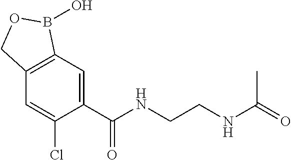 [SMILES: CC(=O)NCCNC(=O)c1cc2c(cc1Cl)COB2O] | | | | |
| 90 | 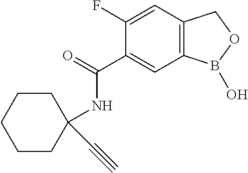 [SMILES: C#CC1(NC(=O)c2cc3c(cc2F)COB3O)CCCCC1] | | | | |
| 91 | 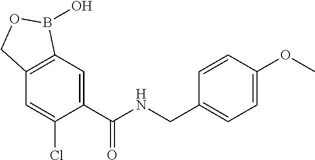 [SMILES: COc1ccc(CNC(=O)c2cc3c(cc2Cl)COB3O)cc1] | | | | |
| 92 | 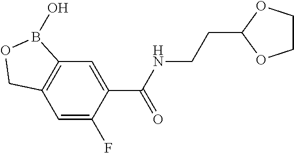 [SMILES: O=C(NCCC1OCCO1)c1cc2c(cc1F)COB2O] | | | | |
| 93 | 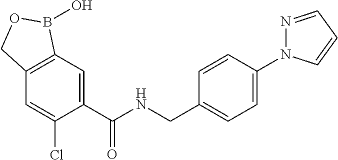 [SMILES: O=C(NCc1ccc(-n2cccn2)cc1)c1cc2c(cc1Cl)COB2O] | | | | |
| 94 | 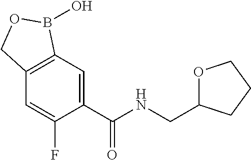 [SMILES: O=C(NCC1CCCO1)c1cc2c(cc1F)COB2O] | | | | |
| 95 | 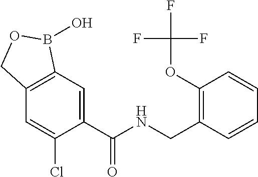 [SMILES: O=C(NCc1ccccc1OC(F)(F)F)c1cc2c(cc1Cl)COB2O] | | | | |
| 96 | 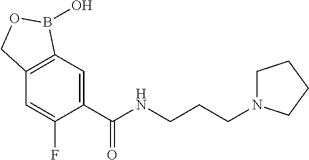 [SMILES: O=C(NCCCN1CCCC1)c1cc2c(cc1F)COB2O] | | | | |
| 97 | 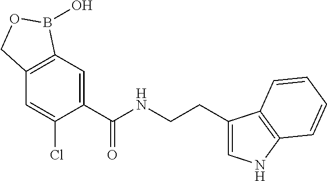 [SMILES: O=C(NCCc1c[nH]c2ccccc12)c1cc2c(cc1Cl)COB2O] | | | | |
| 98 | 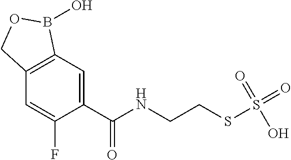 [SMILES: O=C(NCCSS(=O)(=O)O)c1cc2c(cc1F)COB2O] | | | | |
| 99 | 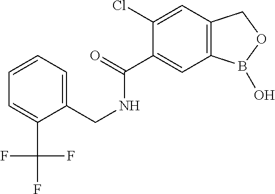 [SMILES: O=C(NCc1ccccc1C(F)(F)F)c1cc2c(cc1Cl)COB2O] | | | | |
| 100 | 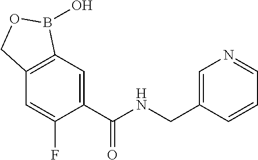 [SMILES: O=C(NCc1cccnc1)c1cc2c(cc1F)COB2O] | | | | |
| 101 | 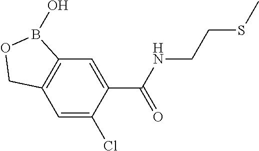 [SMILES: CSCCNC(=O)c1cc2c(cc1Cl)COB2O] | | | | |
| 102 | 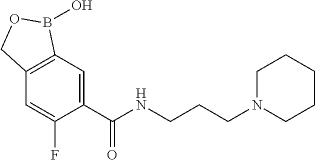 [SMILES: O=C(NCCCN1CCCCC1)c1cc2c(cc1F)COB2O] | | | | |
| 103 | 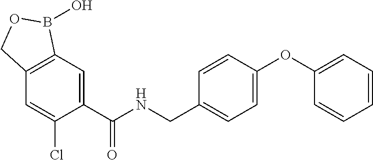 [SMILES: O=C(NCc1ccc(Oc2ccccc2)cc1)c1cc2c(cc1Cl)COB2O] | | | | |
| 104 | 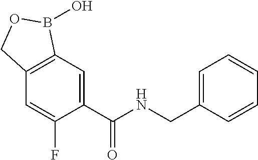 [SMILES: O=C(NCc1ccccc1)c1cc2c(cc1F)COB2O] | | | | |
| 105 | 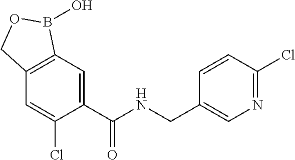 [SMILES: O=C(NCc1ccc(Cl)nc1)c1cc2c(cc1Cl)COB2O] | | | | |
| 106 | 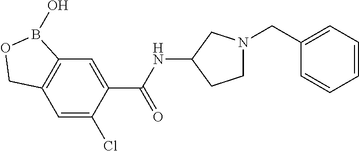 [SMILES: O=C(NC1CCN(Cc2ccccc2)C1)c1cc2c(cc1Cl)COB2O] | | | | |
| 107 | 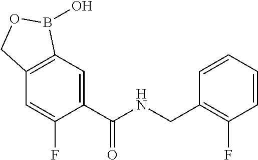 [SMILES: O=C(NCc1ccccc1F)c1cc2c(cc1F)COB2O] | | | | 175-177 |
| 108 | 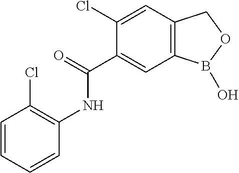 [SMILES: O=C(Nc1ccccc1Cl)c1cc2c(cc1Cl)COB2O] | | | | |
| 109 | 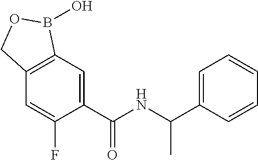 [SMILES: CC(NC(=O)c1cc2c(cc1F)COB2O)c1ccccc1] | | | | |
| 110 | 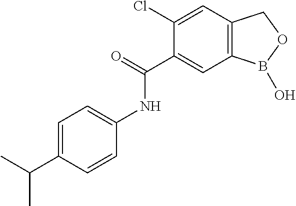 [SMILES: CC(C)c1ccc(NC(=O)c2cc3c(cc2Cl)COB3O)cc1] | | | | |
| 111 | 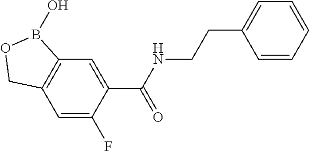 [SMILES: O=C(NCCc1ccccc1)c1cc2c(cc1F)COB2O] | | | | |
| 112 | 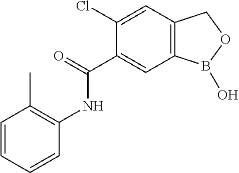 [SMILES: Cc1ccccc1NC(=O)c1cc2c(cc1Cl)COB2O] | | | | |
| 113 | 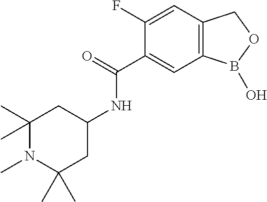 [SMILES: CN1C(C)(C)CC(NC(=O)c2cc3c(cc2F)COB3O)CC1(C)C] | | | | |
| 114 | 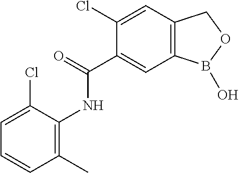 [SMILES: Cc1cccc(Cl)c1NC(=O)c1cc2c(cc1Cl)COB2O] | | | | |
| 115 | 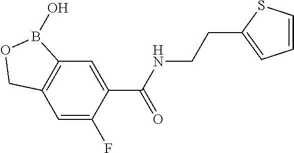 [SMILES: O=C(NCCc1cccs1)c1cc2c(cc1F)COB2O] | | | | |
| 116 | 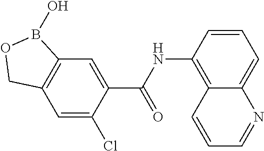 [SMILES: O=C(Nc1cccc2ncccc12)c1cc2c(cc1Cl)COB2O] | | | | |
| 117 | 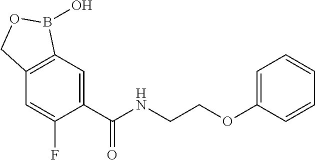 [SMILES: O=C(NCCOc1ccccc1)c1cc2c(cc1F)COB2O] | | | | |
| 118 | 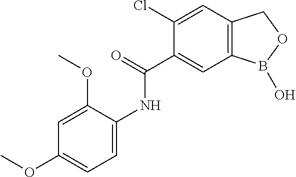 [SMILES: COc1ccc(NC(=O)c2cc3c(cc2Cl)COB3O)c(OC)c1] | | | | |
| 119 | 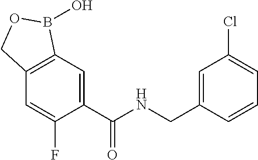 [SMILES: O=C(NCc1cccc(Cl)c1)c1cc2c(cc1F)COB2O] | | | | |
| 120 | 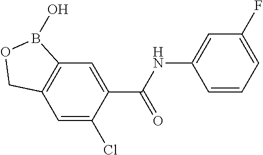 [SMILES: O=C(Nc1cccc(F)c1)c1cc2c(cc1Cl)COB2O] | | | | |
| 121 | 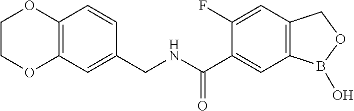 [SMILES: O=C(NCc1ccc2c(c1)OCCO2)c1cc2c(cc1F)COB2O] | | | | |
| 122 | 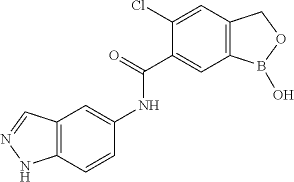 [SMILES: O=C(Nc1ccc2[nH]ncc2c1)c1cc2c(cc1Cl)COB2O] | | | | |
| 123 | 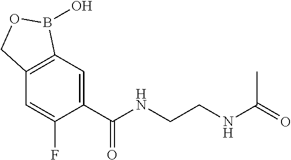 [SMILES: CC(=O)NCCNC(=O)c1cc2c(cc1F)COB2O] | | | | |
| 124 | 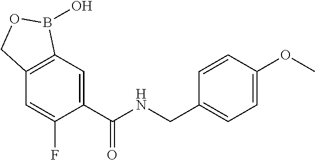 [SMILES: COc1ccc(CNC(=O)c2cc3c(cc2F)COB3O)cc1] | | | | |
| 125 | 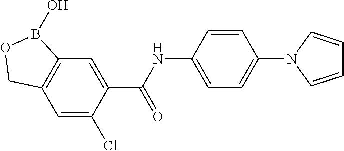 [SMILES: O=C(Nc1ccc(-n2cccc2)cc1)c1cc2c(cc1Cl)COB2O] | | | | |
| 126 | 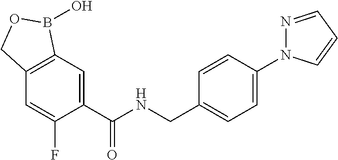 [SMILES: O=C(NCc1ccc(-n2cccn2)cc1)c1cc2c(cc1F)COB2O] | | | | |
| 127 | 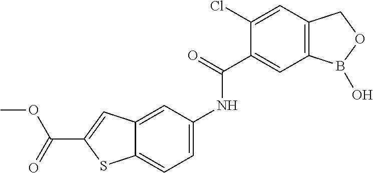 [SMILES: COC(=O)c1cc2cc(NC(=O)c3cc4c(cc3Cl)COB4O)ccc2s1] | | | | |
| 128 | 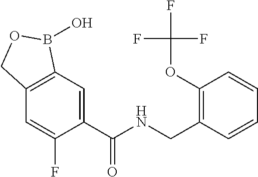 [SMILES: O=C(NCc1ccccc1OC(F)(F)F)c1cc2c(cc1F)COB2O] | | | | |
| 129 | 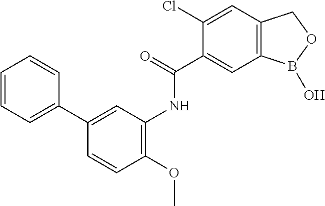 [SMILES: COc1ccc(-c2ccccc2)cc1NC(=O)c1cc2c(cc1Cl)COB2O] | | | | |
| 130 | 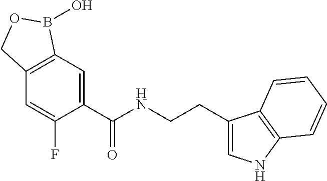 [SMILES: O=C(NCCc1c[nH]c2ccccc12)c1cc2c(cc1F)COB2O] | | | | |
| 131 | 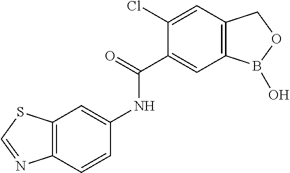 [SMILES: O=C(Nc1ccc2ncsc2c1)c1cc2c(cc1Cl)COB2O] | | | | |
| 132 | 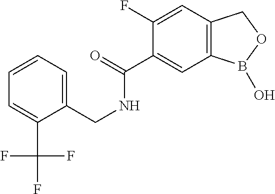 [SMILES: O=C(NCc1ccccc1C(F)(F)F)c1cc2c(cc1F)COB2O] | | | | |
| 133 | 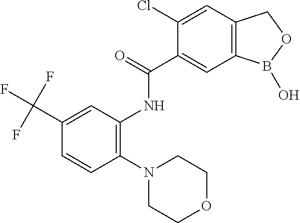 [SMILES: O=C(Nc1cc(C(F)(F)F)ccc1N1CCOCC1)c1cc2c(cc1Cl)COB2O] | | | | |
| 134 | 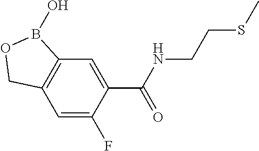 [SMILES: CSCCNC(=O)c1cc2c(cc1F)COB2O] | | | | |
| 135 | 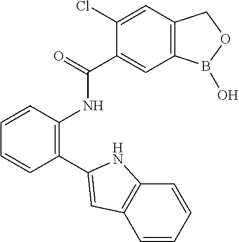 [SMILES: O=C(Nc1ccccc1-c1cc2ccccc2[nH]1)c1cc2c(cc1Cl)COB2O] | | | | |
| 136 | 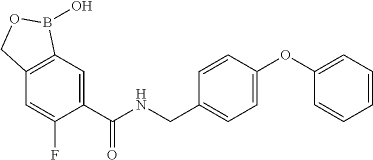 [SMILES: O=C(NCc1ccc(Oc2ccccc2)cc1)c1cc2c(cc1F)COB2O] | | | | 178-180 |
| 137 | 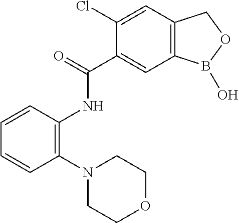 [SMILES: O=C(Nc1ccccc1N1CCOCC1)c1cc2c(cc1Cl)COB2O] | | | | |
| 138 | 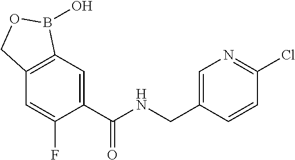 [SMILES: O=C(NCc1ccc(Cl)nc1)c1cc2c(cc1F)COB2O] | | | | |
| 139 | 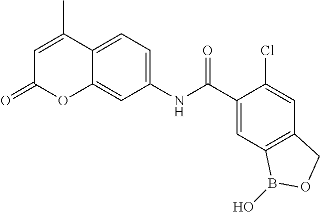 [SMILES: Cc1cc(=O)oc2cc(NC(=O)c3cc4c(cc3Cl)COB4O)ccc12] | | | | |
| 140 | 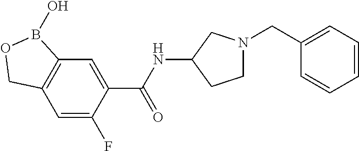 [SMILES: O=C(NC1CCN(Cc2ccccc2)C1)c1cc2c(cc1F)COB2O] | | | | |
| 141 | 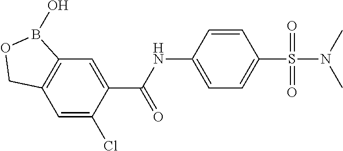 [SMILES: CN(C)S(=O)(=O)c1ccc(NC(=O)c2cc3c(cc2Cl)COB3O)cc1] | | | | |
| 142 | 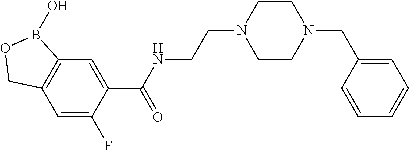 [SMILES: O=C(NCCN1CCN(Cc2ccccc2)CC1)c1cc2c(cc1F)COB2O] | | | | |
| 143 | 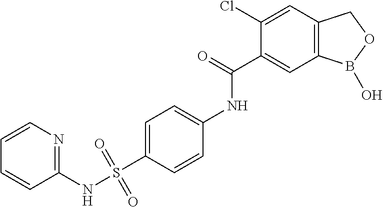 [SMILES: O=C(Nc1ccc(S(=O)(=O)Nc2ccccn2)cc1)c1cc2c(cc1Cl)COB2O] | | | | |
| 144 | 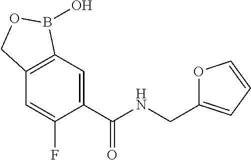 [SMILES: O=C(NCc1ccco1)c1cc2c(cc1F)COB2O] | | | | 158-160 |
| 145 | 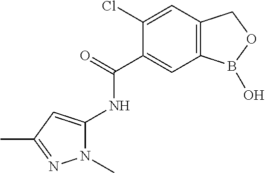 [SMILES: Cc1cc(NC(=O)c2cc3c(cc2Cl)COB3O)n(C)n1] | | | | |
| 146 | 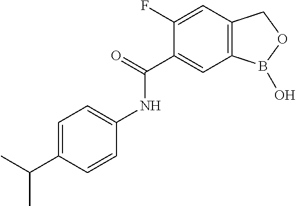 [SMILES: CC(C)c1ccc(NC(=O)c2cc3c(cc2F)COB3O)cc1] | | | | 184-186 |
| 147 | 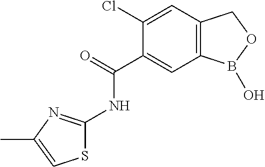 [SMILES: Cc1csc(NC(=O)c2cc3c(cc2Cl)COB3O)n1] | | | | |
| 148 | 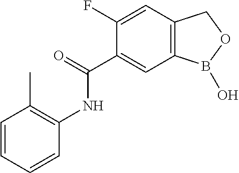 [SMILES: Cc1ccccc1NC(=O)c1cc2c(cc1F)COB2O] | | | | |
| 149 | 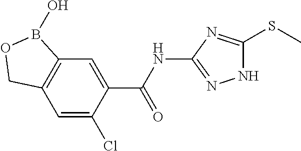 [SMILES: CSc1nc(NC(=O)c2cc3c(cc2Cl)COB3O)n[nH]1] | | | | |
| 150 | 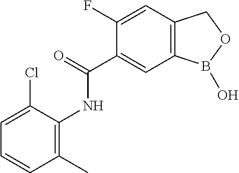 [SMILES: Cc1cccc(Cl)c1NC(=O)c1cc2c(cc1F)COB2O] | | | | 212-214 |
| 151 | 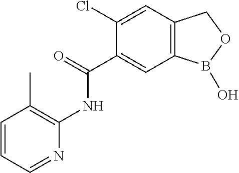 [SMILES: Cc1cccnc1NC(=O)c1cc2c(cc1Cl)COB2O] | | | | |
| 152 | 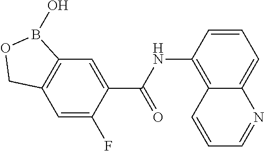 [SMILES: O=C(Nc1cccc2ncccc12)c1cc2c(cc1F)COB2O] | | | | |
| 153 | 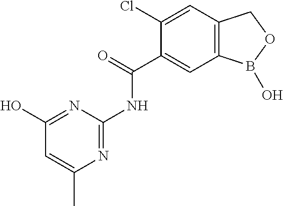 [SMILES: Cc1cc(O)nc(NC(=O)c2cc3c(cc2Cl)COB3O)n1] | | | | |
| 154 | 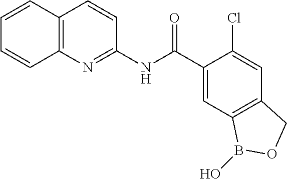 [SMILES: O=C(Nc1ccc2ccccc2n1)c1cc2c(cc1Cl)COB2O] | | | | |
| 155 | 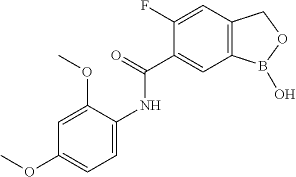 [SMILES: COc1ccc(NC(=O)c2cc3c(cc2F)COB3O)c(OC)c1] | | | | |
| 156 | 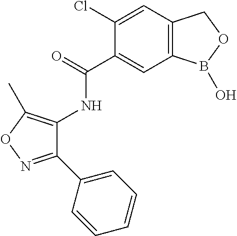 [SMILES: Cc1onc(-c2ccccc2)c1NC(=O)c1cc2c(cc1Cl)COB2O] | | | | |
| 157 | 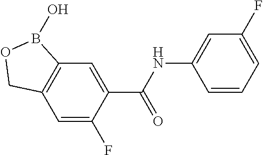 [SMILES: O=C(Nc1cccc(F)c1)c1cc2c(cc1F)COB2O] | | | | |
| 158 | 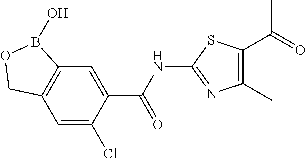 [SMILES: CC(=O)c1sc(NC(=O)c2cc3c(cc2Cl)COB3O)nc1C] | | | | |
| 159 | 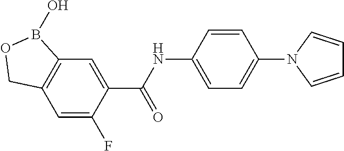 [SMILES: O=C(Nc1ccc(-n2cccc2)cc1)c1cc2c(cc1F)COB2O] | | | | |
| 160 | 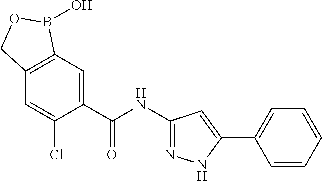 [SMILES: O=C(Nc1cc(-c2ccccc2)[nH]n1)c1cc2c(cc1Cl)COB2O] | | | | |
| 161 | 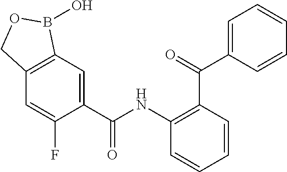 [SMILES: O=C(Nc1ccccc1C(=O)c1ccccc1)c1cc2c(cc1F)COB2O] | | | | |
| 162 | 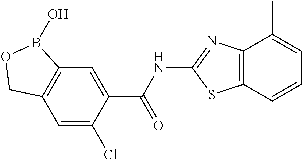 [SMILES: Cc1cccc2sc(NC(=O)c3cc4c(cc3Cl)COB4O)nc12] | | | | |
| 163 | 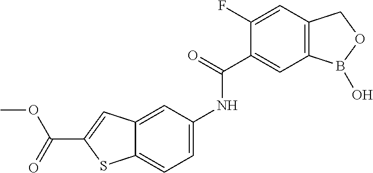 [SMILES: COC(=O)c1cc2cc(NC(=O)c3cc4c(cc3F)COB4O)ccc2s1] | | | | |
| 164 | 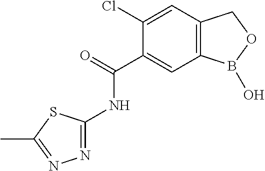 [SMILES: Cc1nnc(NC(=O)c2cc3c(cc2Cl)COB3O)s1] | | | | |
| 165 | 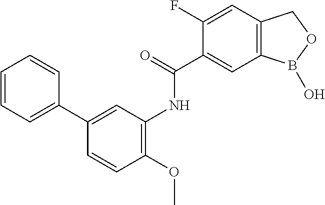 [SMILES: COc1ccc(-c2ccccc2)cc1NC(=O)c1cc2c(cc1F)COB2O] | | | | |
| 166 | 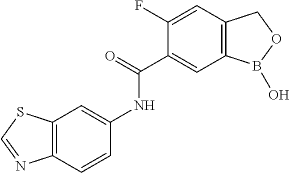 [SMILES: O=C(Nc1ccc2ncsc2c1)c1cc2c(cc1F)COB2O] | | | | |
| 167 | 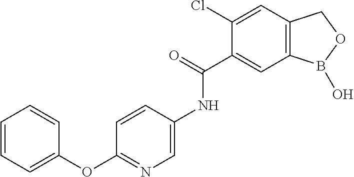 [SMILES: O=C(Nc1ccc(Oc2ccccc2)nc1)c1cc2c(cc1Cl)COB2O] | | | | |
| 168 | 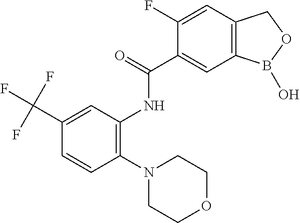 [SMILES: O=C(Nc1cc(C(F)(F)F)ccc1N1CCOCC1)c1cc2c(cc1F)COB2O] | | | | |
| 169 | 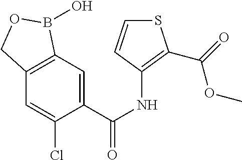 [SMILES: COC(=O)c1sccc1NC(=O)c1cc2c(cc1Cl)COB2O] | | | | 267-269 |
| 170 | 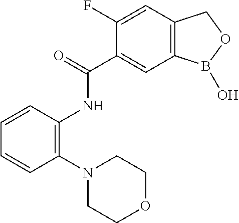 [SMILES: O=C(Nc1ccccc1N1CCOCC1)c1cc2c(cc1F)COB2O] | | | | |
| 171 | 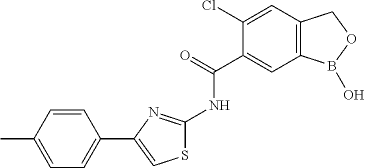 [SMILES: Cc1ccc(-c2csc(NC(=O)c3cc4c(cc3Cl)COB4O)n2)cc1] | | | | |
| 172 | 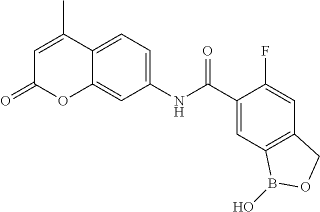 [SMILES: Cc1cc(=O)oc2cc(NC(=O)c3cc4c(cc3F)COB4O)ccc12] | | | | |
| 173 | 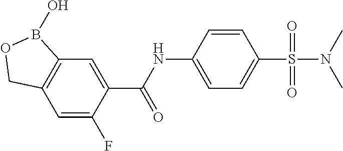 [SMILES: CN(C)S(=O)(=O)c1ccc(NC(=O)c2cc3c(cc2F)COB3O)cc1] | | | | |
| 174 | 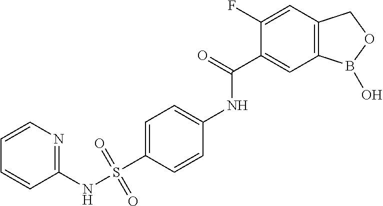 [SMILES: O=C(Nc1ccc(S(=O)(=O)Nc2ccccn2)cc1)c1cc2c(cc1F)COB2O] | | | | |
| 175 | 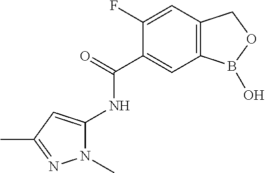 [SMILES: Cc1cc(NC(=O)c2cc3c(cc2F)COB3O)n(C)n1] | | | | |
| 176 | 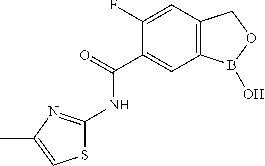 [SMILES: Cc1csc(NC(=O)c2cc3c(cc2F)COB3O)n1] | | | | |
| 177 | 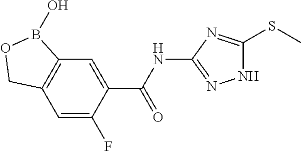 [SMILES: CSc1nc(NC(=O)c2cc3c(cc2F)COB3O)n[nH]1] | | | | |
| 178 | 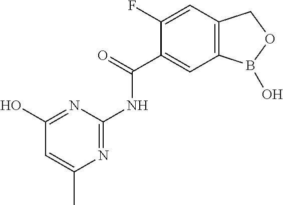 [SMILES: Cc1cc(O)nc(NC(=O)c2cc3c(cc2F)COB3O)n1] | | | | |
| 179 | 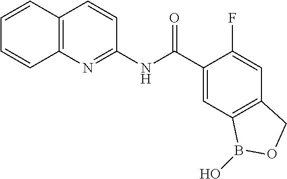 [SMILES: O=C(Nc1ccc2ccccc2n1)c1cc2c(cc1F)COB2O] | | | | |
| 180 | 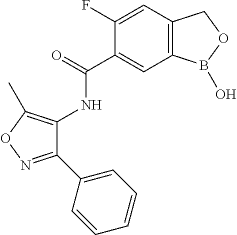 [SMILES: Cc1onc(-c2ccccc2)c1NC(=O)c1cc2c(cc1F)COB2O] | | | | |
| 181 | 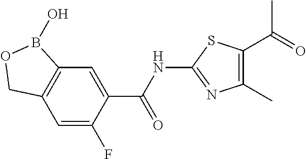 [SMILES: CC(=O)c1sc(NC(=O)c2cc3c(cc2F)COB3O)nc1C] | | | | |
| 182 | 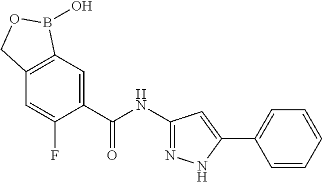 [SMILES: O=C(Nc1cc(-c2ccccc2)[nH]n1)c1cc2c(cc1F)COB2O] | | | | |
| 183 | 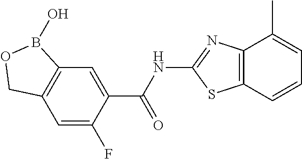 [SMILES: Cc1cccc2sc(NC(=O)c3cc4c(cc3F)COB4O)nc12] | | | | |
| 184 | 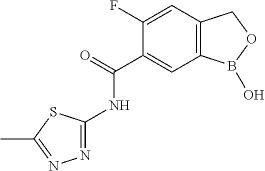 [SMILES: Cc1nnc(NC(=O)c2cc3c(cc2F)COB3O)s1] | | | | |
| 185 | 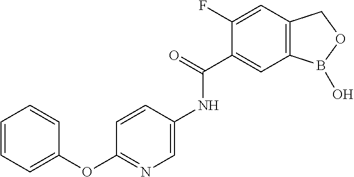 [SMILES: O=C(Nc1ccc(Oc2ccccc2)nc1)c1cc2c(cc1F)COB2O] | | | | |
| 186 | 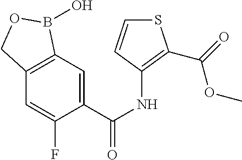 [SMILES: COC(=O)c1sccc1NC(=O)c1cc2c(cc1F)COB2O] | | | | 302-304 |
| 187 | 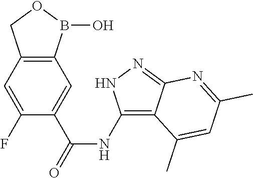 [SMILES: Cc1cc(C)c2c(NC(=O)c3cc4c(cc3F)COB4O)[nH]nc2n1] | | | | |
| 188 | 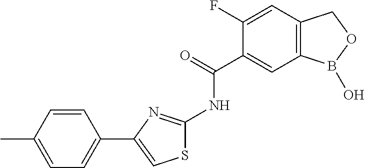 [SMILES: Cc1ccc(-c2csc(NC(=O)c3cc4c(cc3F)COB4O)n2)cc1] | | | | |
| 189 | 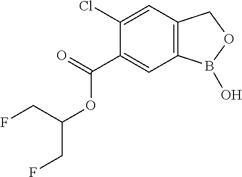 [SMILES: O=C(OC(CF)CF)c1cc2c(cc1Cl)COB2O] | | | | |
| 190 | 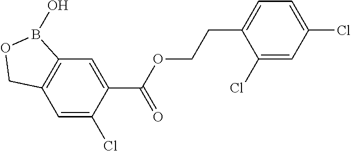 [SMILES: O=C(OCCc1ccc(Cl)cc1Cl)c1cc2c(cc1Cl)COB2O] | | | | |
| 191 | 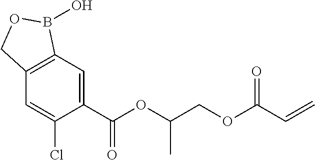 [SMILES: C=CC(=O)OCC(C)OC(=O)c1cc2c(cc1Cl)COB2O] | | | | |
| 192 | 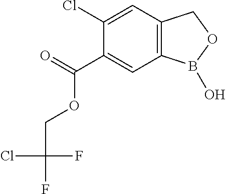 [SMILES: O=C(OCC(F)(F)Cl)c1cc2c(cc1Cl)COB2O] | | | | |
| 193 | 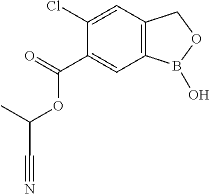 [SMILES: CC(C#N)OC(=O)c1cc2c(cc1Cl)COB2O] | | | | |
| 194 | 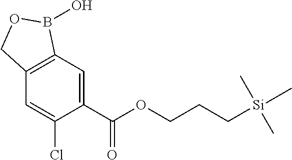 [SMILES: C[Si](C)(C)CCCOC(=O)c1cc2c(cc1Cl)COB2O] | | | | |
| 195 | 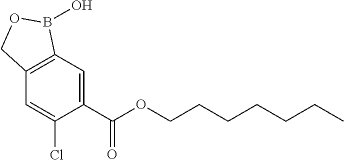 [SMILES: CCCCCCCOC(=O)c1cc2c(cc1Cl)COB2O] | | | | |
| 196 | 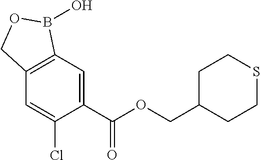 [SMILES: O=C(OCC1CCSCC1)c1cc2c(cc1Cl)COB2O] | | | | |
| 197 | 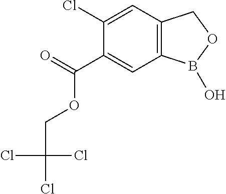 [SMILES: O=C(OCC(Cl)(Cl)Cl)c1cc2c(cc1Cl)COB2O] | | | | |
| 198 | 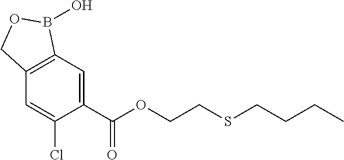 [SMILES: CCCCSCCOC(=O)c1cc2c(cc1Cl)COB2O] | | | | |
| 199 | 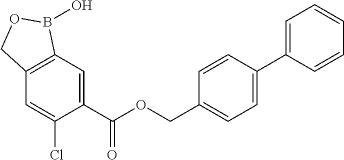 [SMILES: O=C(OCc1ccc(-c2ccccc2)cc1)c1cc2c(cc1Cl)COB2O] | | | | |
| 200 | 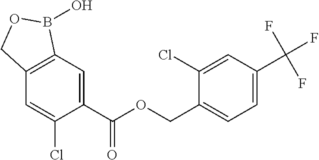 [SMILES: O=C(OCc1ccc(C(F)(F)F)cc1Cl)c1cc2c(cc1Cl)COB2O] | | | | |
| 201 | 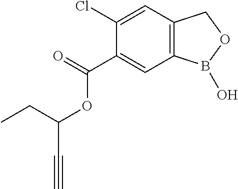 [SMILES: C#CC(CC)OC(=O)c1cc2c(cc1Cl)COB2O] | | | | |
| 202 | 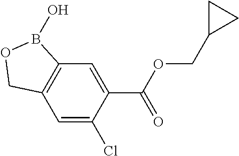 [SMILES: O=C(OCC1CC1)c1cc2c(cc1Cl)COB2O] | | | | |
| 203 | 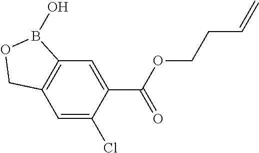 [SMILES: C=CCCOC(=O)c1cc2c(cc1Cl)COB2O] | | | | |
| 204 | 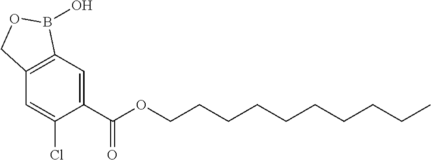 [SMILES: CCCCCCCCCCOC(=O)c1cc2c(cc1Cl)COB2O] | | | | |
| 205 | 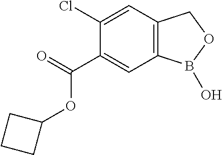 [SMILES: O=C(OC1CCC1)c1cc2c(cc1Cl)COB2O] | | | | |
| 206 | 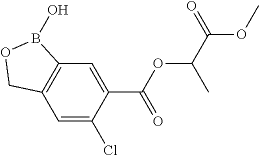 [SMILES: COC(=O)C(C)OC(=O)c1cc2c(cc1Cl)COB2O] | | | | |
| 207 | 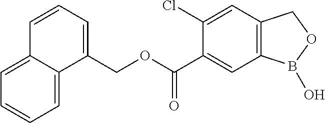 [SMILES: O=C(OCc1cccc2ccccc12)c1cc2c(cc1Cl)COB2O] | | | | |
| 208 | 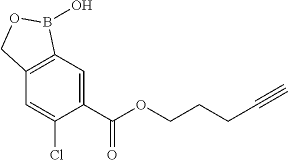 [SMILES: C#CCCCOC(=O)c1cc2c(cc1Cl)COB2O] | | | | |
| 209 | 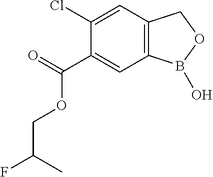 [SMILES: CC(F)COC(=O)c1cc2c(cc1Cl)COB2O] | | | | |
| 210 | 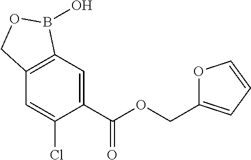 [SMILES: O=C(OCc1ccco1)c1cc2c(cc1Cl)COB2O] | | | | |
| 211 | 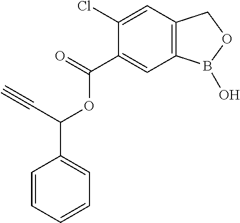 [SMILES: C#CC(OC(=O)c1cc2c(cc1Cl)COB2O)c1ccccc1] | | | | |
| 212 | 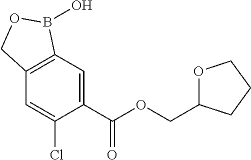 [SMILES: O=C(OCC1CCCO1)c1cc2c(cc1Cl)COB2O] | | | | |
| 213 | 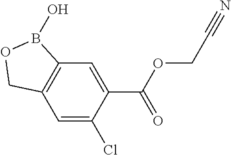 [SMILES: N#CCOC(=O)c1cc2c(cc1Cl)COB2O] | | | | |
| 214 | 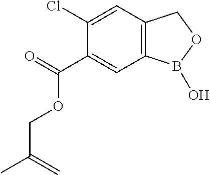 [SMILES: C=C(C)COC(=O)c1cc2c(cc1Cl)COB2O] | | | | |
| 215 | 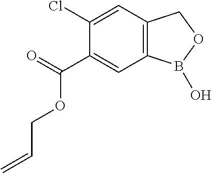 [SMILES: C=CCOC(=O)c1cc2c(cc1Cl)COB2O] | | | | |
| 216 | 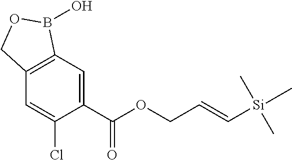 [SMILES: C[Si](C)(C)/C=C/COC(=O)c1cc2c(cc1Cl)COB2O] | | | | |
| 217 | 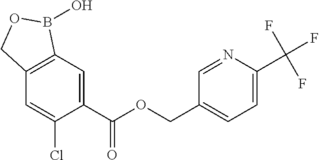 [SMILES: O=C(OCc1ccc(C(F)(F)F)nc1)c1cc2c(cc1Cl)COB2O] | | | | |
| 218 | 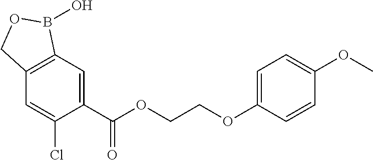 [SMILES: COc1ccc(OCCOC(=O)c2cc3c(cc2Cl)COB3O)cc1] | | | | |
| 219 | 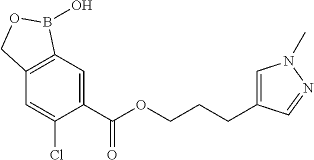 [SMILES: Cn1cc(CCCOC(=O)c2cc3c(cc2Cl)COB3O)cn1] | | | | |
| 220 | 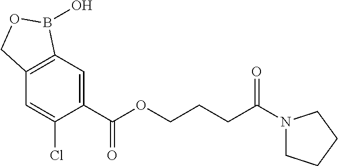 [SMILES: O=C(OCCCC(=O)N1CCCC1)c1cc2c(cc1Cl)COB2O] | | | | |
| 221 | 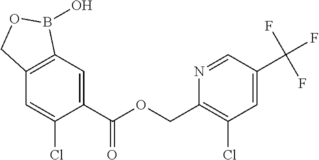 [SMILES: O=C(OCc1ncc(C(F)(F)F)cc1Cl)c1cc2c(cc1Cl)COB2O] | | | | |
| 222 | 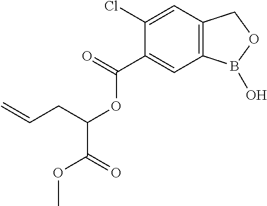 [SMILES: C=CCC(OC(=O)c1cc2c(cc1Cl)COB2O)C(=O)OC] | | | | |
| 223 | 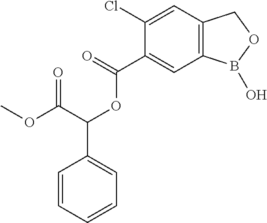 [SMILES: COC(=O)C(OC(=O)c1cc2c(cc1Cl)COB2O)c1ccccc1] | | | | |
| 224 | 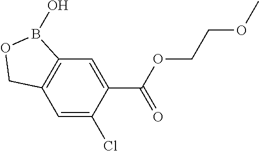 [SMILES: COCCOC(=O)c1cc2c(cc1Cl)COB2O] | | | | |
| 225 | 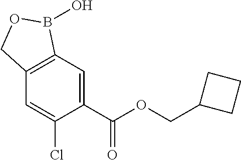 [SMILES: O=C(OCC1CCC1)c1cc2c(cc1Cl)COB2O] | | | | 115-117 |
| 226 | 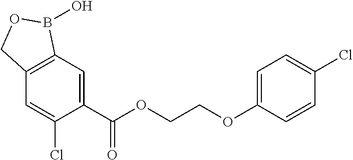 [SMILES: O=C(OCCOc1ccc(Cl)cc1)c1cc2c(cc1Cl)COB2O] | | | | |
| 227 | 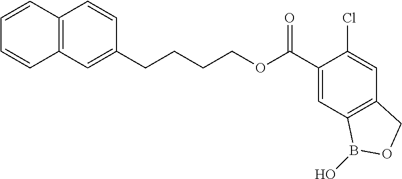 [SMILES: O=C(OCCCCc1ccc2ccccc2c1)c1cc2c(cc1Cl)COB2O] | | | | |
| 228 | 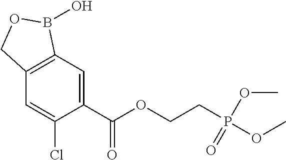 [SMILES: COP(=O)(CCOC(=O)c1cc2c(cc1Cl)COB2O)OC] | | | | |
| 229 | 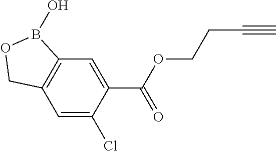 [SMILES: C#CCCOC(=O)c1cc2c(cc1Cl)COB2O] | | | | |
| 230 | 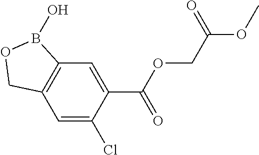 [SMILES: COC(=O)COC(=O)c1cc2c(cc1Cl)COB2O] | | | | |
| 231 | 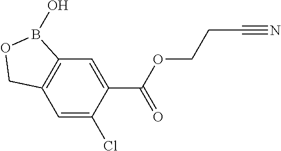 [SMILES: N#CCCOC(=O)c1cc2c(cc1Cl)COB2O] | | | | |
| 232 | 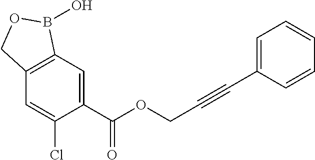 [SMILES: O=C(OCC#Cc1ccccc1)c1cc2c(cc1Cl)COB2O] | | | | |
| 233 | 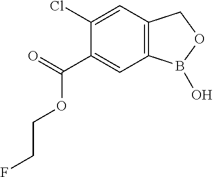 [SMILES: O=C(OCCF)c1cc2c(cc1Cl)COB2O] | | | | |
| 234 | 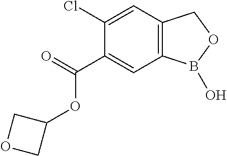 [SMILES: O=C(OC1COC1)c1cc2c(cc1Cl)COB2O] | | | | |
| 235 | 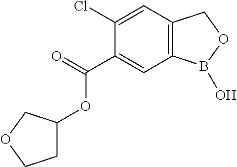 [SMILES: O=C(OC1CCOC1)c1cc2c(cc1Cl)COB2O] | | | | |
| 236 | 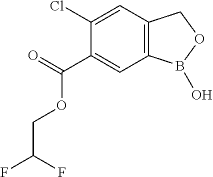 [SMILES: O=C(OCC(F)F)c1cc2c(cc1Cl)COB2O] | | | | |
| 237 | 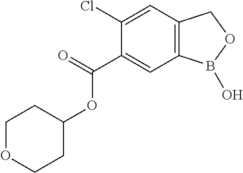 [SMILES: O=C(OC1CCOCC1)c1cc2c(cc1Cl)COB2O] | | | | |
| 238 | 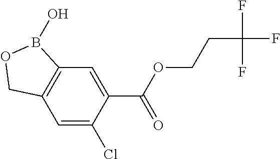 [SMILES: O=C(OCCC(F)(F)F)c1cc2c(cc1Cl)COB2O] | | | | |
| 239 | 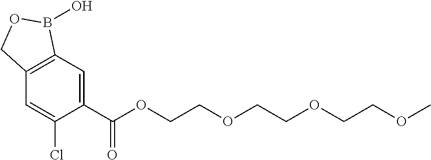 [SMILES: COCCOCCOCCOC(=O)c1cc2c(cc1Cl)COB2O] | | | | |
| 240 | 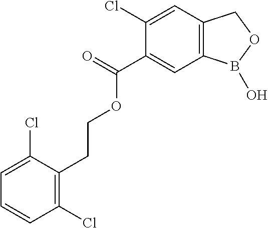 [SMILES: O=C(OCCc1c(Cl)cccc1Cl)c1cc2c(cc1Cl)COB2O] | | | | |
| 241 | 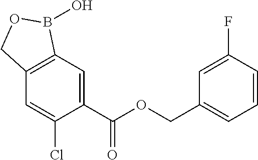 [SMILES: O=C(OCc1cccc(F)c1)c1cc2c(cc1Cl)COB2O] | | | | |
| 242 | 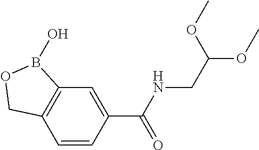 [SMILES: COC(CNC(=O)c1ccc2c(c1)B(O)OC2)OC] | | | | 148-150 |
| 243 | 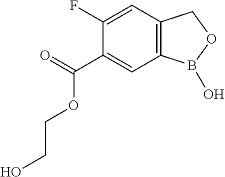 [SMILES: O=C(OCCO)c1cc2c(cc1F)COB2O] | | | | 274-276 |
| 244 | 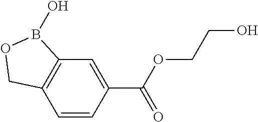 [SMILES: O=C(OCCO)c1ccc2c(c1)B(O)OC2] | | | | 122-124 |
| 245 | 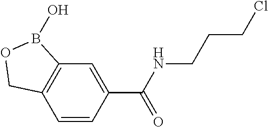 [SMILES: O=C(NCCCCl)c1ccc2c(c1)B(O)OC2] | | | | |
| 246 | 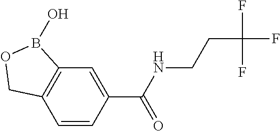 [SMILES: O=C(NCCC(F)(F)F)c1ccc2c(c1)B(O)OC2] | | | | |
| 247 | 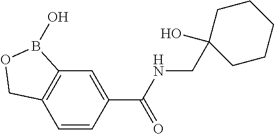 [SMILES: O=C(NCC1(O)CCCCC1)c1ccc2c(c1)B(O)OC2] | | | | |
| 248 | 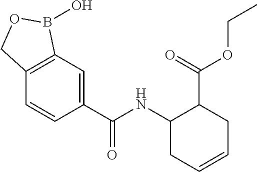 [SMILES: CCOC(=O)C1CC=CCC1NC(=O)c1ccc2c(c1)B(O)OC2] | | | | |
| 249 | 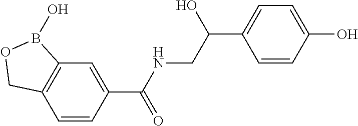 [SMILES: O=C(NCC(O)c1ccc(O)cc1)c1ccc2c(c1)B(O)OC2] | | | | |
| 250 | 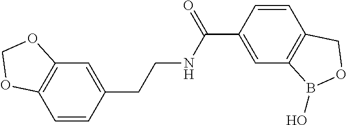 [SMILES: O=C(NCCc1ccc2c(c1)OCO2)c1ccc2c(c1)B(O)OC2] | | | | |
| 251 | 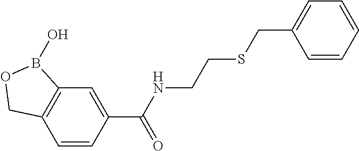 [SMILES: O=C(NCCSCc1ccccc1)c1ccc2c(c1)B(O)OC2] | | | | |
| 252 | 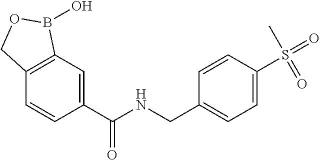 [SMILES: CS(=O)(=O)c1ccc(CNC(=O)c2ccc3c(c2)B(O)OC3)cc1] | | | | |
| 253 | 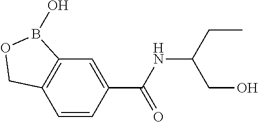 [SMILES: CCC(CO)NC(=O)c1ccc2c(c1)B(O)OC2] | | | | |
| 254 | 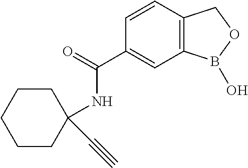 [SMILES: C#CC1(NC(=O)c2ccc3c(c2)B(O)OC3)CCCCC1] | | | | |
| 255 | 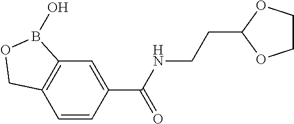 [SMILES: O=C(NCCC1OCCO1)c1ccc2c(c1)B(O)OC2] | | | | |
| 256 | 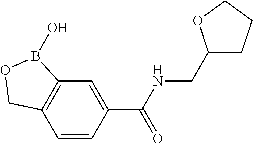 [SMILES: O=C(NCC1CCCO1)c1ccc2c(c1)B(O)OC2] | | | | |
| 257 | 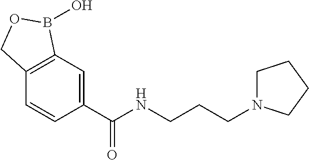 [SMILES: O=C(NCCCN1CCCC1)c1ccc2c(c1)B(O)OC2] | | | | |
| 258 | 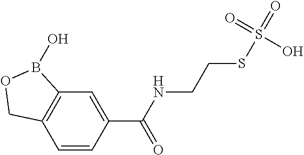 [SMILES: O=C(NCCSS(=O)(=O)O)c1ccc2c(c1)B(O)OC2] | | | | |
| 259 | 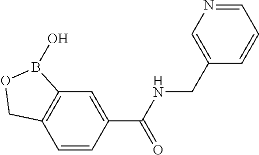 [SMILES: O=C(NCc1cccnc1)c1ccc2c(c1)B(O)OC2] | | | | |
| 260 | 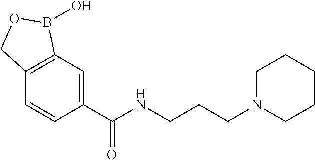 [SMILES: O=C(NCCCN1CCCCC1)c1ccc2c(c1)B(O)OC2] | | | | |
| 261 | 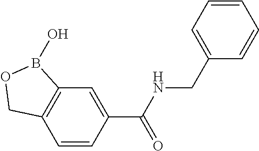 [SMILES: O=C(NCc1ccccc1)c1ccc2c(c1)B(O)OC2] | | | | |
| 262 | 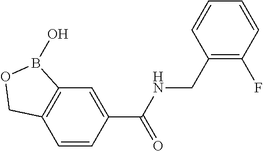 [SMILES: O=C(NCc1ccccc1F)c1ccc2c(c1)B(O)OC2] | | | | |
| 263 | 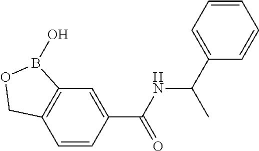 [SMILES: CC(NC(=O)c1ccc2c(c1)B(O)OC2)c1ccccc1] | | | | |
| 264 | 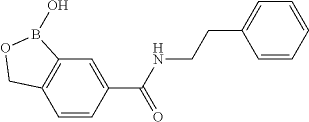 [SMILES: O=C(NCCc1ccccc1)c1ccc2c(c1)B(O)OC2] | | | | |
| 265 | 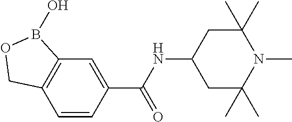 [SMILES: CN1C(C)(C)CC(NC(=O)c2ccc3c(c2)B(O)OC3)CC1(C)C] | | | | |
| 266 | 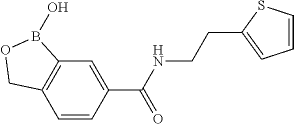 [SMILES: O=C(NCCc1cccs1)c1ccc2c(c1)B(O)OC2] | | | | |
| 267 | 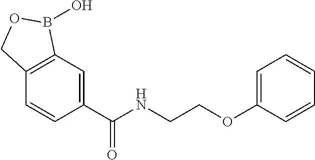 [SMILES: O=C(NCCOc1ccccc1)c1ccc2c(c1)B(O)OC2] | | | | |
| 268 | 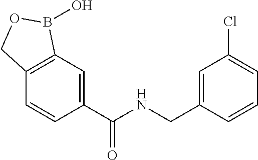 [SMILES: O=C(NCc1cccc(Cl)c1)c1ccc2c(c1)B(O)OC2] | | | | |
| 269 | 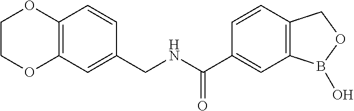 [SMILES: O=C(NCc1ccc2c(c1)OCCO2)c1ccc2c(c1)B(O)OC2] | | | | |
| 270 | 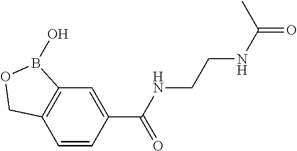 [SMILES: CC(=O)NCCNC(=O)c1ccc2c(c1)B(O)OC2] | | | | |
| 271 | 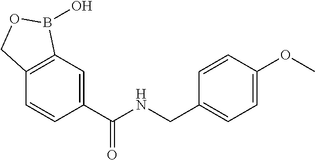 [SMILES: COc1ccc(CNC(=O)c2ccc3c(c2)B(O)OC3)cc1] | | | | |
| 272 | 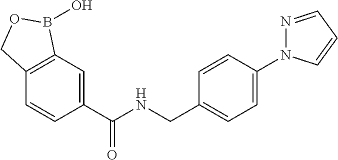 [SMILES: O=C(NCc1ccc(-n2cccn2)cc1)c1ccc2c(c1)B(O)OC2] | | | | |
| 273 | 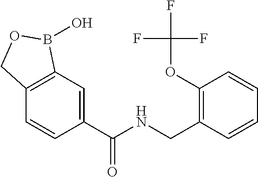 [SMILES: O=C(NCc1ccccc1OC(F)(F)F)c1ccc2c(c1)B(O)OC2] | | | | |
| 274 | 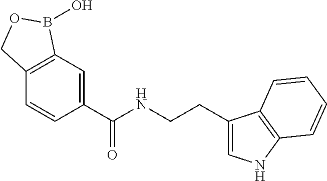 [SMILES: O=C(NCCc1c[nH]c2ccccc12)c1ccc2c(c1)B(O)OC2] | | | | |
| 275 | 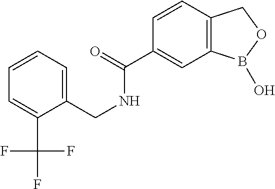 [SMILES: O=C(NCc1ccccc1C(F)(F)F)c1ccc2c(c1)B(O)OC2] | | | | |
| 276 | 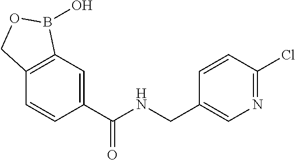 [SMILES: O=C(NCc1ccc(Cl)nc1)c1ccc2c(c1)B(O)OC2] | | | | |
| 277 | 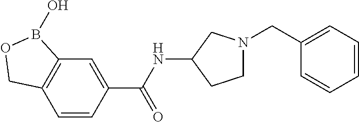 [SMILES: O=C(NC1CCN(Cc2ccccc2)C1)c1ccc2c(c1)B(O)OC2] | | | | |
| 278 | 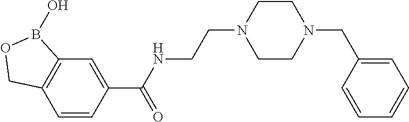 [SMILES: O=C(NCCN1CCN(Cc2ccccc2)CC1)c1ccc2c(c1)B(O)OC2] | | | | |
| 279 | 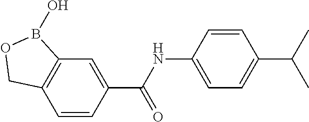 [SMILES: CC(C)c1ccc(NC(=O)c2ccc3c(c2)B(O)OC3)cc1] | | | | |
| 280 | 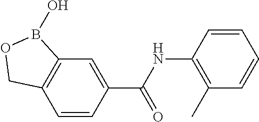 [SMILES: Cc1ccccc1NC(=O)c1ccc2c(c1)B(O)OC2] | | | | |
| 281 | 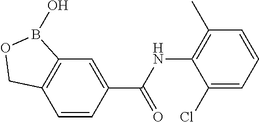 [SMILES: Cc1cccc(Cl)c1NC(=O)c1ccc2c(c1)B(O)OC2] | | | | |
| 282 | 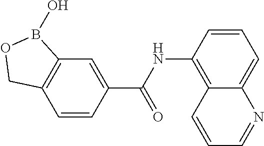 [SMILES: O=C(Nc1cccc2ncccc12)c1ccc2c(c1)B(O)OC2] | | | | |
| 283 | 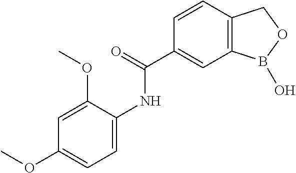 [SMILES: COc1ccc(NC(=O)c2ccc3c(c2)B(O)OC3)c(OC)c1] | | | | |
| 284 | 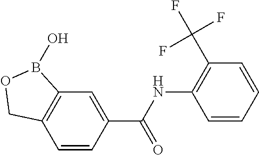 [SMILES: O=C(Nc1ccccc1C(F)(F)F)c1ccc2c(c1)B(O)OC2] | | | | |
| 285 | 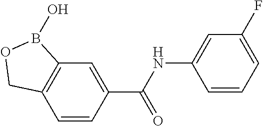 [SMILES: O=C(Nc1cccc(F)c1)c1ccc2c(c1)B(O)OC2] | | | | |
| 286 | 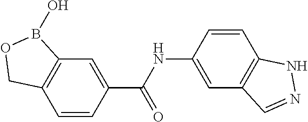 [SMILES: O=C(Nc1ccc2[nH]ncc2c1)c1ccc2c(c1)B(O)OC2] | | | | |
| 287 | 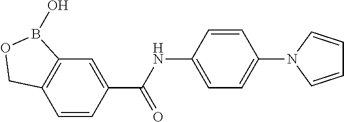 [SMILES: O=C(Nc1ccc(-n2cccc2)cc1)c1ccc2c(c1)B(O)OC2] | | | | |
| 288 | 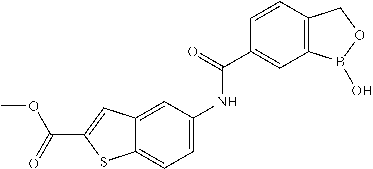 [SMILES: COC(=O)c1cc2cc(NC(=O)c3ccc4c(c3)B(O)OC4)ccc2s1] | | | | |
| 289 | 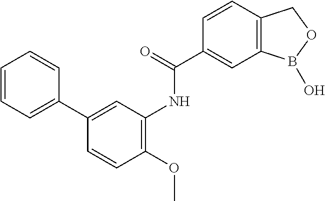 [SMILES: COc1ccc(-c2ccccc2)cc1NC(=O)c1ccc2c(c1)B(O)OC2] | | | | |
| 290 | 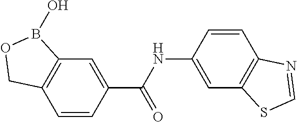 [SMILES: O=C(Nc1ccc2ncsc2c1)c1ccc2c(c1)B(O)OC2] | | | | |
| 291 | 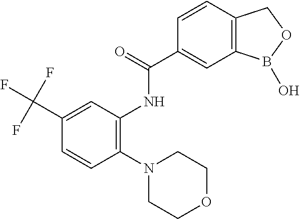 [SMILES: O=C(Nc1cc(C(F)(F)F)ccc1N1CCOCC1)c1ccc2c(c1)B(O)OC2] | | | | |
| 292 | 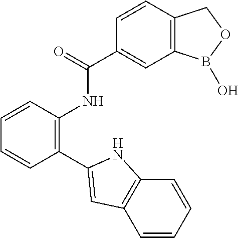 [SMILES: O=C(Nc1ccccc1-c1cc2ccccc2[nH]1)c1ccc2c(c1)B(O)OC2] | | | | |
| 293 | 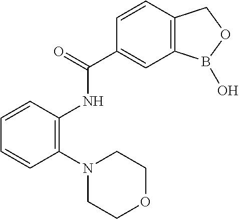 [SMILES: O=C(Nc1ccccc1N1CCOCC1)c1ccc2c(c1)B(O)OC2] | | | | |
| 294 | 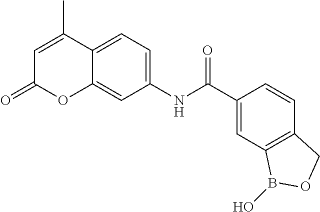 [SMILES: Cc1cc(=O)oc2cc(NC(=O)c3ccc4c(c3)B(O)OC4)ccc12] | | | | |
| 295 | 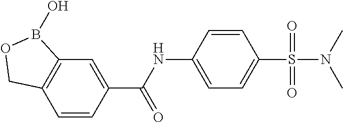 [SMILES: CN(C)S(=O)(=O)c1ccc(NC(=O)c2ccc3c(c2)B(O)OC3)cc1] | | | | |
| 296 | 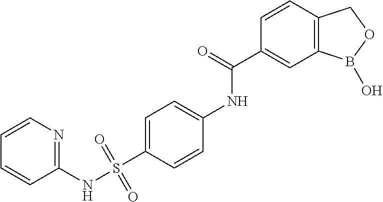 [SMILES: O=C(Nc1ccc(S(=O)(=O)Nc2ccccn2)cc1)c1ccc2c(c1)B(O)OC2] | | | | |
| 297 | 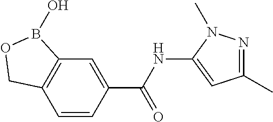 [SMILES: Cc1cc(NC(=O)c2ccc3c(c2)B(O)OC3)n(C)n1] | | | | |
| 298 | 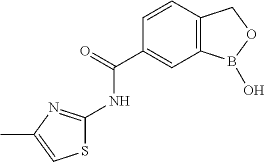 [SMILES: Cc1csc(NC(=O)c2ccc3c(c2)B(O)OC3)n1] | | | | |
| 299 | 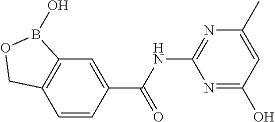 [SMILES: Cc1cc(O)nc(NC(=O)c2ccc3c(c2)B(O)OC3)n1] | | | | |
| 300 | 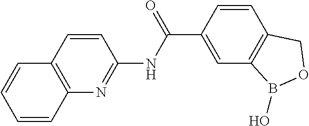 [SMILES: O=C(Nc1ccc2ccccc2n1)c1ccc2c(c1)B(O)OC2] | | | | |
| 301 | 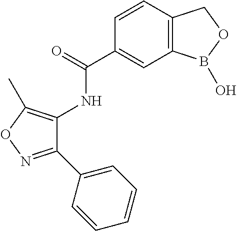 [SMILES: Cc1onc(-c2ccccc2)c1NC(=O)c1ccc2c(c1)B(O)OC2] | | | | |
| 302 | 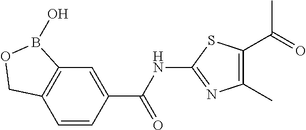 [SMILES: CC(=O)c1sc(NC(=O)c2ccc3c(c2)B(O)OC3)nc1C] | | | | |
| 303 | 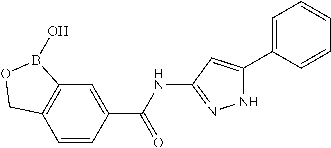 [SMILES: O=C(Nc1cc(-c2ccccc2)[nH]n1)c1ccc2c(c1)B(O)OC2] | | | | |
| 304 | 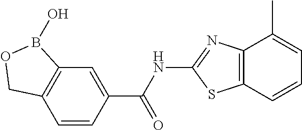 [SMILES: Cc1cccc2sc(NC(=O)c3ccc4c(c3)B(O)OC4)nc12] | | | | |
| 305 | 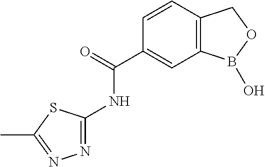 [SMILES: Cc1nnc(NC(=O)c2ccc3c(c2)B(O)OC3)s1] | | | | |
| 306 | 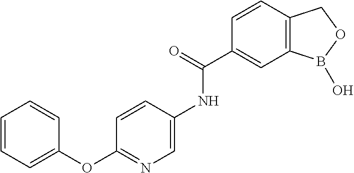 [SMILES: O=C(Nc1ccc(Oc2ccccc2)nc1)c1ccc2c(c1)B(O)OC2] | | | | |
| 307 | 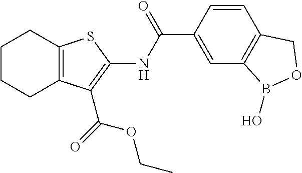 [SMILES: CCOC(=O)c1c(NC(=O)c2ccc3c(c2)B(O)OC3)sc2c1CCCC2] | | | | |
| 308 | 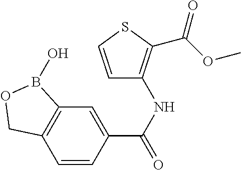 [SMILES: COC(=O)c1sccc1NC(=O)c1ccc2c(c1)B(O)OC2] | | | | |
| 309 | 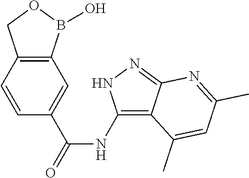 [SMILES: Cc1cc(C)c2c(NC(=O)c3ccc4c(c3)B(O)OC4)[nH]nc2n1] | | | | |
| 310 | 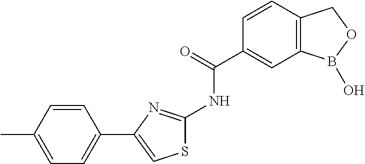 [SMILES: Cc1ccc(-c2csc(NC(=O)c3ccc4c(c3)B(O)OC4)n2)cc1] | | | | |
| 311 | 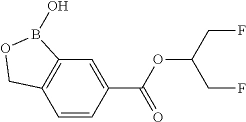 [SMILES: O=C(OC(CF)CF)c1ccc2c(c1)B(O)OC2] | | | | |
| 312 | 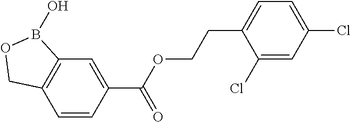 [SMILES: O=C(OCCc1ccc(Cl)cc1Cl)c1ccc2c(c1)B(O)OC2] | | | | |
| 313 | 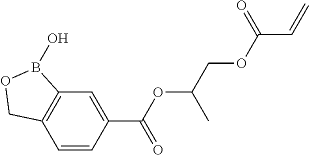 [SMILES: C=CC(=O)OCC(C)OC(=O)c1ccc2c(c1)B(O)OC2] | | | | |
| 314 | 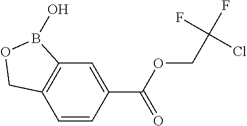 [SMILES: O=C(OCC(F)(F)Cl)c1ccc2c(c1)B(O)OC2] | | | | |
| 315 | 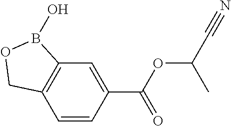 [SMILES: CC(C#N)OC(=O)c1ccc2c(c1)B(O)OC2] | | | | |
| 316 | 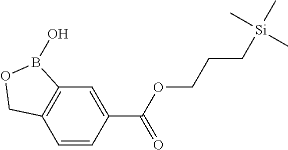 [SMILES: C[Si](C)(C)CCCOC(=O)c1ccc2c(c1)B(O)OC2] | | | | |
| 317 | 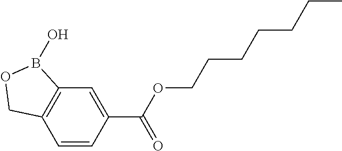 [SMILES: CCCCCCCOC(=O)c1ccc2c(c1)B(O)OC2] | | | | |
| 318 | 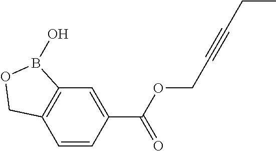 [SMILES: CCC#CCOC(=O)c1ccc2c(c1)B(O)OC2] | | | | |
| 319 | 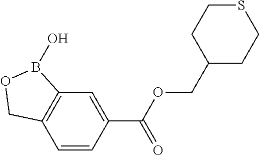 [SMILES: O=C(OCC1CCSCC1)c1ccc2c(c1)B(O)OC2] | | | | |
| 320 | 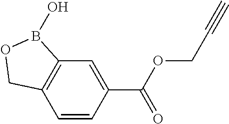 [SMILES: C#CCOC(=O)c1ccc2c(c1)B(O)OC2] | | | | |
| 321 | 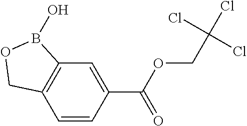 [SMILES: O=C(OCC(Cl)(Cl)Cl)c1ccc2c(c1)B(O)OC2] | | | | |
| 322 | 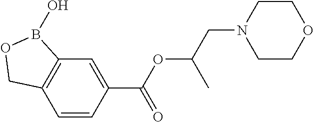 [SMILES: CC(CN1CCOCC1)OC(=O)c1ccc2c(c1)B(O)OC2] | | | | |
| 323 | 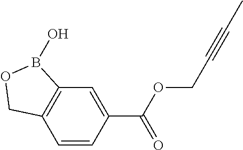 [SMILES: CC#CCOC(=O)c1ccc2c(c1)B(O)OC2] | | | | 154-155 |
| 324 | 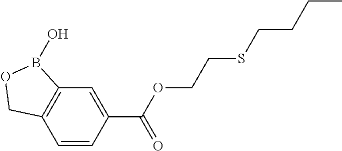 [SMILES: CCCCSCCOC(=O)c1ccc2c(c1)B(O)OC2] | | | | |
| 325 | 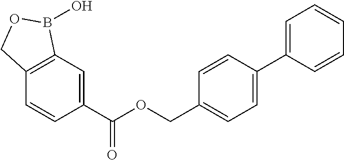 [SMILES: O=C(OCc1ccc(-c2ccccc2)cc1)c1ccc2c(c1)B(O)OC2] | | | | |
| 326 | 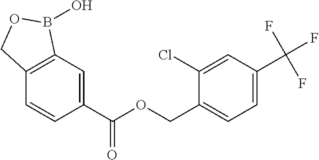 [SMILES: O=C(OCc1ccc(C(F)(F)F)cc1Cl)c1ccc2c(c1)B(O)OC2] | | | | |
| 327 | 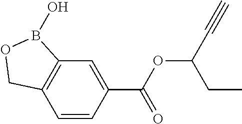 [SMILES: C#CC(CC)OC(=O)c1ccc2c(c1)B(O)OC2] | | | | |
| 328 | 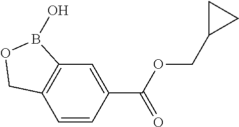 [SMILES: O=C(OCC1CC1)c1ccc2c(c1)B(O)OC2] | | | | |
| 329 | 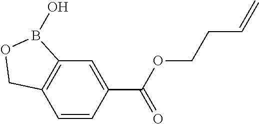 [SMILES: C=CCCOC(=O)c1ccc2c(c1)B(O)OC2] | | | | |
| 330 | 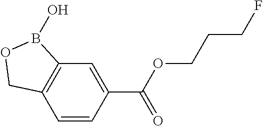 [SMILES: O=C(OCCCF)c1ccc2c(c1)B(O)OC2] | | | | |
| 331 | 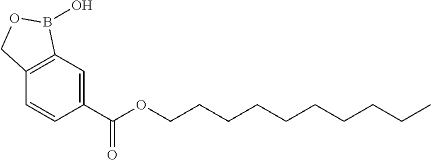 [SMILES: CCCCCCCCCCOC(=O)c1ccc2c(c1)B(O)OC2] | | | | |
| 332 | 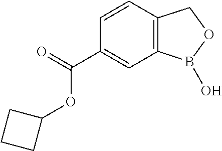 [SMILES: O=C(OC1CCC1)c1ccc2c(c1)B(O)OC2] | | | | |
| 333 | 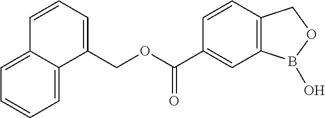 [SMILES: O=C(OCc1cccc2ccccc12)c1ccc2c(c1)B(O)OC2] | | | | |
| 334 | 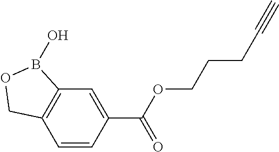 [SMILES: C#CCCCOC(=O)c1ccc2c(c1)B(O)OC2] | | | | |
| 335 | 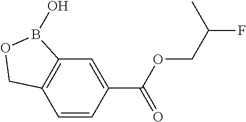 [SMILES: CC(F)COC(=O)c1ccc2c(c1)B(O)OC2] | | | | |
| 336 | 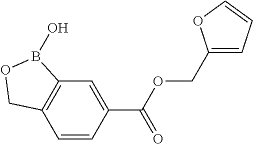 [SMILES: O=C(OCc1ccco1)c1ccc2c(c1)B(O)OC2] | | | | |
| 337 | 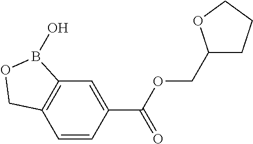 [SMILES: O=C(OCC1CCCO1)c1ccc2c(c1)B(O)OC2] | | | | |
| 338 | 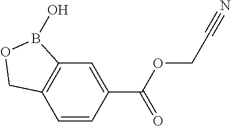 [SMILES: N#CCOC(=O)c1ccc2c(c1)B(O)OC2] | | | | |
| 339 | 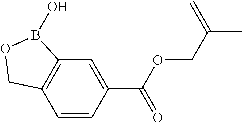 [SMILES: C=C(C)COC(=O)c1ccc2c(c1)B(O)OC2] | | | | |
| 340 | 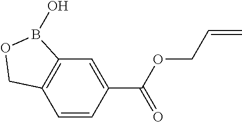 [SMILES: C=CCOC(=O)c1ccc2c(c1)B(O)OC2] | | | | |
| 341 | 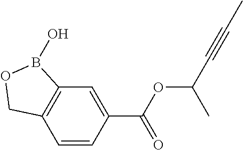 [SMILES: CC#CC(C)OC(=O)c1ccc2c(c1)B(O)OC2] | | | | |
| 342 | 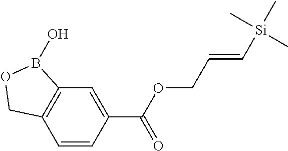 [SMILES: C[Si](C)(C)/C=C/COC(=O)c1ccc2c(c1)B(O)OC2] | | | | |
| 343 | 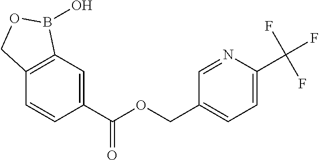 [SMILES: O=C(OCc1ccc(C(F)(F)F)nc1)c1ccc2c(c1)B(O)OC2] | | | | |
| 344 | 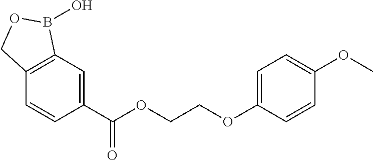 [SMILES: COc1ccc(OCCOC(=O)c2ccc3c(c2)B(O)OC3)cc1] | | | | |
| 345 | 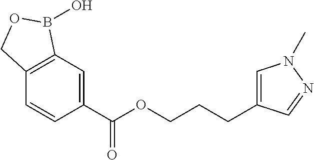 [SMILES: Cn1cc(CCCOC(=O)c2ccc3c(c2)B(O)OC3)cn1] | | | | |
| 346 | 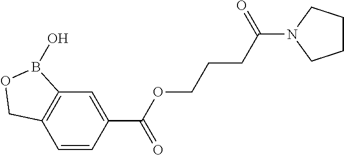 [SMILES: O=C(OCCCC(=O)N1CCCC1)c1ccc2c(c1)B(O)OC2] | | | | |
| 347 | 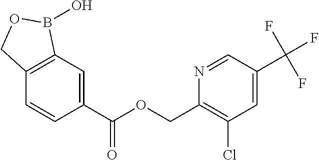 [SMILES: O=C(OCc1ncc(C(F)(F)F)cc1Cl)c1ccc2c(c1)B(O)OC2] | | | | |
| 348 | 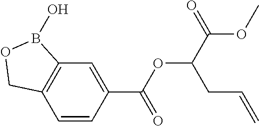 [SMILES: C=CCC(OC(=O)c1ccc2c(c1)B(O)OC2)C(=O)OC] | | | | |
| 349 | 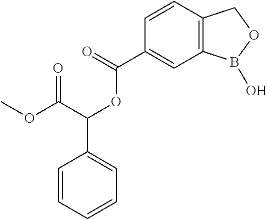 [SMILES: COC(=O)C(OC(=O)c1ccc2c(c1)B(O)OC2)c1ccccc1] | | | | |
| 350 | 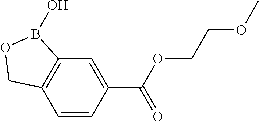 [SMILES: COCCOC(=O)c1ccc2c(c1)B(O)OC2] | | | | |
| 351 | 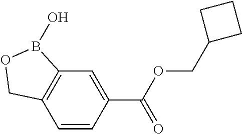 [SMILES: O=C(OCC1CCC1)c1ccc2c(c1)B(O)OC2] | | | | |
| 352 | 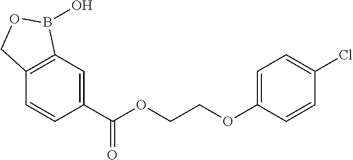 [SMILES: O=C(OCCOc1ccc(Cl)cc1)c1ccc2c(c1)B(O)OC2] | | | | 122-124 |
| 353 | 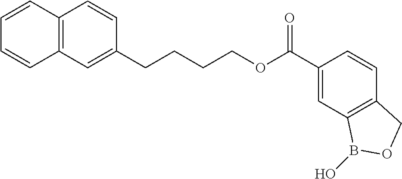 [SMILES: O=C(OCCCCc1ccc2ccccc2c1)c1ccc2c(c1)B(O)OC2] | | | | |
| 354 | 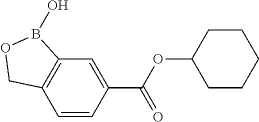 [SMILES: O=C(OC1CCCCC1)c1ccc2c(c1)B(O)OC2] | | | | |
| 355 | 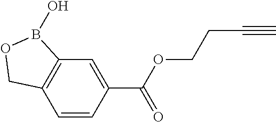 [SMILES: C#CCCOC(=O)c1ccc2c(c1)B(O)OC2] | | | | |
| 356 | 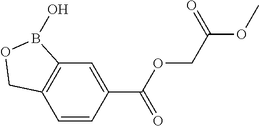 [SMILES: COC(=O)COC(=O)c1ccc2c(c1)B(O)OC2] | | | | |
| 357 | 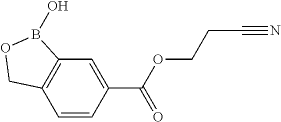 [SMILES: N#CCCOC(=O)c1ccc2c(c1)B(O)OC2] | | | | |
| 358 | 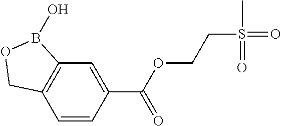 [SMILES: CS(=O)(=O)CCOC(=O)c1ccc2c(c1)B(O)OC2] | | | | |
| 359 | 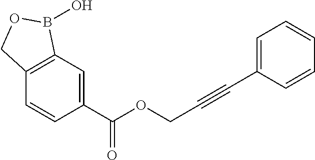 [SMILES: O=C(OCC#Cc1ccccc1)c1ccc2c(c1)B(O)OC2] | | | | |
| 360 | 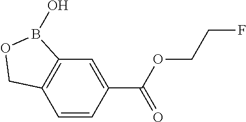 [SMILES: O=C(OCCF)c1ccc2c(c1)B(O)OC2] | | | | |
| 361 | 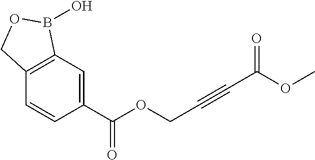 [SMILES: COC(=O)C#CCOC(=O)c1ccc2c(c1)B(O)OC2] | | | | |
| 362 | 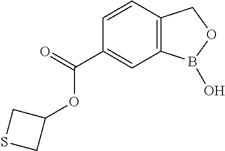 [SMILES: O=C(OC1CSC1)c1ccc2c(c1)B(O)OC2] | | | | |
| 363 | 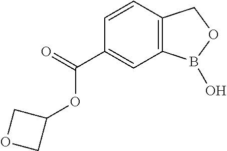 [SMILES: O=C(OC1COC1)c1ccc2c(c1)B(O)OC2] | | | | |
| 364 | 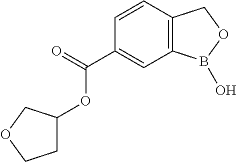 [SMILES: O=C(OC1CCOC1)c1ccc2c(c1)B(O)OC2] | | | | |
| 365 | 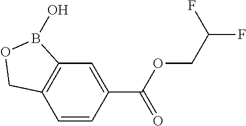 [SMILES: O=C(OCC(F)F)c1ccc2c(c1)B(O)OC2] | | | | |
| 366 | 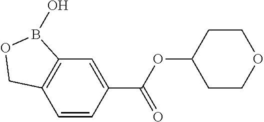 [SMILES: O=C(OC1CCOCC1)c1ccc2c(c1)B(O)OC2] | | | | |
| 367 | 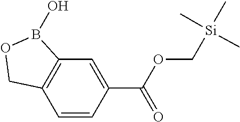 [SMILES: C[Si](C)(C)COC(=O)c1ccc2c(c1)B(O)OC2] | | | | |
| 368 | 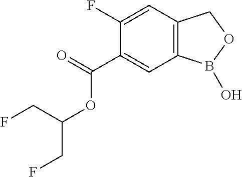 [SMILES: O=C(OC(CF)CF)c1cc2c(cc1F)COB2O] | | | | |
| 369 | 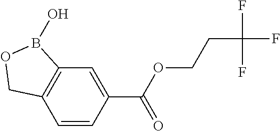 [SMILES: O=C(OCCC(F)(F)F)c1ccc2c(c1)B(O)OC2] | | | | |
| 370 | 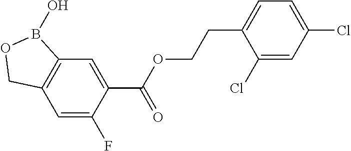 [SMILES: O=C(OCCc1ccc(Cl)cc1Cl)c1cc2c(cc1F)COB2O] | | | | |
| 371 | 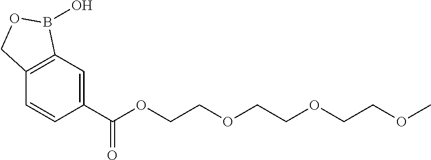 [SMILES: COCCOCCOCCOC(=O)c1ccc2c(c1)B(O)OC2] | | | | |
| 372 | 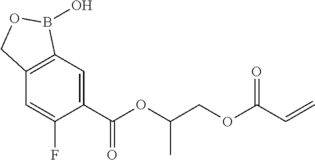 [SMILES: C=CC(=O)OCC(C)OC(=O)c1cc2c(cc1F)COB2O] | | | | |
| 373 | 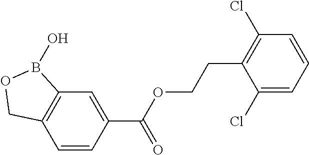 [SMILES: O=C(OCCc1c(Cl)cccc1Cl)c1ccc2c(c1)B(O)OC2] | | | | |
| 374 | 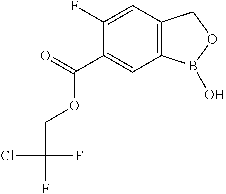 [SMILES: O=C(OCC(F)(F)Cl)c1cc2c(cc1F)COB2O] | | | | |
| 375 | 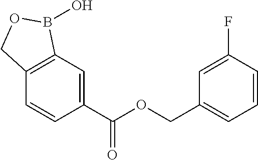 [SMILES: O=C(OCc1cccc(F)c1)c1ccc2c(c1)B(O)OC2] | | | | 125-127 |
| 376 | 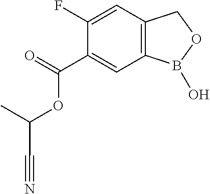 [SMILES: CC(C#N)OC(=O)c1cc2c(cc1F)COB2O] | | | | |
| 377 | 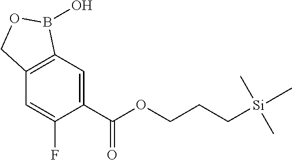 [SMILES: C[Si](C)(C)CCCOC(=O)c1cc2c(cc1F)COB2O] | | | | |
| 378 | 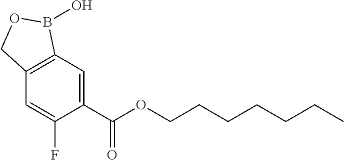 [SMILES: CCCCCCCOC(=O)c1cc2c(cc1F)COB2O] | | | | |
| 379 | 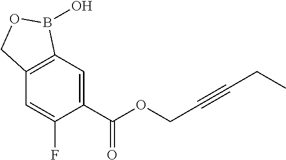 [SMILES: CCC#CCOC(=O)c1cc2c(cc1F)COB2O] | | | | |
| 380 | 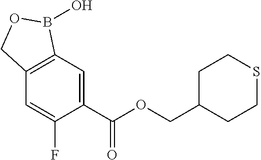 [SMILES: O=C(OCC1CCSCC1)c1cc2c(cc1F)COB2O] | | | | |
| 381 | 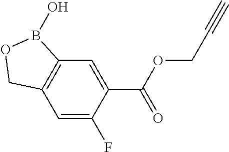 [SMILES: C#CCOC(=O)c1cc2c(cc1F)COB2O] | | | | |
| 382 | 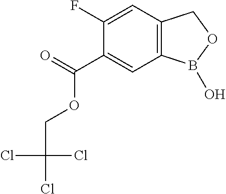 [SMILES: O=C(OCC(Cl)(Cl)Cl)c1cc2c(cc1F)COB2O] | | | | |
| 383 | 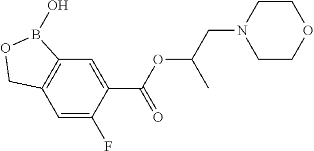 [SMILES: CC(CN1CCOCC1)OC(=O)c1cc2c(cc1F)COB2O] | | | | |
| 384 | 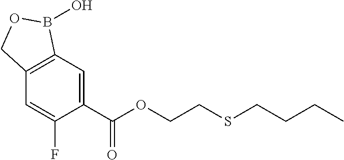 [SMILES: CCCCSCCOC(=O)c1cc2c(cc1F)COB2O] | | | | |
| 385 | 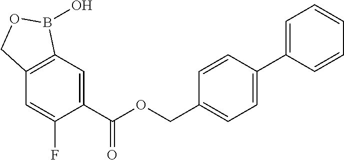 [SMILES: O=C(OCc1ccc(-c2ccccc2)cc1)c1cc2c(cc1F)COB2O] | | | | |
| 386 | 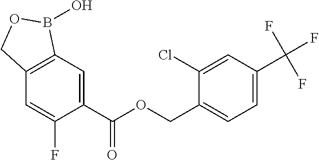 [SMILES: O=C(OCc1ccc(C(F)(F)F)cc1Cl)c1cc2c(cc1F)COB2O] | | | | |
| 387 | 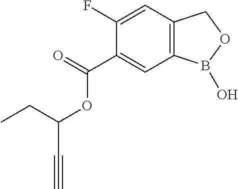 [SMILES: C#CC(CC)OC(=O)c1cc2c(cc1F)COB2O] | | | | |
| 388 | 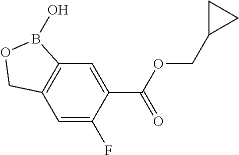 [SMILES: O=C(OCC1CC1)c1cc2c(cc1F)COB2O] | | | | |
| 389 | 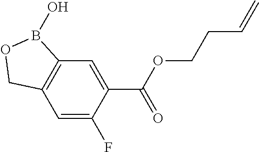 [SMILES: C=CCCOC(=O)c1cc2c(cc1F)COB2O] | | | | 107-109 |
| 390 | 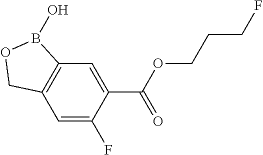 [SMILES: O=C(OCCCF)c1cc2c(cc1F)COB2O] | | | | |
| 391 | 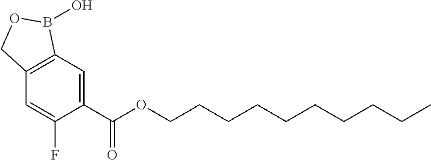 [SMILES: CCCCCCCCCCOC(=O)c1cc2c(cc1F)COB2O] | | | | |
| 392 | 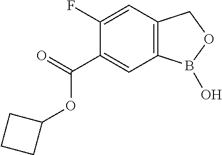 [SMILES: O=C(OC1CCC1)c1cc2c(cc1F)COB2O] | | | | |
| 393 | 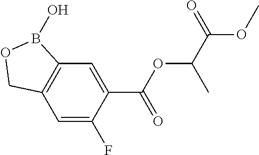 [SMILES: COC(=O)C(C)OC(=O)c1cc2c(cc1F)COB2O] | | | | |
| 394 | 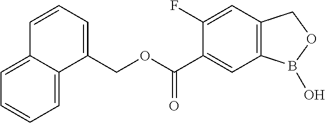 [SMILES: O=C(OCc1cccc2ccccc12)c1cc2c(cc1F)COB2O] | | | | |
| 395 | 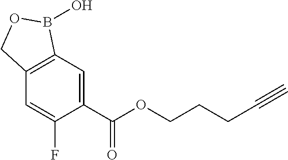 [SMILES: C#CCCCOC(=O)c1cc2c(cc1F)COB2O] | | | | |
| 396 | 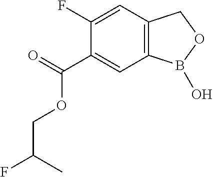 [SMILES: CC(F)COC(=O)c1cc2c(cc1F)COB2O] | | | | |
| 397 | 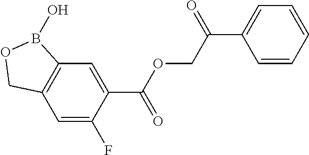 [SMILES: O=C(COC(=O)c1cc2c(cc1F)COB2O)c1ccccc1] | | | | |
| 398 | 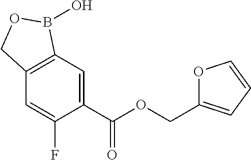 [SMILES: O=C(OCc1ccco1)c1cc2c(cc1F)COB2O] | | | | |
| 399 | 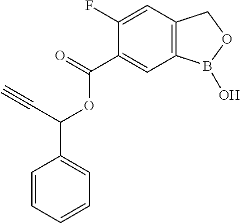 [SMILES: C#CC(OC(=O)c1cc2c(cc1F)COB2O)c1ccccc1] | | | | |
| 400 | 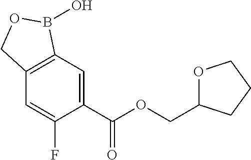 [SMILES: O=C(OCC1CCCO1)c1cc2c(cc1F)COB2O] | | | | |
| 401 | 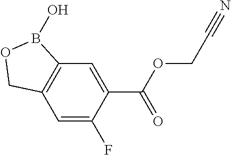 [SMILES: N#CCOC(=O)c1cc2c(cc1F)COB2O] | | | | |
| 402 | 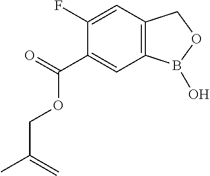 [SMILES: C=C(C)COC(=O)c1cc2c(cc1F)COB2O] | | | | |
| 403 | 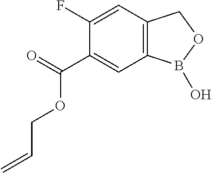 [SMILES: C=CCOC(=O)c1cc2c(cc1F)COB2O] | | | | |
| 404 | 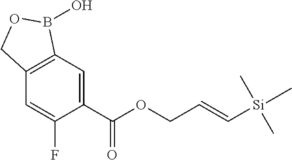 [SMILES: C[Si](C)(C)/C=C/COC(=O)c1cc2c(cc1F)COB2O] | | | | |
| 405 | 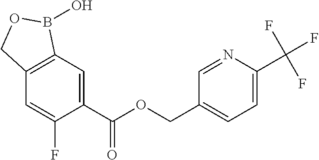 [SMILES: O=C(OCc1ccc(C(F)(F)F)nc1)c1cc2c(cc1F)COB2O] | | | | |
| 406 | 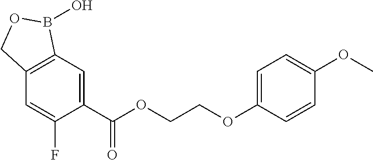 [SMILES: COc1ccc(OCCOC(=O)c2cc3c(cc2F)COB3O)cc1] | | | | |
| 407 | 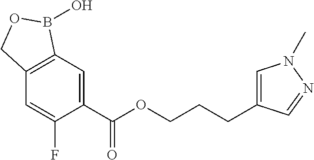 [SMILES: Cn1cc(CCCOC(=O)c2cc3c(cc2F)COB3O)cn1] | | | | |
| 408 | 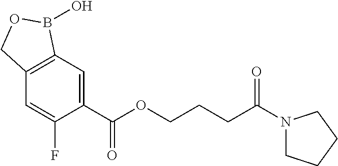 [SMILES: O=C(OCCCC(=O)N1CCCC1)c1cc2c(cc1F)COB2O] | | | | |
| 409 | 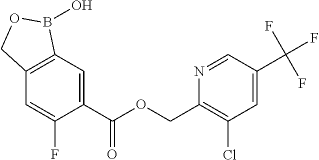 [SMILES: O=C(OCc1ncc(C(F)(F)F)cc1Cl)c1cc2c(cc1F)COB2O] | | | | |
| 410 | 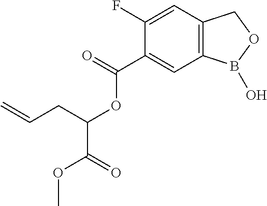 [SMILES: C=CCC(OC(=O)c1cc2c(cc1F)COB2O)C(=O)OC] | | | | |
| 411 | 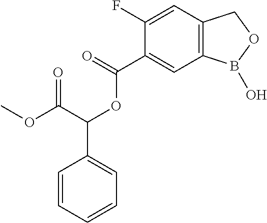 [SMILES: COC(=O)C(OC(=O)c1cc2c(cc1F)COB2O)c1ccccc1] | | | | |
| 412 | 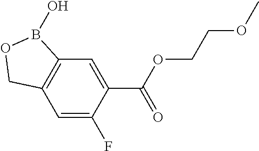 [SMILES: COCCOC(=O)c1cc2c(cc1F)COB2O] | | | | |
| 413 | 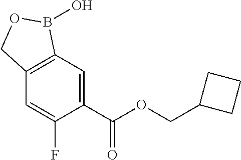 [SMILES: O=C(OCC1CCC1)c1cc2c(cc1F)COB2O] | | | | |
| 414 | 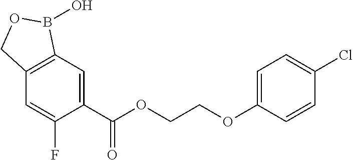 [SMILES: O=C(OCCOc1ccc(Cl)cc1)c1cc2c(cc1F)COB2O] | | | | |
| 415 | 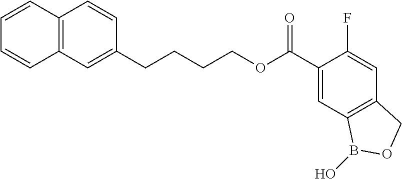 [SMILES: O=C(OCCCCc1ccc2ccccc2c1)c1cc2c(cc1F)COB2O] | | | | |
| 416 | 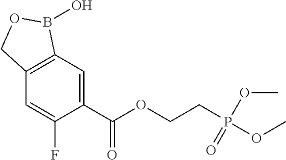 [SMILES: COP(=O)(CCOC(=O)c1cc2c(cc1F)COB2O)OC] | | | | |
| 417 | 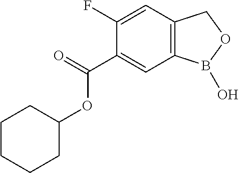 [SMILES: O=C(OC1CCCCC1)c1cc2c(cc1F)COB2O] | | | | |
| 418 | 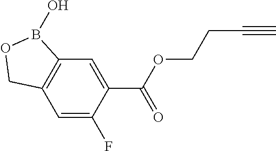 [SMILES: C#CCCOC(=O)c1cc2c(cc1F)COB2O] | | | | |
| 419 | 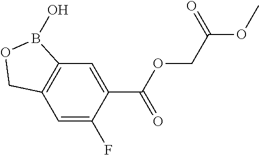 [SMILES: COC(=O)COC(=O)c1cc2c(cc1F)COB2O] | | | | 112-114 |
| 420 | 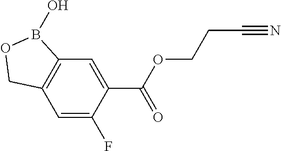 [SMILES: N#CCCOC(=O)c1cc2c(cc1F)COB2O] | | | | |
| 421 | 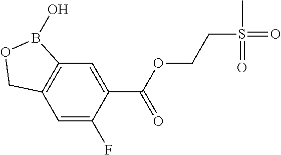 [SMILES: CS(=O)(=O)CCOC(=O)c1cc2c(cc1F)COB2O] | | | | |
| 422 | 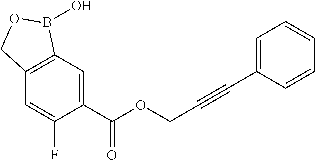 [SMILES: O=C(OCC#Cc1ccccc1)c1cc2c(cc1F)COB2O] | | | | |
| 423 | 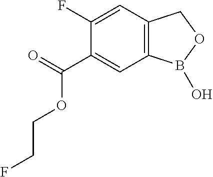 [SMILES: O=C(OCCF)c1cc2c(cc1F)COB2O] | | | | |
| 424 | 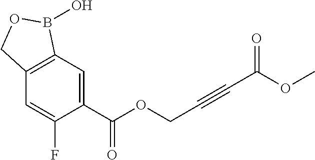 [SMILES: COC(=O)C#CCOC(=O)c1cc2c(cc1F)COB2O] | | | | 112-114 |
| 425 | 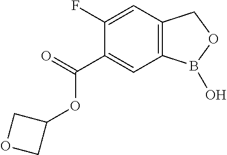 [SMILES: O=C(OC1COC1)c1cc2c(cc1F)COB2O] | | | | |
| 426 | 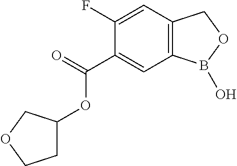 [SMILES: O=C(OC1CCOC1)c1cc2c(cc1F)COB2O] | | | | |
| 427 | 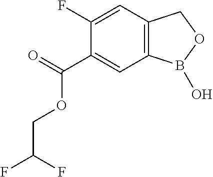 [SMILES: O=C(OCC(F)F)c1cc2c(cc1F)COB2O] | | | | |
| 428 | 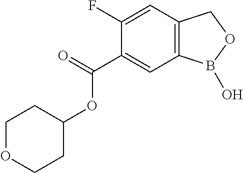 [SMILES: O=C(OC1CCOCC1)c1cc2c(cc1F)COB2O] | | | | |
| 429 | 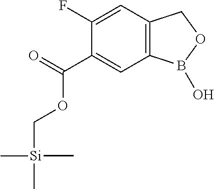 [SMILES: C[Si](C)(C)COC(=O)c1cc2c(cc1F)COB2O] | | | | 122-124 |
| 430 | 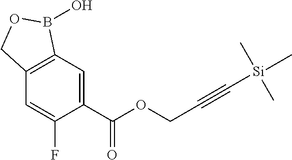 [SMILES: C[Si](C)(C)C#CCOC(=O)c1cc2c(cc1F)COB2O] | | | | |
| 431 | 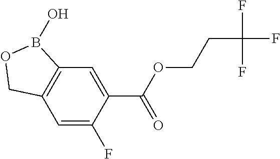 [SMILES: O=C(OCCC(F)(F)F)c1cc2c(cc1F)COB2O] | | | | |
| 432 | 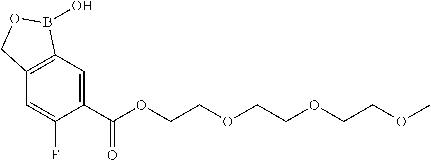 [SMILES: COCCOCCOCCOC(=O)c1cc2c(cc1F)COB2O] | | | | |
| 433 | 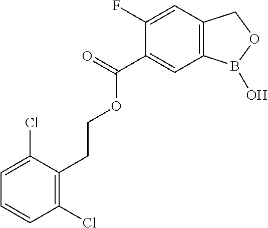 [SMILES: O=C(OCCc1c(Cl)cccc1Cl)c1cc2c(cc1F)COB2O] | | | | |
| 434 | 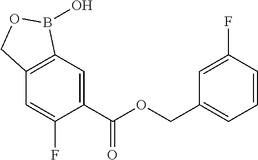 [SMILES: O=C(OCc1cccc(F)c1)c1cc2c(cc1F)COB2O] | | | | |
| 435 | 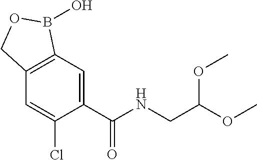 [SMILES: COC(CNC(=O)c1cc2c(cc1Cl)COB2O)OC] | | | | 150-152 |
| 436 | 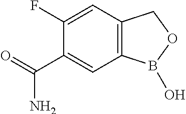 [SMILES: NC(=O)c1cc2c(cc1F)COB2O] | | | | 216-218 |
| 439 | 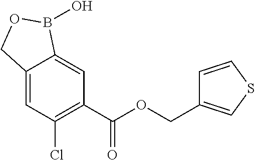 [SMILES: O=C(OCc1ccsc1)c1cc2c(cc1Cl)COB2O] | | | | |
| 440 | 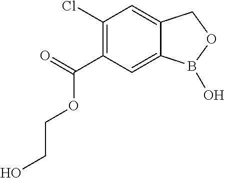 [SMILES: O=C(OCCO)c1cc2c(cc1Cl)COB2O] | | | | 270-272 |
| 441 | 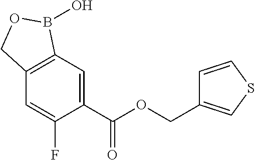 [SMILES: O=C(OCc1ccsc1)c1cc2c(cc1F)COB2O] | | | | 128-130 |
| 442 | 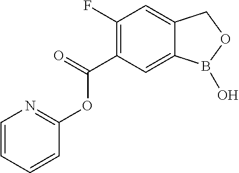 [SMILES: O=C(Oc1ccccn1)c1cc2c(cc1F)COB2O] | | | | 213-215 |
| 443 | 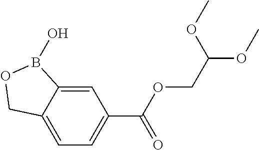 [SMILES: COC(COC(=O)c1ccc2c(c1)B(O)OC2)OC] | | | | 110-112 |
| 444 | 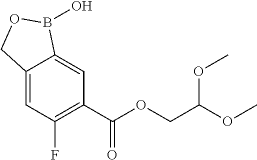 [SMILES: COC(COC(=O)c1cc2c(cc1F)COB2O)OC] | | | | 109-111 |
| 445 | 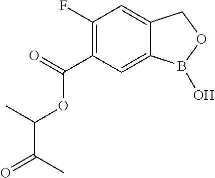 [SMILES: CC(=O)C(C)OC(=O)c1cc2c(cc1F)COB2O] | | | | 108-110 |
| 446 | 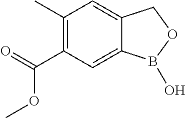 | | | | 136-138 |
| 447 | 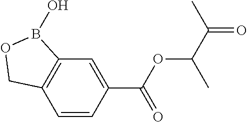 [SMILES: CC(=O)C(C)OC(=O)c1ccc2c(c1)B(O)OC2] | | | | 110-112 |
| 448 | 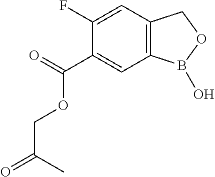 [SMILES: CC(=O)COC(=O)c1cc2c(cc1F)COB2O] | | | | 122-124 |
| 449 | 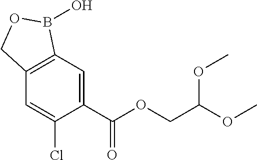 [SMILES: COC(COC(=O)c1cc2c(cc1Cl)COB2O)OC] | | | | 122-124 |
| 450 | 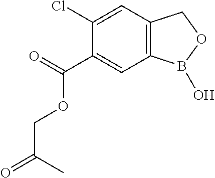 [SMILES: CC(=O)COC(=O)c1cc2c(cc1Cl)COB2O] | | | | 134-136 |
| 451 | 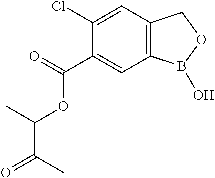 [SMILES: CC(=O)C(C)OC(=O)c1cc2c(cc1Cl)COB2O] | | | | 102-104 |

### Characterising Data:

Table 2 shows all the prepared examples with selected melting point and selected NMR data for prepared compounds. CDCl₃/D₂O and DMSO are used as solvents for NMR 400 MHz measurements. No attempt is made to list all characterising data in all cases.

In Table 2 and throughout the description that follows, temperatures are given in degrees Celsius; “NMR” means nuclear magnetic resonance spectrum; MS stands for mass spectrum; “%” is percent by weight, unless corresponding concentrations are indicated in other units. The following abbreviations are used throughout this description:

| | | | |
|---|---|---|---|
| m.p. = | melting point | b.p. = | boiling point. |
| S = | Singlet | br = | broad |
| d = | Doublet | dd = | doublet of doublets |
| t = | Triplet | q = | quartet |
| m = | Multiplet | ppm = | parts per million |

The following LC-MS methods were used to characterize the compounds:

### Method—M 1

ACQUITY SQD Mass Spectrometer from Waters (Single quadrupole mass spectrometer)
Ionisation method: Electrospray
Polarity: positive ions

### Capillary (kV) 3.00, Cone (V) 20.00, Extractor (V) 3.00, Source Temperature (° C.) 150, Desolvation

### Temperature (° C.) 400, Cone Gas Flow (L/Hr) 60, Desolvation Gas Flow (L/Hr) 700

Mass range: 100 to 800 Da
DAD Wavelength range (nm): 210 to 400
Method Waters ACQUITY UPLC with the following HPLC gradient conditions
(Solvent A: Water/Methanol 9:1, 0.1% formic acid and Solvent B: Acetonitrile, 0.1% formic acid)

| Time (minutes) | A (%) | B (%) | Flow rate (ml/min) |
|---|---|---|---|
| 0 | 100 | 0 | 0.75 |
| 2.5 | 0 | 100 | 0.75 |
| 2.8 | 0 | 100 | 0.75 |
| 3.0 | 100 | 0 | 0.75 |

Type of column: Waters ACQUITY UPLC HSS T3; Column length: 30 mm; Internal diameter of column: 2.1 mm; Particle Size: 1.8 micron; Temperature: 60° C.

The characteristic values obtained for each compound were the retention time (“Rₜ”, recorded in minutes) and the molecular ion as listed in Table 3.

### Method—M2

### Instrumentation:—

Mass Spectrometer: 6410 Triple quadrupole Mass Spectrometer from Agilent Technologies

### HPLC: Agilent 1200 Series HPLC

### Optimized Mass Parameter:—

Ionisation method: Electrospray (ESI)
Polarity: positive and Negative Polarity Switch

### Scan Type: MS2 Scan

### Capillary (kV): 4.00

### Fragmentor (V): 100.00

### Gas Temperature (° C.): 350

### Gas Flow (L/min): 11

Nebulizer Gas (psi): 35
Mass range: 110 to 1000 Da
DAD Wavelength range (nm): 190 to 400
Optimized Chromatographic parameter
Gradient conditions
(Solvent A: Water, 0.1% formic acid and Solvent B: Acetonitrile, 0.1% formic acid)

| Time (minutes) | A (%) | B (%) | Flow rate (ml/min) |
|---|---|---|---|
| 0 | 90 | 10 | 1.8 |
| 2.0 | 0 | 100 | 1.8 |
| 3.0 | 0 | 100 | 1.8 |
| 3.2 | 90 | 10 | 1.8 |
| 4.0 | 90 | 10 | 1.8 |

Type of column: Waters Xterra MS C18; Column length: 30 mm; Internal diameter of column: 4.6 mm; Particle Size: 3.5μ; Temperature: 30° C.

Table 5 shows selected melting point and selected NMR data for compounds of Table 1. CDCl₃/D₂O and DMSO are used as solvents for NMR 400 MHz measurements. No attempt is made to list all characterising data in all cases.

Table 5 and throughout the description that follows, temperatures are given in degrees Celsius; “NMR” means nuclear magnetic resonance spectrum; MS stands for mass spectrum; “%” is percent by weight, unless corresponding concentrations are indicated in other units. The following abbreviations are used throughout this description:

| | | | |
|---|---|---|---|
| m.p. = | melting point | b.p. = | boiling point. |
| S = | Singlet | br = | broad |
| d = | Doublet | dd = | doublet of doublets |
| t = | Triplet | q = | quartet |
| m = | Multiplet | ppm = | parts per million |

The following LC-MS methode was used to characterize the compounds:

ACQUITY SQD Mass Spectrometer from Waters (Single quadrupole mass spectrometer)
Ionisation method: Electrospray
Polarity: positive ions

### Capillary (kV) 3.00, Cone (V) 20.00, Extractor (V) 3.00, Source Temperature (° C.) 150, Desolvation Temperature (° C.) 400, Cone Gas Flow (L/Hr) 60, Desolvation Gas Flow (L/Hr) 700

Mass range: 100 to 800 Da
DAD Wavelength range (nm): 210 to 400
Method Waters ACQUITY UPLC with the following HPLC gradient conditions
(Solvent A: Water/Methanol 9:1, 0.1% ic acid and Solvent B: Acetonitrile, 0.1% ic acid)

| Time (minutes) | A (%) | B (%) | Flow rate (ml/min) |
|---|---|---|---|
| 0 | 100 | 0 | 0.75 |
| 2.5 | 0 | 100 | 0.75 |
| 2.8 | 0 | 100 | 0.75 |
| 3.0 | 100 | 0 | 0.75 |

Type of column: Waters ACQUITY UPLC HSS T3; Column length: 30 mm; Internal diameter of column: 2.1 mm; Particle Size: 1.8 micron; Temperature: 60° C.

The characteristic values obtained for each compound were the retention time (“Rₜ”, recorded in minutes) and the molecular ion as listed in Table T1.

Formulation examples for compounds of formula (I):

### Example F-1.1 to F-1.2

### Emulsifiable Concentrates

| Components | F-2.1 | F-2.2 |
|---|---|---|
| A compound selected from the Table T1, | 25% | 50% |
| T1-A or from the Tables 1 to 7 | | |
| calciumdodecylbenzenesulfonate | 5% | 6% |
| castoroilpolyethyleneglycolether | | |
| (36 molethylenoxyunits) | 5% | — |
| tributylphenolpolyethyleneglycolether | | |
| (30 molethylenoxyunits) | — | |
| cyclohexanone | — | 20% |
| xylenemixture | 65% | 20% |

Emulsions of any desired concentration can be prepared by diluting such concentrates with water.

### Example F-2

### Emulsifiable Concentrate

| Components | F-2 |
|---|---|
| A compound selected from the Table T1, | 10% |
| T1-A or from the Tables 1 to 7 | |
| octylphenolpolyethyleneglycolether | 3% |
| (4 to 5 mol ethylenoxy units) | |
| Calcium dodecylbenzenesulfonate | 3% |
| Castoroilpolyglycolether | 4% |
| (36 mol ethylenoxy units) | |
| cyclohexanone | 30% |
| xylenemixture | 50% |

Emulsions of any desired concentration can be prepared by diluting such concentrates with water.

### Examples F-3.1 to F-3.4

### Solutions

| Components | F-3.1 | F-3.2 | F-3.3 | F-3.4 |
|---|---|---|---|---|
| A compound selected from the Table T1, | 80% | 10% | 5% | 95% |
| T1-A or from the Tables 1 to 7 | | | | |
| propylene glycol monomethyl ether | 20% | — | — | — |
| polyethylene glycol | — | 70% | — | — |
| (relative molecular mass: 400 | | | | |
| atomic mass units) | | | | |
| N-methylpyrrolid-2-one | — | 20% | — | — |
| epoxidised coconut oil | — | — | 1% | 5% |
| benzin (boiling range: 160-190°) | — | — | 94% | — |
| The solutions are suitable for use | | | | |
| in the form of microdrops. | | | | |

### Examples F-4.1 to F-4.4

### Granulates

| Components | F-4.1 | F-4.2 | F-4.3 | F-4.4 |
|---|---|---|---|---|
| A compound selected from the Table T1, | 5% | 10% | 8% | 21% |
| T1-A or from the Tables 1 to 7 | | | | |
| Kaolin | 94% | — | 79% | 54% |
| highly dispersed silicic acid | 1% | — | 13% | 7% |
| Attapulgite | — | 90% | — | 18% |

The novel compound is dissolved in dichloromethane, the solution is sprayed onto the carrier and the solvent is then removed by distillation under vacuum.

### Examples F-5.1 and F-5.2

### Dusts

| Components | F-5.1 | F-5.2 |
|---|---|---|
| A compound selected from the Table T1, | 2% | 5% |
| T1-A or from the Tables 1 to 7 | | |
| highly dispersed silicic acid | 1% | 5% |
| Talcum | 97% | — |
| Kaolin | — | 90% |

Ready for use dusts are obtained by intimately mixing all components.

### Examples F-6.1 to F-6.3

### Wettable Powders

| Components | F-6.1 | F-6.2 | F-6.3 |
|---|---|---|---|
| A compound selected from the Table T1, | 25% | 50% | 75% |
| T1-A or from the Tables 1 to 7 | | | |
| sodium lignin sulfonate | 5% | 5% | — |
| sodium lauryl sulphate | 3% | — | 5% |
| sodium diisobutylnaphthalene sulfonate | 6% | 10% | — |
| octylphenolpolyethylene glycol ether | 2% | — | — |
| (7 to 8 mol ethylenoxy units) | | | |
| highly dispersed silicic acid | 5% | 10% | 10% |
| Kaolin | 62% | 27% | — |

All components are mixed and the mixture is thoroughly ground in a suitable mill to give wettable powders which can be diluted with water to suspensions of any desired concentration.

### Example F7

### Flowable Concentrate for Seed Treatment

| Components | F-7 |
|---|---|
| A compound selected from the Table | 40% |
| T1, T1-A or from the Tables 1 to 7 | |
| propylene glycol | 5% |
| copolymer butanol PO/EO | 2% |
| tristyrenephenole with 10-20 moles EO | 2% |
| 1,2-benzisothiazolin-3-one | 0.5% |
| (in the form of a 20% solution in water) | |
| monoazo-pigment calcium salt | 5% |
| Silicone oil | 0.2% |
| (in the form of a 75% emulsion in | |
| water) | |
| Water | 45.3% |

The finely ground active ingredient is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Biological Examples

### Fungicidal Action

1. Phytophthora infestans/Tomato/Leaf Disc Preventative (Late Blight)

Tomato leaf disks were placed on water agar in multiwell plates (24-well format) and sprayed with the formulated test compound diluted in water at an application rate of 200 ppm. The leaf disks were inoculated with a spore suspension of the fungus 1 day after application. The inoculated leaf disks were incubated at 16° C. and 75% relative humidity under a light regime of 24 h darkness followed by 12/12 h (light/dark) in a climate cabinet and the activity of a compound was assessed as percent disease control compared to untreated when an appropriate level of disease damage appears in untreated check leaf disks (5-7 days after application). The compounds 16, 21, 23, 27, 59, 78, 84, 85, 87, 90, 94, 107, 114, 119, 121, 124, 128, 129, 132, 138, 150, 163, 181, 182, 186, 193, 202, 206, 207, 208, 211, 217, 231, 236 and 323 (from table T1 and T1-A) at 200 ppm give at least 80% disease control in this test when compared to untreated control leaf disks under the same conditions, which show extensive disease development.

2. Plasmopara viticola/Grape/Leaf Disc Preventative (Late Blight)

Grape vine leaf disks were placed on water agar in multiwell plates (24-well format) and sprayed with the formulated test compound diluted in water. The leaf disks were inoculated with a spore suspension of the fungus 1 day after application. The inoculated leaf disks were incubated at 19° C. and 80% relative humidity under a light regime of 12/12 h (light/dark) in a climate cabinet and the activity of a compound was assessed as percent disease control compared to untreated when an appropriate level of disease damage appears in untreated check leaf disks (6-8 days after application). The compounds 6, 7, 10, 16, 21, 23, 26, 43, 45, 50, 73, 84, 85, 95, 103, 107, 109, 114, 119, 121, 124, 132, 143, 144, 155, 161, 169, 170, 174, 179, 182, 184, 185, 186, 188, 192, 196, 201, 208, 211, 213, 223, 226, 230, 232, 238, 240, 261, 262, 268, 271, 273, 279, 283, 285, 289, 292, 298, 306, 308, 311, 314, 317, 318, 320, 323, 324, 327, 328, 329, 330, 332, 334, 335, 336, 337, 338, 339, 340, 341, 342, 343, 344, 345, 348, 349, 351, 355, 356, 357, 359, 360, 361, 364, 365, 366, 367, 368, 373, 374, 376, 379, 380, 381, 382, 388, 390, 392, 393, 394, 395, 396, 397, 398, 399, 400, 401, 403, 409, 410, 411, 412, 417, 418, 419, 420, 423, 424, 425, 429, 430, 433, 434, 439, 441, 450 and 451 (from table T1 and T1-A) at 200 ppm give at least 80% disease control in this test when compared to untreated control leaf disks under the same conditions, which show extensive disease development.

3. Puccinia recondita f. sp. tritici/Wheat/Leaf Disc Preventative (Brown Rust):

Wheat leaf segments cultivated variety (cv) Kanzler were placed on agar in 24-well plates and sprayed with formulated test compound diluted in water at an application rate of 200 ppm. The leaf disks were inoculated with a spore suspension of the fungus 1 day after application. The inoculated leaf segments were incubated at 19° C. and 75% relative humidity under a light regime of 12/12 h (light/dark) in a climate cabinet and the activity of a compound was assessed as percent disease control compared to untreated when an appropriate level of disease damage appears in untreated check leaf segments (7-9 days after application).) The compounds 6, 7, 16, 21, 23, 26, 50, 161, 169, 188, 207, 225, 312, 317, 331, 349, 356, 367, 370, 380, 391, 419 and 441 (from table T1 and T1-A) at 200 ppm give at least 80% disease control in this test when compared to untreated control leaf disks under the same conditions, which show extensive disease development.

4. Puccinia recondita f. sp. tritici/Wheat/Leaf Disc Curative (Brown Rust)

Wheat leaf segments are placed on agar in multiwell plates (24-well format). The leaf disks are then inoculated with a spore suspension of the fungus. One day after inoculation the test solution is applied. After appropriate incubation the activity of a compound is assessed 8 dpi (days after inoculation) as curative fungicidal activity. Dose range: 200-22 ppm. The Compounds 21, 23, 40, 230, 233, 339, 348, 351, 355, 356, 365, 393, 401, 402, 418, and 419 (from table T1 and T1-A) at 200 ppm give at least 80% disease control in this test when compared to untreated control leaf disks under the same conditions, which show extensive disease development.

5. Phaeosphaeria nodorum (Septoria nodorum)/Wheat/Leaf Disc Preventative (Glume Blotch):

Wheat leaf segments (cv) Kanzler were placed on agar in a 24-well plate and sprayed with formulated test compound diluted in water at an application rate of 200 ppm. The leaf disks were inoculated with a spore suspension of the fungus 2 days after application. The inoculated test leaf disks were incubated at 20° C. and 75% relative humidity under a light regime of 12/12 h (light/dark) in a climate cabinet and the activity of a compound was assessed as percent disease control compared to untreated when an appropriate level of disease damage appears in untreated check leaf disks (5-7 days after application). The Compounds 16, 21, 23, 110, 161, 202, 208, 232, 233, 318, 351 and 446 (from table T1 and T1-A) at 200 ppm give at least 80% disease control in this test when compared to untreated control leaf disks under the same conditions, which show extensive disease development.

6. Magnaporthe grisea (Pyricularia oryzae)/Rice/Leaf Disc Preventative (Rice Blast):

Rice leaf segments cv. Ballila were placed on agar in multiwell plate (24-well format) and sprayed with the formulated test compound diluted in water at an application rate of 200 ppm. The leaf segments were inoculated with a spore suspension of the fungus 2 days after application. The inoculated leaf segments were incubated at 22° C. and 80% rh under a light regime of 24 h darkness followed by 12/12 h (light/dark) in a climate cabinet and the activity of a compound was assessed as percent disease control compared to untreated when an appropriate level of disease damage appears in untreated check leaf segments (5-7 days after application). The Compound 21 (from table T1 and T1-A) at 200 ppm give at least 80% disease control in this test when compared to untreated control leaf disks under the same conditions, which show extensive disease development.

7. Pyrenophora teres/Barley/Leaf Disc Preventative (Net Blotch):

Barley leaf segments cv. Hasso were placed on agar in a multiwell plate (24-well format) and sprayed with the formulated test compound diluted in water. The leaf segments were inoculated with a spore suspension of the fungus 2 days after application. The inoculated leaf segments were incubated at 20° C. and 65% rh under a light regime of 12 h light/12 h darkness in a climate cabinet and the activity of a compound was assessed as disease control compared to untreated when an appropriate level of disease damage appears in untreated check leaf segments (5-7 days after application). The Compounds (from table T1 and T1-A) 16 and 23 at 200 ppm give at least 80% disease control in this test when compared to untreated control leaf disks under the same conditions, which show extensive disease development.

8. Alternaria solani/Tomato/Leaf Disc (Early Blight)

Tomato leaf disks cultivated variety (cv.) Baby were placed on agar in multiwell plates (24-well format) and sprayed with the formulated test compound diluted in water at an application rate of 200 ppm. The leaf disks were inoculated with a spore suspension of the fungus 2 days after application. The inoculated leaf disks were incubated at 23° C./21° C. (day/night) and 80% relative humidity under a light regime of 12/12 h (light/dark) in a climate cabinet and the activity of a compound was assessed as percent disease control compared to untreated when an appropriate level of disease damage appears on untreated check disk leaf disks (5-7 days after application). The Compounds (from table T1 and T1-A) 21 and 23 at 200 ppm give at least 80% disease control in this test when compared to untreated control leaf disks under the same conditions, which show extensive disease development.

9. Pythium ultimum/Liquid Culture (Seedling Damping Off)

Mycelia fragments and oospores of a newly grown liquid culture of the fungus were directly mixed into nutrient broth (potato dextrose broth). After placing a DMSO solution of test compound into a 96-well format microtiter plate at an application rate of 200 ppm, the nutrient broth containing the fungal mycelia/spore mixture was added. The test plates were incubated at 24° C. and the inhibition of growth was determined photometrically 2-3 days after application. The Compounds 1, 2, 3, 4, 5, 6, 7, 8, 10, 11, 12, 13, 14, 16, 17, 18, 19, 20, 21, 22, 23, 24, 25, 26, 27, 28, 29, 30, 31, 32, 33, 34, 35, 36, 37, 38, 39, 40, 41, 44, 50, 51, 52, 53, 54, 55, 58, 59, 62, 64, 70, 71, 72, 73, 74, 75, 76, 78, 81, 82, 83, 84, 85, 86, 87, 90, 91, 92, 93, 94, 97, 99, 101, 103, 104, 105, 107, 108, 109, 111, 115, 117, 118, 119, 120, 121, 124, 125, 126, 128, 129, 130, 132, 134, 135, 136, 138, 139, 143, 144, 146, 147, 148, 149, 150, 151, 152, 153, 154, 155, 156, 157, 158, 159, 160, 161, 163, 164, 166, 170, 172, 173, 174, 175, 176, 177, 178, 179, 180, 181, 182, 184, 185, 186, 189, 192, 193, 196, 197, 198, 201, 202, 203, 205, 206, 207, 208, 209, 210, 211, 212, 213, 214, 215, 217, 218, 219, 220, 221, 222, 223, 224, 225, 226, 228, 229, 230, 231, 232, 233, 234, 235, 236, 237, 238, 239, 240, 241, 242, 243, 244, 246, 247, 248, 249, 254, 255, 256, 259, 261, 262, 263, 267, 268, 269, 271, 272, 273, 274, 275, 276, 278, 279, 280, 281, 283, 285, 287, 288, 289, 292, 293, 295, 296, 298, 299, 300, 301, 302, 303, 305, 306, 309, 311, 314, 315, 316, 317, 318, 319, 320, 321, 322, 323, 324, 327, 328, 329, 330, 331, 332, 333, 334, 335, 336, 337, 338, 339, 340, 341, 342, 343, 344, 345, 346, 347, 348, 349, 350, 351, 352, 355, 356, 357, 358, 359, 360, 361, 362, 363, 364, 365, 366, 367, 368, 369, 370, 371, 372, 374, 375, 376, 377, 378, 379, 380, 381, 382, 383, 384, 386, 387, 388, 389, 390, 391, 392, 393, 394, 395, 396, 397, 398, 399, 400, 401, 402, 403, 404, 405, 406, 407, 408, 409, 410, 411, 412, 413, 414, 416, 417, 418, 419, 420, 421, 422, 423, 424, 425, 426, 427, 428, 429, 430, 431, 432, 434, 436, 438, 439, 440, 441, 442, 443, 444, 445, 446, 447, 448, 449, 450 and 451 (from table T1 and T1-A) at 200 ppm give at least 80% disease control in this test when compared to untreated control leaf disks under the same conditions, which show extensive disease development.

10. Botryotinia fuckeliana (Botrytis cinerea)/Liquid Culture (Gray Mould):

Conidia of the fungus from cryogenic storage were directly mixed into nutrient broth (Vogels broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 3-4 days after application. The Compounds 16, 21, 23, 27, 49, 194, 201, 202, 216, 225, 317, 318, 323, 359, 361, 373, 375, 419, 422, 424, and 434 (from table T1 and T1-A) at 200 ppm give at least 80% disease control in this test when compared to untreated control leaf disks under the same conditions, which show extensive disease development.

11. Glomerella lagenarium (Colletotrichum lagenarium)/Liquid Culture (Anthracnose):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was measured photometrically 3-4 days after application. The Compounds 3, 5, 16, 17, 21, 23, 37, 39, 41, 43, 44, 49, 50, 107, 112, 114, 132, 136, 144, 146, 147, 150, 158, 169, 189, 191, 192, 194, 195, 196, 197, 198, 199, 201, 202, 203, 205, 208, 209, 211, 214, 215, 217, 218, 221, 223, 224, 225, 226, 227, 229, 230, 232, 233, 236, 237, 238, 240, 241, 280, 314, 317, 320, 325, 326, 327, 328, 334, 336, 339, 340, 341, 343, 344, 345, 348, 349, 351, 355, 356, 360, 361, 367, 369, 375, 378, 379, 380, 381, 382, 384, 385, 386, 387, 388, 389, 390, 392, 394, 395, 403, 404, 406, 407, 409, 411, 412, 414, 419, 424, 427, 429, 434, 439, 441, 446 and 449 (from table T1 and T1-A) at 200 ppm give at least 80% disease control in this test when compared to untreated control leaf disks under the same conditions, which show extensive disease development.

12. Mycosphaerella arachidis (Cercospora arachidicola)/Liquid Culture (Early Leaf Spot):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. The Compounds 3, 5, 6, 7, 13, 14, 16, 17, 18, 19, 21, 23, 37, 39, 43, 44, 50, 104, 136, 144, 147, 194, 195, 197, 198, 202, 203, 205, 214, 215, 216, 218, 225, 226, 229, 230, 232, 233, 240, 241, 261, 267, 271, 298, 302, 311, 314, 317, 318, 319, 320, 323, 324, 325, 328, 329, 330, 331, 332, 333, 334, 336, 337, 339, 340, 341, 342, 343, 344, 345, 347, 348, 350, 351, 352, 353, 355, 356, 359, 360, 361, 362, 365, 366, 371, 375, 377, 378, 379, 380, 382, 384, 385, 386, 388, 389, 391, 392, 394, 395, 396, 398, 402, 403, 404, 405, 406, 407, 412, 414, 415, 418, 419, 422, 423, 424, 430, 434, 439, 441, 446, 449 and 451 (from table T1 and T1-A) at 200 ppm give at least 80% disease control in this test when compared to untreated control leaf disks under the same conditions, which show extensive disease development.

13. Mycosphaerella graminicola (Septoria tritici)/Liquid Culture (Septoria Blotch):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. The Compounds 3, 5, 6, 16, 17, 18, 19, 20, 21, 23, 26, 27, 32, 37, 39, 40, 41, 50, 110, 114, 129, 136, 144, 146, 154, 161, 169, 179, 191, 192, 194, 195, 196, 197, 198, 199, 201, 202, 203, 205, 208, 211, 214, 215, 216, 218, 225, 226, 227, 229, 230, 232, 233, 236, 238, 240, 241, 314, 317, 318, 319, 320, 321, 323, 324, 325, 328, 329, 331, 332, 333, 334, 336, 339, 340, 341, 342, 343, 344, 351, 352, 355, 359, 361, 362, 367, 370, 373, 374, 375, 377, 378, 379, 381, 382, 384, 385, 387, 388, 389, 392, 394, 397, 399, 402, 403, 404, 406, 411, 413, 414, 417, 418, 419, 422, 423, 424, 429, 430, 434, 439, 441, 446, 449 and 451 (from table T1 and T1-A) at 200 ppm give at least 80% disease control in this test when compared to untreated control leaf disks under the same conditions, which show extensive disease development.

14. Gaeumannomyces graminis/Liquid Culture (Take-all of Cereals):

Mycelial fragments of the fungus from cryogenic storage were directly mixed into nutrient broth (PDB potato dextrose broth). After placing a DMSO solution of test compound into a 96-well microtiter plate at an application rate of 200 ppm, the nutrient broth Cp.33, containing the fungal spores is added. The test plates were incubated at 24° C. and the inhibition of growth was determined photometrically 4-5 days after application. The Compounds 3, 5, 6, 13, 16, 17, 19, 21, 23, 26, 50, 78, 85, 97, 103, 125, 129, 132, 139, 144, 157, 179, 189, 190, 191, 192, 194, 195, 196, 199, 200, 201, 202, 203, 205, 207, 208, 209, 210, 214, 215, 216, 217, 218, 221, 224, 225, 226, 229, 230, 232, 233, 236, 238, 240, 241, 291, 292, 312, 314, 316, 317, 318, 320, 321, 323, 324, 325, 326, 327, 328, 329, 330, 334, 336, 339, 340, 341, 342, 343, 344, 345, 347, 349, 351, 352, 353, 355, 356, 359, 361, 362, 365, 367, 369, 370, 373, 374, 375, 377, 378, 379, 381, 382, 385, 386, 387, 388, 389, 390, 391, 393, 394, 395, 399, 402, 403, 404, 406, 409, 410, 411, 413, 414, 415, 417, 418, 419, 422, 423, 424, 425, 429, 430, 431, 433, 434, 437, 439, 446, 447, 449, 450 and 451 (from table T1 and T1-A) at 200 ppm give at least 80% disease control in this test when compared to untreated control leaf disks under the same conditions, which show extensive disease development.

15. Monographella nivalis (Microdochium nivale)/Liquid Culture (Foot Rot Cereals):

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. The Compounds 2, 3, 5, 6, 16, 17, 18, 19, 20, 21, 23, 26, 27, 32, 37, 39, 40, 41, 43, 44, 49, 50, 90, 95, 99, 103, 110, 114, 129, 132, 136, 144, 146, 147, 150, 161, 169, 179, 181, 186, 188, 189, 190, 191, 192, 194, 195, 196, 197, 198, 199, 200, 201, 202, 203, 205, 207, 208, 209, 211, 214, 215, 216, 217, 218, 221, 222, 223, 224, 225, 226, 227, 229, 230, 232, 233, 236, 237, 238, 240, 241, 244, 279, 308, 311, 312, 314, 316, 317, 318, 319, 320, 321, 323, 324, 325, 326, 328, 329, 330, 332, 333, 334, 336, 337, 339, 340, 342, 343, 344, 349, 350, 351, 352, 355, 356, 359, 361, 362, 367, 368, 369, 370, 372, 373, 374, 375, 377, 378, 379, 380, 381, 382, 384, 385, 386, 387, 388, 389, 390, 392, 394, 395, 396, 397, 398, 399, 402, 403, 404, 405, 406, 409, 410, 411, 412, 413, 414, 415, 417, 418, 419, 422, 423, 424, 427, 429, 431, 433, 434, 439, 441, 442, 446, 447, 448, 449 and 451 (from table T1 and T1-A) at 200 ppm give at least 80% disease control in this test when compared to untreated control leaf disks under the same conditions, which show extensive disease development.

16. Fusarium culmorum/Liquid Culture (Head Blight):

Conidia of the fungus from cryogenic storage were directly mixed into nutrient broth (PDB potato dextrose broth). After placing a (DMSO) solution of the test compounds into a microtiter plate (96-well format), the nutrient broth containing the fungal spores was added. The test plates were incubated at 24° C. and the inhibition of growth was determined visually 3-4 days after application. The Compounds 3, 16, 21, 23, 37, 39, 50, 114, 146, 150, 197, 202, 203, 205, 215, 226, 229, 230, 232, 233, 318, 323, 329, 332, 334, 336, 344, 351, 359, 361, 362, 373, 375, 379, 381, 389, 413, 419, 422, 424, 429, 430, 433, 441, 446 and 449 (from table T1 and T1-A) at 200 ppm give at least 80% disease control in this test when compared to untreated control leaf disks under the same conditions, which show extensive disease development.

17. Thanatephorus cucumeris (Rhizoctonia solani)/Liquid Culture (Foot Rot, Damping-Off):

Mycelia fragments of a newly grown liquid culture of the fungus were directly mixed into nutrient broth (PDB potato dextrose broth). After placing a DMSO solution of the test compounds into a 96-well microtiter plate at an application rate of 200 ppm, the nutrient broth containing the fungal material was added. The test plates were incubated at 24° C. and the inhibition of growth was determined photometrically 3-4 days after application. The Compounds 3, 5, 13, 16, 17, 18, 19, 20, 21, 23, 27, 37, 39, 40, 41, 50, 148, 192, 195, 197, 198, 202, 203, 205, 206, 209, 210, 211, 214, 215, 218, 222, 225, 226, 227, 229, 230, 232, 238, 240, 241, 311, 314, 315, 316, 317, 318, 319, 320, 321, 323, 324, 327, 328, 329, 330, 331, 332, 334, 335, 336, 337, 338, 339, 340, 341, 342, 343, 344, 345, 348, 350, 351, 352, 355, 356, 359, 360, 361, 362, 364, 366, 367, 368, 369, 370, 374, 375, 377, 378, 379, 380, 381, 382, 384, 385, 386, 387, 388, 389, 390, 391, 392, 393, 394, 395, 396, 397, 398, 399, 400, 402, 403, 404, 405, 406, 407, 409, 410, 412, 413, 414, 415, 417, 418, 419, 422, 423, 424, 427, 429, 430, 431, 433, 434, 439, 441, 442 and 446 (from table T1 and T1-A) at 200 ppm give at least 80% disease control in this test when compared to untreated control leaf disks under the same conditions, which show extensive disease development.

18. Sclerotinia sclerotiorum/Liquid Culture (Cottony Rot):

Mycelia fragments of a newly grown liquid culture of the fungus were directly mixed into nutrient broth (PDB potato dextrose broth). After placing a (DMSO) solution of the test compounds into a microtiter plate (96-well format) the nutrient broth containing the fungal material was added. The test plates were incubated at 24° C. and the inhibition of growth was determined visually 3-4 days after application. The Compounds 16, 21, 23, 27, 37, 147, 202, 215, 230, 359, 361, 375, 379, 389, 410, 418, 419, 424, 446 and 449 (from table T1 and T1-A) at 200 ppm give at least 80% disease control in this test when compared to untreated control leaf disks under the same conditions, which show extensive disease development.

1. A method for controlling or preventing infestation of plants or plant propagation material and/or harvested food crops susceptible to microbial attack by treating plants or plant propagation material and/or harvested food crops with an effective amount of an oxaborole of general formula (I) 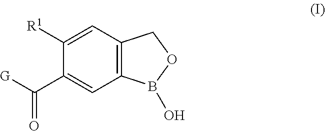
R¹ is H, fluorine, chlorine, bromine, cyano, nitro, unsubstituted or substituted C₁-C₄alkyl or unsubstituted or substituted C₁-C₄haloalkyl, unsubstituted or substituted C₁-C₄alkoxy, haloalkoxy;
G=OR², NR³R⁴
R², R³ and R⁴ independently are H, unsubstituted or substituted C₁-C₆alkyl, haloalkyl, six to 10 membered aryl, 1,3-benzodioxole-(C₀-C₂)—, five to ten membered heteroaryl which may be mono or bicyclic containing 1 to 3 hetero atoms selected from the group consisting of nitrogen, oxygen and sulfur, it not being possible for the ring system to contain more than 2 oxygen atoms and more than 2 sulfur atoms, C₃-C₆cycloalkyl, unsubstituted or substituted heterocycloalkyl containing 3 to 10 ring members containing 1 to 3 hetero atoms selected from the group consisting of nitrogen, oxygen and sulfur, it not being possible for the ring system to contain more than 2 oxygen atoms and more than 2 sulfur atoms, unsubstituted or substituted C₁-C₆alkoxy, unsubstituted or substituted C₁-C₆haloalkoxy, unsubstituted or substituted C₂-C₆alkenyl, unsubstituted or substituted C₂-C₆alkynyl, or
R³ and R⁴ form together with the nitrogen to which they are attached a 3 to 9 ring containing 1 to 3 hetero atoms selected from the group consisting of nitrogen, oxygen and sulfur, it not being possible for the ring system to contain more than 2 oxygen atoms and more than 2 sulfur atoms,
and wherein the substituents for the substituted aryl, heteroaryl, cycloalkyl, heterocycloalkyl and alkyl can be independently mono- or polysubstituted by substituents selected from oxo, —OH, CN, NO₂, F, Cl, —SH, —S—C₁₋₄ alkyl, —S(O)₂—N— heteroaryl, —S(O)₂—N-aryl, —C₁₋₄ alkyl C₁₋₄alkoxy, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁₋₄alkylamino, unsubstituted or substituted five- to ten-membered aryl, unsubstituted or substituted five- to six-membered heteroaryl, unsubstituted or substituted C₃-C₇ cycloalkyl, and unsubstituted or substituted C₃-C₇ heterocycloalkyl, C₁-C₆alkyl, C₁-C₆haloalkyl, C₁-C₆alkenyl, C₁-C₆haloalkenyl, C₁-C₆alkinyl, C₁-C₆haloalkinyl, C₁-C₆alkoxy, C₁-C₆haloalkoxy, C₁-C₆alkenyloxy, C₁-C₆haloalkenyloxy, C₁-C₆alkinyloxy, C₁-C₆haloalkinyl, C₁-C₆alkoxy-C₁-C₆alkyl, C₁-C₆haloalkoxy, C₁-C₆alkoximino, C₁-C₆alkylendioxy, —C(O)(C₁₋₄ alkyl), —(C₁₋₄ alkyl)-C(O)(C₁₋₄ alkyl), —C(O)OH, —(C₁₋₄ alkyl)-C(O)OH, —S—S(O)₂—OH, —S(O)₂—OH, indolin, unsubstituted or substituted six- to ten-membered-aryl(alkylene)₍₀₋₃₎ and unsubstituted or substituted six- to ten-membered-aryl(alkylene)₍₀₋₃₎oxy;
wherein the heterocycloalkyl and heteroaryl containing 3 to 10 ring members containing 1 to 3 hetero atoms selected from the group consisting of nitrogen, oxygen and sulfur, it not being possible for the ring system to contain more than 2 oxygen atoms and more than 2 sulfur atoms
and wherein the heterocycloalkyl and the heteroaryl contain 1 to 3 hetero atoms selected from the group consisting of nitrogen, oxygen and sulfur, it not being possible for the ring system to contain more than 2 oxygen atoms and more than 2 sulfur atoms;
or an agronomically acceptable salt, stereoisomer,
diastereoisomer, enantiomer, tautomer, and or N-oxide thereof.

2. A compound of formula (I) 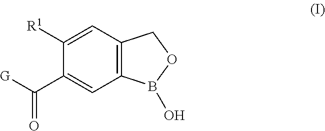
wherein
R¹ is H, fluorine, chlorine, bromine, cyano, nitro, unsubstituted or substituted C₁-C₄alkyl or unsubstituted or substituted C₁-C₄haloalkyl, unsubstituted or substituted C₁-C₄alkoxy, haloalkoxy;
G=OR², NR³R⁴
R², R³ and R⁴ independently are H, unsubstituted or substituted C₁-C₆alkyl, haloalkyl, six to 10 membered aryl, 1,3-benzodioxole-(C₀-C₂)-, five to ten membered heteroaryl which may be mono or bicyclic containing 1 to 3 hetero atoms selected from the group consisting of nitrogen, oxygen and sulfur, it not being possible for the ring system to contain more than 2 oxygen atoms and more than 2 sulfur atoms, C₃-C₆cycloalkyl, unsubstituted or substituted heterocycloalkyl containing 3 to 10 ring members containing 1 to 3 hetero atoms selected from the group consisting of nitrogen, oxygen and sulfur, it not being possible for the ring system to contain more than 2 oxygen atoms and more than 2 sulfur atoms, unsubstituted or substituted C₁-C₆alkoxy, unsubstituted or substituted C₁-C₆haloalkoxy, unsubstituted or substituted C₂-C₆alkenyl, unsubstituted or substituted C₂-C₆alkynyl, or
R³ and R⁴ form together with the nitrogen to which they are attached a 3 to 9 ring containing 1 to 3 hetero atoms selected from the group consisting of nitrogen, oxygen and sulfur, it not being possible for the ring system to contain more than 2 oxygen atoms and more than 2 sulfur atoms,
and wherein the substituents for the substituted aryl, heteroaryl, cycloalkyl, heterocycloalkyl and alkyl can be independently mono- or polysubstituted by substituents selected from oxo, —OH, CN, NO₂, F, Cl, —SH, —S—C₁₋₄ alkyl, —S(O)₂—N— heteroaryl, —S(O)₂—N-aryl, —C₁₋₄ alkyl C₁₋₄alkoxy, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁₋₄alkylamino, unsubstituted or substituted five- to ten-membered aryl, unsubstituted or substituted five- to six-membered heteroaryl, unsubstituted or substituted C₃-C₇ cycloalkyl, and unsubstituted or substituted C₃-C₇ heterocycloalkyl, C₁-C₆alkyl, C₁-C₆haloalkyl, C₁-C₆alkenyl, C₁-C₆haloalkenyl, C₁-C₆alkinyl, C₁-C₆haloalkinyl, C₁-C₆alkoxy, C₁-C₆haloalkoxy, C₁-C₆alkenyloxy, C₁-C₆haloalkenyloxy, C₁-C₆alkinyloxy, C₁-C₆haloalkinyl, C₁-C₆alkoxy-C₁-C₆alkyl, C₁-C₆haloalkoxy, C₁-C₆alkoximino, C₁-C₆alkylendioxy, —C(O)(C₁₋₄ alkyl), —(C₁₋₄ alkyl)-C(O)(C₁₋₄ alkyl), —C(O)OH, —(C₁₋₄ alkyl)-C(O)OH, —S—S(O)₂—OH, —S(O)₂—OH, indolin, unsubstituted or substituted six- to ten-membered-aryl(alkylene)₍₀₋₃₎ and unsubstituted or substituted six- to ten-membered-aryl(alkylene)₍₀₋₃₎oxy;
wherein the heterocycloalkyl and heteroaryl containing 3 to 10 ring members containing 1 to 3 hetero atoms selected from the group consisting of nitrogen, oxygen and sulfur, it not being possible for the ring system to contain more than 2 oxygen atoms and more than 2 sulfur atoms
and wherein the heterocycloalkyl and the heteroaryl contain 1 to 3 hetero atoms selected from the group consisting of nitrogen, oxygen and sulfur, it not being possible for the ring system to contain more than 2 oxygen atoms and more than 2 sulfur atoms;
or an agronomically acceptable salt, stereoisomer,
diastereoisomer, enantiomer, tautomer, atriopisomer or N-oxide thereof;
provided that the compound of formula (I) is not 1,3-dihydro-1-hydroxy-2,1-Benzoxaborole-7-carboxylic acid methyl ester or 3-dihydro-1-hydroxy-2,1-Benzoxaborole-7-carboxylic acid or 1,3-dihydro-1-hydroxy-N-phenyl-2,1-Benzoxaborole-6-carboxamide or 4-[[(1,3-dihydro-1-hydroxy-2,1-benzoxaborol-6-yl)carbonyl]amino]-benzenesulfonic acid or 1,3-dihydro-1-hydroxy-2,1-Benzoxaborole-6-carboxylic acid.

3. A compound of formula (I) according to claim 1 wherein
R¹ is fluorine or chlorine;
G is OR² or NR³R⁴;
R² is a C₁-C₆alkyl or C₁-C₆haloalkyl;
R³ and R⁴ independently are H, C₁-C₆alkyl, C₁-C₆haloalkyl, aryl, heteroaryl, C₃-C₆cycloalkyl, heterocycloalkyl, alkoxy, haloalkoxy, C₂-C₆alkenyl, or C₂-C₆alkynyl.

4. A compound of formula (I) according to claim 1 wherein
R¹ is fluorine or chlorine;
G is OR² or NR³R⁴;
R² is a C₁-C₆alkyl; and
R³ and R⁴ independently are H, C₁-C₆alkyl, heterocycloalkyl, alkoxy or haloalkoxy.

5. A compound of formula (I) according to claim 1 wherein
R¹ fluorine or chlorine;
G is OR² or NR³R⁴;
R² is a C₁-C₆alkyl;
R³ and R⁴ independently are H, methyl, methoxy, trifluoromethoxy, or
heterocycloalkyl having a ring comprising from 2 to 6 carbon atoms and from 1 to 3 heteroatoms selected from N, O, S.

6. A compound of formula (I) according to claim 1 wherein
G is NR³R⁴.

7. A compound of formula (I) according to claim 1 wherein
G is OR².

8. A method of controlling or preventing infestation of useful plants by phytopathogenic microorganisms, wherein a compound of formula (I) as defined in claim 1 is applied to the plants, to parts thereof or the locus thereof.

9. A composition for controlling and protecting against phytopathogenic microorganisms, comprising a compound of formula (I) as defined in claim 1 and at least one auxiliary.

10. A method of controlling phytopathogenic diseases on useful plants or plant propagation material thereof, which comprises applying to said plant propagation material a fungicidally effective amount of a plant propagation material protecting composition comprising a compound of formula (I) as defined in claim 1 together with a suitable carrier therefor.

11. A composition as defined in claim 9 further comprising at least one additional active ingredient.
